(19) United States
(12) Patent Application Publication
(10) Pub. No.: US 2011/0319104 A1
(43) Pub. Date: Dec. 29, 2011

(54) Telephone call handling system

(76) Inventor: Christopher Guy Williams, Spokane, WA (US)

(21) Appl. No.: 13/136,520

(22) Filed: Aug. 3, 2011

Related U.S. Application Data
(63) Continuation-in-part of application No. 12/802,685, filed on Jun. 12, 2010.
Application No. 12/802,685 is a continuation-in-part of application No. 12/658,475, filed on Feb. 4, 2010.

(51) Int. Cl. H04W 4/14

(52) U.S. Cl. 455/466

(57) ABSTRACT

A telephone call handling system includes a text selector to enable a user to select a text message prior to an incoming call. The text message can be stored in a text storage and sent by a text sender from the text storage to a calling telephone. A delivery trigger can initiate the text sender to send the text message at the time of the telephone call. The delivery trigger can be linked to delivery of an audio message, an audio content, an image or a video. The delivery trigger can be linked to call detection, call answer or call hang up. The user can be enabled to initiate the sending of the text message. The system can further include caller I.D. information. The user can employ the caller I.D. information in making a decision to initiate the sending of the text message.

### CROSS REFERENCE TO RELATED APPLICATIONS

This is a continuation in part of co-pending U.S. patent application Ser. No. 12/802,685 filed Jun. 12, 2010 which is hereby incorporated by reference herein in it's entirety. U.S. patent application Ser. No. 12/802,685 filed Jun. 12, 2010 is a continuation in part of co-pending U.S. patent application Ser. No. 12/658,475 filed Feb. 4, 2010, which is hereby incorporated by reference herein in it's entirety.

### BACKGROUND

A call screening service commonly known as “Caller I.D.” is widely utilized by present-day telephone users. Caller I.D. is a service provided to users by the telephone service providers via telephones typically fitted with a display. For calls from landline phones, the caller I.D. information typically displayed includes the telephone number of the landline phone a caller is calling from and the subscriber name documented to that number. For calls from cell phones, the information typically displayed includes the telephone number of the cell phone a caller is calling from and whatever name the cell phone owner happens to program into his phone (or not).

Present-day, telephone users having caller I.D. typically first respond to an incoming telephone call by looking at the display. They then consider that information along with their encumbrances of that moment and mood at that moment, and decide whether to answer the call or not. If not, typically after a set number of additional rings, the incoming call is automatically transferred to a voice mail service (or answering machine for many landline phones) where the caller may leave a message to be reviewed by the user at some later time.

### SUMMARY OF THE INVENTION

Caller I.D. is flawed in that the telephone number and name provided belong to the subscriber of the calling telephone. A caller wishing to circumvent caller I.D. call screening need only place the call from someone else's phone, a pay phone or an out-of-area phone or simply use their own phone and block transmission of the caller I.D. information. Conversely, often times a caller simply happens to be calling from someone else's phone, a pay phone, an out-of-area phone or a family shared phone and, thus, caller I.D. will not provide the user with the true identity of the caller.

In this ever-accelerated world, unknown/unwanted calls answered and unknown yet wanted calls not answered, all due to the shortcomings of caller I.D., costs time/productivity. U.S. Pat. No. 7,062,034 to Williams discloses an invention that cures said caller I.D. shortcomings. Williams discloses a number of embodiments where call-announce information is attained from the caller and delivered to the user. Williams describes attaining call-announce information whereby the caller is asked to speak their name. From the spoken name information and in the caller's voice, the user can readily identify the individual who's calling.

In one embodiment, Williams discloses a system whereby the user initiates the system to attain call-announce information and deliver the information to the user. This system enables the user to consider their encumbrances of that moment and mood at that moment in their decision whether to bother the caller to provide the call-announce information or not. However, if the user desires to know the identity of every caller, every caller must be inconvenienced to provide the call-announce information.

The present disclosure provides for a telephone call handling system, certain embodiments of which achieve improved utilization of caller I.D. information (improved beyond a user receiving caller I.D. information and therefrom simply deciding whether to answer the phone or not). The improved utilization of the caller I.D. information produces improved fluency and continuity to telephone call communication, saves caller and user time and enables selective entertainment of caller and/or user.

The following example description of operation of one embodiment provides one example of said greater fluidity and continuity while conserving callers and the user's time. At the onset of an incoming call, caller I.D. information is provided to the user (i.e. the party being called). From the information, the user is able to essentially determine the identity of the caller and surmises that this person cares to discuss something the user has not yet accumulated all the facts regarding. Accordingly, the user activates a callback message circuitry. A message is then sent to the caller, for example, “Please callback in twenty minutes”.

A second example description of operation of another embodiment of the present invention provides another example of said greater fluidity and continuity while saving the user's time and providing convenience to the user. The incoming call includes caller I.D. information. From the information, the user is essentially able to determine the identity of the caller. However, the user is presently occupied with other matters. Consequently, the user starts a message-then-hold circuitry. In response, the circuitry sends the message to the caller, “I'll be right with you”. The circuitry then retains connection with the caller, circuitry and caller waiting for the user to answer the call. When the user is no longer preoccupied, the user may then answer the call. Message-then-hold frees the user from the messy/uncomfortable and time consuming action of having to answering the call and notifying the caller he is to be placed on hold.

A third example description of operation of another embodiment of the present invention provides an example of enabling selective entertainment of the caller and/or user. The incoming call includes caller I.D. information. For example, from the information, the user presumes that his big brother Mike is calling. The user knows that brother Mike likes rap music. Accordingly, the user presses a concert button and, subsequently, key-six on the touch-tone keypad of his telephone. Pressing the concert button places the system in concert mode and pressing key-six picks a rap song the user has previously programmed to key-six. The system then responds by playing the key-six rap sound to both caller and user. The user then decides to answer the call. The system continues to play the music to both caller and user while they converse.

A fourth example description of operation of another embodiment of the present invention provides another example of said greater fluidity and continuity while conserving both callers and user's time. The incoming call includes caller I.D. information. From the information, the user is unable to positively identify the caller. Consequently, the user then initiates a call-announce circuitry. The circuitry attains “who” information by asking the caller “Who's calling”? The name of the caller and in the caller's voice is provided by the caller and delivered to the user. Consequently, the user now knows with certainty who's calling. The user may then decide whether to answer the call or not. In this way, only when the caller's identity cannot be essentially determined from the caller I.D. is the caller inconvenienced to provide call-announce information and is the user required to spend time listening to the call-announce information

A fifth example description of operation of another embodiment of the present invention provides another example of said greater fluidity and continuity while conserving both caller's and user's time. First, caller I.D. information is provided to the user. From the information, the user is able to essentially determine the identity of the caller. However, the user is busy and, so, the user then initiates a call-announce circuitry. The circuitry attains what/why-information by asking the caller “To best handle this call, please state why you've called”? The what/why-information provided by the caller is delivered to the user and the user may decide whether this is the most appropriate moment to answer the call and address the caller's what/why.

As can be seen, in various of the embodiments described herein above, a message or other information is provided to a caller based on caller I.D. information (or, in the alternative, based on a lack of caller I.D. information), and the message or information is provided without the called party actually answering the call. However, in each instance the called party can make an election to either answer the call or send the caller the selected message or information. This arrangement is in contrast to prior art voice message systems wherein the called telephone answers the call and plays a pre-set message irrespective of any caller I.D. information (or lack thereof). Further, the prior art voice message systems do not allow the called-party to review caller I.D. information and then make an election of a specific message or information to be transmitted back to the calling party, as do embodiments of the current invention.

### BRIEF DESCRIPTION OF THE DRAWINGS

A form of the invention is illustrated in the accompanying drawings in which:

FIGS. 1a and 1b are block diagrammatic views depicting examples of a first embodiment comprised of caller I.D. circuitry, callback message circuitry and an activator.

FIGS. 2a and 2b are block diagrammatic views depicting examples of a second embodiment comprised of caller I.D. circuitry, message-then-hold circuitry and a starter.

FIGS. 3a and 3b are block diagrammatic views depicting examples of a third embodiment comprised of caller I.D. circuitry, concert circuitry and an orchestrator.

FIG. 4 is a block diagrammatic view depicting an example of a fourth embodiment comprised of caller I.D. circuitry, call-announce circuitry configured to attain who-information, and an initiator.

FIG. 5 is a block diagrammatic view depicting an example of a fifth embodiment comprised of caller I.D. circuitry, call-announce circuitry configured to attain what/why-information, and an initiator.

FIG. 6 is a block diagrammatic view depicting an example of a sixth embodiment comprised of caller I.D. circuitry, call-announce circuitry configured to attain who-information and what/why-information, and an initiator.

FIG. 7 is a block diagrammatic view depicting a telephone service provider with the present invention located therein.

FIG. 8 is a block diagrammatic view depicting an example of a seventh embodiment comprised of caller I.D. circuitry, a plurality of complementary circuitry and an enabler.

FIG. 9 is a block diagram depicting an example of an eighth embodiment comprised of caller I.D. circuitry, a starter and a ring-back selector.

FIG. 10 is a block diagram depicting an example of a ninth embodiment comprised of caller I.D. circuitry, an orchestrator and a ring-back selector.

FIG. 11 is a block diagram depicting an example of a tenth embodiment comprised of a ring-back selector, a cell phone, a music player and a music player and ring-back content sharer.

FIG. 12 is a block diagram depicting an example of an eleventh embodiment comprised of a ring-back selector 180, a ring-back duration selector 185, a ring-back terminator selector 190 and a ring-back profile selector 200.

FIG. 13a is a block diagram depicting an example of a twelfth embodiment comprised of a text delivery and wherein the text delivery comprises a text selector, a text storage, a delivery trigger and a text sender and wherein the delivery trigger comprises a linked trigger.

FIG. 13b is a block diagram depicting an example of a twelfth embodiment comprised of a text delivery and wherein the text delivery comprises a text selector, a text storage, a delivery trigger and a text sender and wherein the delivery trigger comprises a deployed trigger.

FIG. 13c is a block diagram depicting an example of a twelfth embodiment comprised of a text delivery and wherein the text delivery comprises a text selector, a text storage, a delivery trigger, a text sender and a text picker.

FIG. 13d is a block diagram depicting an example of a twelfth embodiment comprised of a text delivery and further comprised of a still camera delivery and/or a video delivery.

FIG. 14a is a block diagram depicting an example of a thirteenth embodiment comprised of a picture delivery and wherein the picture delivery comprises a picture selector, a picture storage, a delivery trigger and a picture sender and wherein the delivery trigger comprises a linked trigger.

FIG. 14b is a block diagram depicting an example of a thirteenth embodiment comprised of a picture delivery and wherein the picture delivery comprises a picture selector, a picture storage, a delivery trigger and a picture sender and wherein the delivery trigger comprises a deployed trigger.

FIG. 14c is a block diagram depicting an example of a thirteenth embodiment comprised of a picture delivery and wherein the picture delivery comprises a picture selector, a picture storage, a delivery trigger, a picture sender and a picture picker.

FIG. 15a is a block diagram depicting an example of a fourteenth embodiment comprised of a video delivery and wherein the video delivery comprises a video selector, a video storage, a delivery trigger and a video sender and wherein the delivery trigger comprises a linked trigger.

FIG. 15b is a block diagram depicting an example of a fourteenth embodiment comprised of a video delivery and wherein the video delivery comprises a video selector, a video storage, a delivery trigger and a video sender and wherein the delivery trigger comprises a deployed trigger.

FIG. 15c is a block diagram depicting an example of a fourteenth embodiment comprised of a video delivery and wherein the video delivery comprises a video selector, a video storage, a delivery trigger, a video sender and a video picker.

FIGS. 16a, 16b and 16c are block diagrammatic views depicting examples of a fifteenth embodiment comprised of message-then-record circuitry, a commencer and a recorder.

### DETAILED DESCRIPTION

The present invention pertains to telephone calls. Accordingly, a general description of telephone service is appropriate. For decades, telephone service in the U.S. was provided by an entity commonly known as “the phone company”, “Ma Bell” and “AT&T”. Deregulation broke up the giant telephone service provider into a network of service providers then commonly referred to as “the baby bells”. For this discussion, the present-day network of service providers including the circuitry they employ is referred to as a telephone service provider 121.

Examples provided herein describe certain functionality, structure and components for the purpose of facilitating understanding of how the various disclosed embodiments can operate. However, it will be understood that the functionality, structure and components described in the examples is exemplary only, and should not be considered as limiting the scope of the embodiment to which the example applies.

One example of circuitry that can be employed in the routing of a telephone call by a service provider 121 is shown in FIG. 7. An example of operation of the example circuitry shown will now be given. The caller places a call from the caller's phone 122. That call is received at local switching station 120a, sent over long distance network 124 and received at local switching station 120. Station 120 then rings the user's telephone 27k. If telephone 27k is answered, station 120 then communicably connects phone 122 with phone 27k.

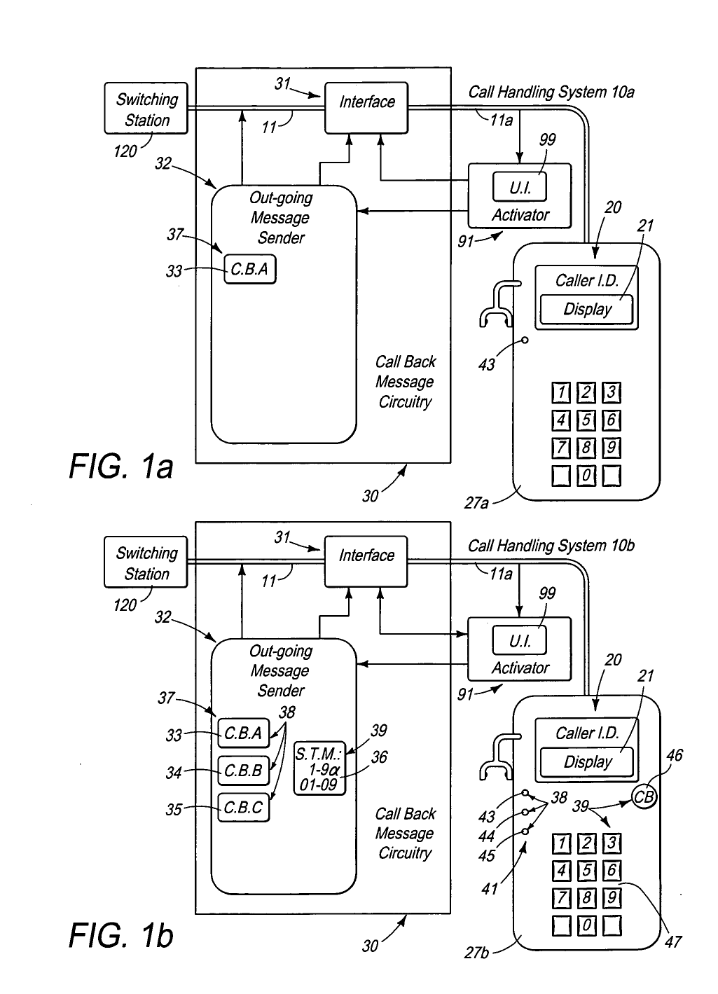

Examples of the present invention, referred to herein as telephone call handling system 10, are illustrated in the accompanying FIGS. 1a through 13d. Example handling systems 10a through 10m and 10r through 10t comprise a caller I.D. circuitry 20. Caller I.D. circuitry 20 functions to provide caller I.D. information to a user. An exemplary caller I.D. is depicted in FIGS. 1a through 10 and 13b through 13d. The exemplary caller I.D. circuitry 20 comprises a caller I.D. display 21. To indicate the presence of an incoming call, local switching station 120 sends a ring signal to telephone 27, causing telephone 27 to ring. Along with the ring signal, station 120 sends caller I.D. information. The information is received at caller I.D. circuitry 20 and, subsequently, provided for a user to read on caller I.D. display 21. (Caller I.D. can comprise an audible announcement of the I.D. information to the user including or absent display 21.)

Example handling systems 10a through 10k can further comprise at least one complementary circuitry. Said complementary circuitry can be employed by a user to the send a response to the source of an incoming call, the source as identified (or not) by caller I.D. 20. Said complementary circuitry comprises one or more of: callback message circuitry 30, message and hold circuitry 40, concert circuitry 50, call-announce circuitry configured to attain who-information 60, call-announce circuitry configured to attain what/why-information 70 and call-announce circuitry configured to attain who and what/why information 80. Circuitry 30, 40, 50, 60, 70 and 80 shown variously in FIGS. 1a through 6 and 8 through 10 each employ an interface 31 and an out-going message sender 32.

Interface 31 functions to control connection and release operations. An exemplary interface 31 is depicted in FIGS. 1a through 6 and 8 through 10. The exemplary interface 31 is electrically connected to (or connectable to) line 11 and, responsive to input, can go off-hook. (“Electrically connected to” includes the capability to become electrically connected to, for example, as by way of a switch, as well as connectivity by wireless transmission such as Blue Tooth or other radio frequency or infra red-type transmission.) Handling system 10 can be located remote from service provider 121, as for example at a user location or in a user telephone 27, as depicted in FIGS. 1a through 6 and FIGS. 8 through 13d. Handling system 10 can also be located at service provider 121, as depicted in FIG. 7. (Other arrangements for distribution and/or consolidation of the components of system 10 can also be provided, all within the scope of the present disclosure.) When system 10 is located at either location, going off-hook can serve to cause service provider 121 to discontinue the sending of a ring sound to the caller's telephone and further can serve to provide that system 10 and service provider 121 are communicably connected such that message sender 32 of system 10 can send a message to the caller's telephone. When system 10 is located at either location, going off-hook can further function to discontinue the sending of a ring signal to telephone 27 and to provide that system 10 can receive information from the caller's telephone via service provider 121. (Interface 31, when located as shown in FIGS. 1a through 6 and FIGS. 8 through 10, can optionally be configured to connect and disconnect two-way communication between telephone 27 and an incoming call. The two-way communication pathway can be disconnected in the case where signals sent from system 10 to telephone 27, via line 11a, and from telephone 27 to system 10 are desired not to travel back to the caller's telephone or to the service provider.)

Out-going message sender 32 functions to send stored information to a caller. An exemplary message sender 32 is depicted in FIGS. 1a through 6 and 8 through 10. The exemplary sender 32 is electrically connected to (or connectable to) telephone line 11 and sends a message to line 11 and, thus, ultimately to the caller.

A first embodiment of telephone call handling system 10 is illustrated in FIGS. 1a and 1b. This first embodiment comprises the prior described caller I.D. circuitry 20. This embodiment also comprises a callback message circuitry 30 and an activator 91. (In one variation, this first embodiment comprises circuitry 20 and activator 91, both located at a cell phone 165 (phone 165 described later) and interacts with, and can include, message circuitry 30 located, for example, at service provider 121.)

Callback circuitry 30 functions to deliver a callback message to a caller. An exemplary callback message circuitry 30 is depicted in FIGS. 1a and 1b. The exemplary circuitry 30 comprises interface 31 (described prior) and out-going message sender 32 (described prior).

Activator 91 functions to receive instruction from a user to activate callback message circuitry 30. An exemplary activator 91 is depicted in FIGS. 1a and 1b. The exemplary activator 91 comprises a user interface (shown as U.I.) 99, user interface 99 referred to hereafter as UI 99. UI 99 functions to receive instruction from a user. (UI 99 can comprise a microprocessor and memory available to the microprocessor.)

A first example of this first embodiment is illustrated as system 10a in FIG. 1a. For this example, out-going message sender 32 of callback circuitry 30 is configured to deliver to a caller a callback message A 33 shown as C.B. A 33. Callback message A 33 states (for example), “Please call back in one hour”. (“Please call back in one hour” constitutes a specific time callback message 37, shown in FIGS. 1a and 1b. Conversely, callback messages can state, for example, “I'll call you back in one hour”.) Message sender 32 is further configured to send a signal to interface 31 at the conclusion to the sending of the message.

For this example, UI 99 of activator 91 is configured to receive instruction from a user via a control button 43, button 43 electrically connected to (or connectable to) line 11a and located at telephone 27a. When pressed, button 43 is configured to send a control signal via line 11a to UI 99. UI 99 responds by sending a signal to interface 31 and, after a two-second delay, by sending a signal to sender 32. Interface 31 responds by going off-hook. Sender 32 responds by sending callback message A 33 to the caller. (Button 43 can be part of activator 91. In one variation, button 43 can be configured to send the signal to interface 31 directly, and without the user of activator 91.)

An example of operation of this first example of this first embodiment will now be given (FIG. 1a). A user's telephone is rung by an incoming ring signal provided by station 120 via line 11 and line 11a. Delivered with the ring signal is caller I.D. information. The information appears on display 21 (located at telephone 27a). The user recognizes the phone number on the display; i.e. the user presumably knows who's calling. The user surmises that this person cares to discuss a matter that the user has not yet accumulated all the pertinent facts regarding and, thus, cannot conclude a successful conversation with this caller at this time. Accordingly, the user presses control button 43. Button 43 responds by sending a signal to UI 99 via line 11a. UI 99 responds by sending a signal to interface 31 and, after a two second delay, by sending a signal to out-going message sender 32. Interface 31 responds by going off-hook. Sender 32 responds by playing and sending stored callback message A 33, “Please callback in one hour” to the caller (via line 11 and switching station 120). The caller hears the message and understands to call back in one hour. At the conclusion to sending the message, sender 32 sends a signal to interface 31. Interface 31 responds by discontinuing the off-hook condition. (If the caller hangs up prior to completion of the sending of the message, interface 31 can respond by discontinuing the off-hook condition.)

A second example of the first embodiment (FIG. 1a) is illustrated as handling system 10b in FIG. 1b. This second example comprises the first example configured with one or more of a callback message picker 38 and a specific-time callback message picker 39, theses additional features serving to enhance the performance of the first example.

Callback message picker 38 function to enable the user to pick a callback message from a plurality of callback messages to pick from. An exemplary callback message picker 38 is depicted in FIG. 1b. For this example, message sender 32 of callback circuitry 30 is configured to deliver to the caller one of callback messages: A 33, B 34 and C 35 (message A 33 shown as C.B. A 33, message B 34 shown as C.B. B 34, message C 35 shown as C.B. C 35). Callback message A 33 states, “Please call back in one hour”. Callback message B 34 states, “Please call back tomorrow”. Callback message C 35 states, “Please never call back”. Message sender 32 is further configured to send a signal to interface 31 at the conclusion to sending the callback message. During an incoming call, a user can consider their encumbrances/mood at that moment and, accordingly, deploy the most appropriate callback message by picking one of: A 33, B 34 and C 35.

Further for this example, UI 99 of activator 91 is configured to receive instruction from a user via the user pressing control button 43, a control signal button 44 or a control signal button 45, all three buttons shown located on telephone 27b. Each button when pressed sends a signal to U.I 99. UI 99 responds to the signal from button 43 by activating interface 31 and by activating sender 32 to play callback message A 33. UI 99 responds to the signal from button 44 by activating interface 31 and by activating sender 32 to play callback message B 34. UI 99 responds to the signal from button 45 by activating interface 31 and by activating sender 32 to play callback message C 35. (Control button 43, control button 44 and control button 45 can be part of activator 91. In one variation, button 43, button 44 and button 45 can each be configured to send the signal to interface 31 directly, and without the user of activator 91.)

An example of operation of this second example of this first embodiment, employing callback message picker 38, will now be given (FIG. 1b). The embodiment operates as described above for the first example operation until the point where the user has decided to send a callback message. The user now picks callback message B 34 and, accordingly, presses button 44 (telephone 27b). Button 44 sends a signal to UI 99. UI 99 responds by sending a signal to interface 31 and, after a two-second delay, by sending a signal to sender 32. Interface 31 responds by going off-hook. Sender 32 responds by playing and sending callback message B 34, “Please call back tomorrow” to the caller (via line 11 and station 120). The caller hears the message and understands to call the user back on the following day. Message sender 32 sends a signal to interface 31 at the conclusion to sending the message. Interface 31 responds by discontinuing the off-hook condition.

Specific-time callback message picker 39 functions to enable a user to pick a specific-time callback message from a plurality of specific-time callback messages to pick from. An exemplary specific-time callback message picker 39 is depicted in FIG. 1b. For this example, out-going message sender 32 of callback circuitry 30 is configured to deliver to the caller one of specific time messages 36 shown as S.T.M. 36: 1-9 & 01-09. Message 1 states “Please call back in 10 minutes”. Message 2 states, “Please call back in 20 minutes”. Message 3 states, “Please call back in 30 minutes”. Likewise, messages 4 through 9 are configured to state 40 minutes through 90 minutes respectively. Message 01 states, “Please call back in one hour”. Message 02 states, “Please call back in two hours”. Likewise, messages 03 through 09 are configured to state 3 hours through 9 hours respectively. (Other time periods can also be provided, for example, message 001 can provide a message of, “Please call back in one day.) Message sender 32 is configured to send a signal to interface 31 at the conclusion to the sending of the specific-time call back message to terminate the off-hook condition. During an incoming call, a user can consider their encumbrances and mood at that moment and accordingly, deploy the most appropriate callback message by picking from one of specific time messages 36: 1-9 & 01-09.

Further for this example, UI 99 of activator 91 is configured to receive instruction from a user via a messaging button CB 46 and a keypad 47. Pressed button CB 46 instructs UI 99 that specific-time callback message picker 39 is in operation. Pressed button CB 46 also activates keypad 47. Keypad 47 comprises keys “1” through “0” (CB 46 and keys “1” through “0” located at telephone 27b). Pressing button CB 46 activates touch-tone keys “1” through “0”. When activated, each key when pressed is configured to send a signal via line 11a to UI 99. UI 99 responds by engaging interface 31 and, after a two second delay, by engaging sender 32 to play the specific time message 36 (0-9 & 01-09) associated with the key (or keys) pressed. Pressing key-1 engages interface 31 and message-1 of messages 36. Pressing key-2 engages interface 31 and message-2 of messages 36. Pressing key-3 engages interface 31 and message-3 of messages 36, and so on through message-09. (Button CB 46 and keypad 47 can be part of activator 91. Keypad 47 can be a touch-tone keypad, a touch-screen keypad, a touch-screen touch-tone keypad, or other. In one variation, button keypad 47 can be configured to send the signal to interface 31 and the signal to sender 32 directly, and without the user of activator 91.)

An example of operation of this second example of this first embodiment, employing specific-time callback message picker 39, will now be given (FIG. 1b). The embodiment operates as described above for the first example operation until the point where the user has decided to send a callback message. The user now picks message-5 of specific time messages 36 and, to choose that message, presses button CB 46 and touch-tone key-5 (telephone 27b). Key-5 sends a signal to UI 99. UI 99 responds by sending a signal to interface 31 and, after a two-second delay, sending a signal to sender 32. Interface 31 responds by going off-hook. Sender 32 responds by playing and sending the message, “Please call back in 50 minutes” to the caller (via line 11 and station 120). The caller hears the message and understands to call the user back in 50 minutes. Message sender 32 sends a signal to interface 31 upon conclusion to sending the “50 minute” message. Interface 31 responds by discontinuing the off-hook condition.

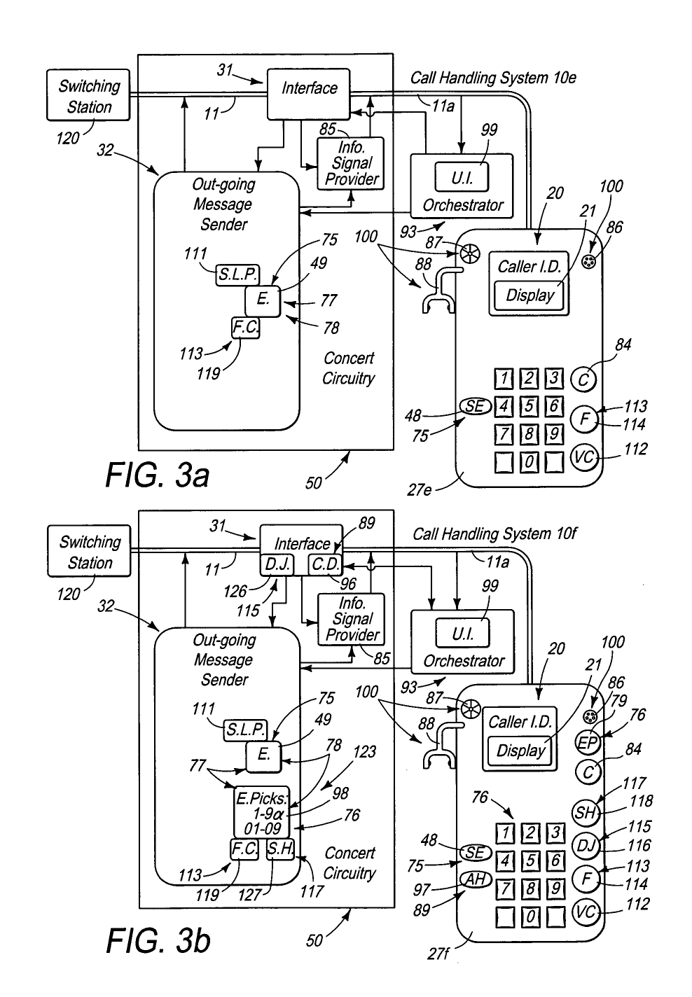

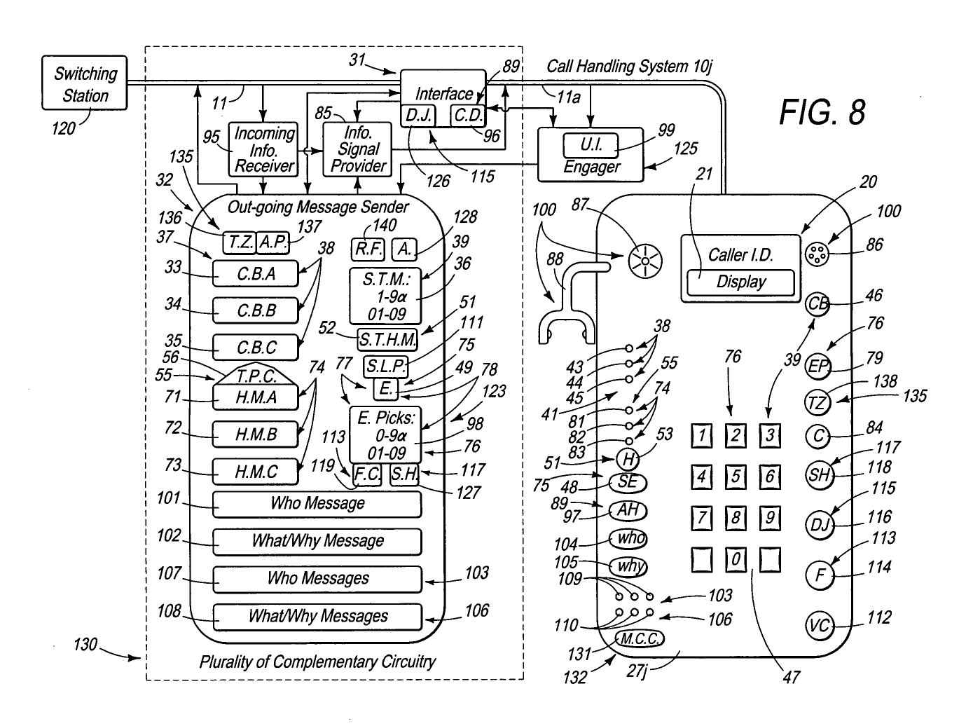

The examples of the first embodiment can be enhanced with an auto-callback 41 shown in FIGS. 1b and 8. An exemplary auto-callback 41 functions to automatically send a callback message to a caller. For this example, auto-callback 41 comprises the prior described callback button 45 when pressed-for-duration. (Button 45, electrically connected to or connectable to message sender 32 and to interface 31 via line 11a and UI 99. Auto-callback 41 can further comprise button 43, button 44, button CB 46 or other.) Button 45, when pressed-for-duration, sends a signal to UI 99 via line 11a. UI 99 responds by waiting for a signal from interface 31. Upon detecting a ring signal, interface 31 sends a signal to UI 99 (interface 31 can include call detector 96 described later and shown in FIG. 3b). In response to the signal from interface 31, UI 99 delays three-seconds and then signals interface 31. Interface 31 responds by going off-hook. UI 99 further delays an additional two-seconds and then signals message sender 32. Sender 32 responds by playing and sending callback message 35, “Please call back in one hour” to the caller. (Sender 32 then signals interface 31 and interface 31 then discontinues the off-hook condition.)

In summary, the examples of the first embodiment (FIGS. 1a and 1b) preferably operate by: providing caller I.D. information to a user; receiving instruction from a user; going off-hook in response to the instruction received; sending a stored callback message to a caller in response to the instruction received; and discontinuing the off-hook condition.

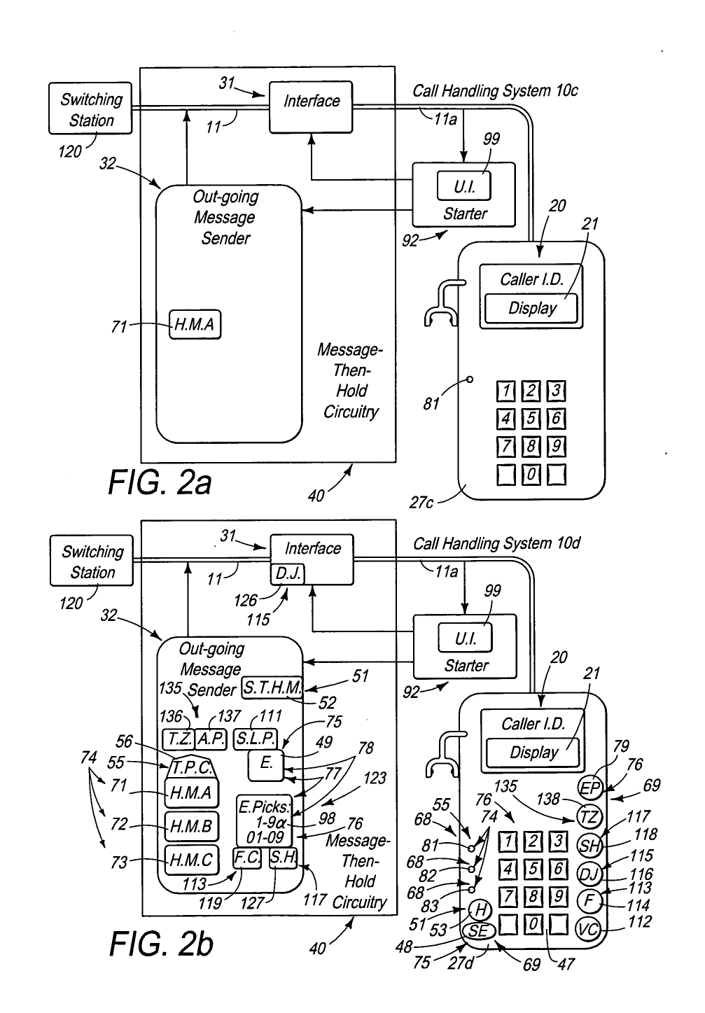

A second embodiment of telephone call handling system 10 is illustrated in FIGS. 2a and 2b. This second embodiment comprises the prior described caller I.D. circuitry 20. This embodiment also comprises message-then-hold circuitry 40 and a starter 92. (In one variation, this second embodiment comprises circuitry 20 and starter 92, both located at a cell phone 165 (phone 165 described later) and interacts with, and can include, message-then-hold circuitry 40 located, for example, at service provider 121.)

Message-then-hold circuitry 40 functions to deliver a message to a caller and then hold for a user to answer. An exemplary message-then-hold circuitry 40 is depicted in FIGS. 2a and 2b. The exemplary circuitry 40 comprises interface 31 (described prior) and out-going message sender 32 (described prior).

Starter 92 functions to receive instruction from a user to start message-then-hold circuitry 30. An exemplary starter 92 is depicted in FIGS. 2a and 2b. The exemplary starter 92 comprises user interface (shown as U.I.) 99 (described prior). UI 99 functions to receive instruction from a user.

A first example of this second embodiment is illustrated as system 10c in FIG. 2a. For this example, out-going message sender 32 of message-then-hold circuitry 40 is configured to store and to deliver to a caller a hold message A 71 shown as H.M. A 71. Hold message A 71 states, for example, “I'll be right with you”. Interface 31 is configured to maintain the off-hook condition until detecting the call being answered by the user.

Further for this example, UI 99 of starter 92 is configured to receive instruction from a user via a control button 81, button 81 electrically connected to (or connectable to) line 11a and located at telephone 27c. When pressed, button 81 sends a control signal to UI 99. UI 99 responds by sending a signal to interface 31 and, after a two-second delay, sending a signal to sender 32. Interface 31 responds by going off-hook. Sender 32 responds by sending hold message A 71 to the caller. (Button 81 can be part of starter 92. In one variation, button 81 can be configured to send the signal to interface 31 directly, and without the user of starter 92.)

An example of operation of this first example of this second embodiment will now be given (FIG. 2a). A user's telephone is rung by an incoming ring signal provided by station 120 via line 11 and line 11a. Delivered with the ring signal is caller I.D. information. The information appears on display 21 (located at telephone 27c). The user recognizes the phone number on the display; i.e. the user essentially knows who's calling. The user is quite busy driving his car but figures he will be comfortable to answer the call shortly. Accordingly, the user presses control button 81. Pressed button 81 sends a signal to UI 99 via line 11a. UI 99 responds by sending a signal to interface 31 and, after a two-second delay, by sending a signal to out-going message sender 32. Interface 31 responds by going off-hook. Sender 32 responds by playing and sending hold message A 71, “I'll be right with you” to the caller (via line 11 and switching station 120). The caller hears the message and understands the user will answer shortly. At the conclusion to the sending of the message, handling system 10c remains idle (on hold) by interface 31 maintaining the off-hook condition until the user answers the call. When the user answers, the off-hook condition of telephone 27c is detected by interface 31. Interface 31 responds by discontinuing the off-hook condition. (If the caller hangs up prior to the user answering, interface 31 can respond by discontinuing the off-hook condition.)

A second example of the second embodiment (FIG. 2a) is illustrated as telephone call handling system 10d in FIG. 2b. This second example comprises the first example configured with one or more of: a hold message picker 74, specific-time hold message picker 51, an user-selected entertainment 75, an entertainment picker “E. Picks” 76 and a “tiser” 135, theses additional features serving to enhance the performance of the first example.

Hold message picker 74 functions to enable a user to pick a hold message from a plurality of hold messages to pick from. An exemplary hold message picker 74 is depicted in FIG. 2b. The exemplary hold message picker 74 comprise hold message A 71 shown as H.M. A 71, hold message B 72 shown as H.M. B 72 and hold message C 73 shown as H.M. C 73. For this example, out-going message sender 32 of circuitry 40 is configured to deliver to a caller one of hold messages: A 71, B 72 and C 73. Hold message A 71 states, “I'll be right with you”. Hold message B 72 states, “Hold your horses, I'll be there in a jiffy”. Hold message C 73 states, “I'll be with you in a couple shakes”. For this example, interface 31 is configured to maintain the off-hook condition until the user answers the call (or the caller hangs up). When the user answers, the off-hook condition of telephone 27d is detected by interface 31. Interface 31 responds by discontinuing the off-hook condition. During an incoming call, a user can consider their encumbrances and mood at that moment along with the identity of the caller and, accordingly, deploy the most appropriate hold message by picking one of message A 71, message B 72 and message C 73.

Further for this example, UI 99 of starter 92 is configured to receive instruction from a user via control button 81, a control button 82 and a control button 83, all three buttons shown located on telephone 27d. (Buttons 81, 82 and 83 each electrically connected to (or connectable to) line 11a and located at telephone 27c.) Each button when pressed is configured to send a signal via line 11a to UI 99. UI 99 responds by engaging interface 31 and, after a two-second delay, by engaging sender 32. UI 99 responds to a signal from pressed button 81 by engaging interface 31 and by engaging sender 32 to play hold message A 71. UI 99 responds to a signal from pressed button 82 by engaging interface 31 and by engaging sender 32 to play hold message B 72. UI 99 responds to a signal from button 83 by engaging interface 31 and by engaging sender 32 to play hold message C 73. (Button 81, button 82 and button 83 can be part of starter 92. In one variation, button 81, button 82 and button 83 can each be configured to send the signal to interface 31 directly, and without the user of starter 92.)

An example of operation of this second example of this second embodiment, employing hold message picker 74, will now be given (FIG. 2b). The embodiment operates as described above for the example of operation of this first example of this second embodiment until the point where the user has decided to place the caller on hold. The user now picks hold message C 73 and, accordingly, presses button 83. Button 83 sends a signal to UI 99. UI 99 responds by sending a signal to interface 31 and, after a two-second delay, by sending a signal to sender 32. Interface 31 responds by going off-hook. Sender 32 responds by sending hold message C 73, “I'll be with you in a couple shakes” to the caller. The caller hears the message and understands to wait for the user to answer. At the conclusion to the sending of the message, handling system 10d remains idle (on hold), by interface 31 maintaining the off-hook condition, until the user answers the call. When the user answers, the off-hook condition of telephone 27d is detected by interface 31. Interface 31 responds by discontinuing the off-hook condition.

Specific-time hold message picker 51 functions to enable a user to pick a specific-time hold message from a plurality of specific-time hold messages to pick from. An exemplary specific-time hold message picker 51 is depicted in FIGS. 2b and 8. The exemplary message picker 51 comprises a specific-time hold message storage 52 shown as S.T.H.M. 52 located at message sender 32. For this example, message sender 32 of message-then-hold circuitry 40 is configured to deliver to the caller one of the messages stored in specific-time hold message storage 52. Message 1 (of storage 52) states, “I'll be with you in 10 seconds”. Message 2 states, “I'll be with you in 20 seconds”. Message 3 states, “I'll be with you in 30 seconds”. Likewise, messages 4 through 9 are configured to state 40 seconds through 90 seconds respectively. Message 01 states, “I'll be with you in one minute”. Message 02 states, “I'll be with you in two minutes”. Likewise, messages 03 through 09 are configured to state 3 minutes through 9 minutes respectively. (Other time periods can also be provided.) During an incoming call, a user can consider their encumbrances and mood at that moment and accordingly, deploy the most appropriate specific-time hold message stored in storage 52.

Further for this example, UI 99 of starter 92 is configured to receive instruction from a user via a hold button H 53 and keypad 47 (both shown located at telephone 27d, keypad 47 described prior). Pressed button H 53 instructs UI 99 that specific-time hold message picker 51 is in operation. Pressed button H 53 also activates keys “1” through “0” of keypad 47. When activated, each key when pressed is configured to send a signal via line 11a to UI 99. UI 99 responds by engaging interface 31 and, after a two second delay, by engaging sender 32 to play the message stored in storage 52 associated with the key (or keys) pressed. Pressing key-1 engages interface 31 and a message-1 of storage 52. Pressing key-2 engages interface 31 and a message-2 of storage 52. Pressing key-3 engages interface 31 and a message-3 of storage 52, and so on through a message-09. (Button H 53 and keypad 47 can be part of starter 92. In one variation, keypad 47 can each be configured to send the signal to interface 31 and the signal to sender 32 directly, and without the user of starter 92.)

An example of operation of this second example of this second embodiment, employing specific-time hold message picker 51, will now be given (FIG. 2b). The embodiment operates as described above for the example of operation of this first example of this second embodiment until the point where the user has decided to place the caller on hold. The user figures he'll be available in approximately 40 seconds. Accordingly, the user presses button H 53 followed by key-4. Pressed button H 53 instructs UI 99 that specific-time hold message picker 51 is in operation. Pressed button H 53 also activates keys “1” through “0” of keypad 47. Subsequently pressed key-4 sends a signal to UI 99. UI 99 responds by sending a signal to interface 31 and, after a two-second delay, sending a signal to sender 32. Interface 31 responds by going off-hook. Sender 32 responds by playing and sending the message-4 stored in storage 52, “I'll be with you in 40 seconds” to the caller (via line 11 and station 120). The caller hears the message and anticipates that the user will answer in some 40 seconds. At the conclusion to the sending of the hold message, handling system 10d remains idle (on hold), by interface 31 maintaining the off-hook condition, until the user answers the call. When the user answers, the off-hook condition of telephone 27d is detected by interface 31. Interface 31 responds by discontinuing the off-hook condition.

User-selected entertainment 75 functions to enable a user to select entertainment prior to an incoming call, for delivery during the incoming call. An exemplary user-selected entertainment 75 is depicted in FIG. 2b. The exemplary user-selected entertainment 75 comprises an entertainment selector 69, a stored entertainment 49 and a selected entertainment button 48. Selector 69 functions to enable a user to select entertainment. As one example, selector 69 can be configured to employ button SE 48 (described below) in the downloading of entertainment. For example, selector 69 can be configured such that pressing button SE 48 four times signals selected content to be downloaded into stored entertainment 49 (shown as E. 49 located at out-going message sender 32). For this exemplary user-selected entertainment 75, sender 32 of message-then-hold circuitry 40 is configured to store and to deliver to a caller stored entertainment 49. Selector 69 can be employed to select entertainment/content such as a music 77 and/or an interesting sound 78 (or other content). The user can, for example, employ selector 69 to download music 77 and/or sound 78 into sender 32 via system 10d. Music 77 can be downloaded from a music web sight or service provider web site or from a music player or some other form of music library, or other. Interesting sound 78 can be download from wherever said sounds can be found such as on the internet or a music player, or other. (The downloading process can be configured such as downloading a ring-tone into a phone or downloading music into a music player from a computer or downloading music/content into a cell phone from the internet via the service provider or can be configured otherwise. Accordingly, the downloading process has not been described in detail. Also, alternately, hundreds of songs (music) 77 and/or thousands of interesting sound 78 can be provided pre-loaded in phone 27d by the manufacturer of phone 27d to be selected employing selector 69 and loaded into stored entertainment 49.)

Further for this example, UT 99 (of starter 92) is configured to receive instruction from a user via a selected entertainment button 48 shown as SE 48, button SE 48 electrically connected to (or connectable to) line 11a and located at telephone 27d. Button SE 48 is configured to send a control signal via line 11a to UI 99. UI 99 responds by signaling sender 32. Provided that one button 81, button 82 or button 83 of hold message picker 74 has been pressed prior during the incoming call, sender 32 responds to the signal from UI 99 by sending stored entertainment 49. In other words, if a hold button has been pressed and button SE 48 is pressed, stored entertainment 49 will be played to the caller upon completion of whichever of the hold message the user has chosen: message A 71, message B 72 or message C 73. (Button SE 48 can be part of starter 92. In one variation, button 48 can be configured to send the signal to sender 32 directly, and without the user of starter 92.)

An example of operation of this second example of this second embodiment, employing user-selected entertainment 75, will now be given (FIG. 2b). The embodiment operates as described above for the example of operation of the second example of the second embodiment (employing hold message picker 74) until the point where the user has pressed button 83. Sender 32 has responded by sending hold message. C 73, “I'll be with you in a couple shakes” to the caller. (Interface 31 has gone off-hook.) The user now presses the select entertainment button SE 48. Pressed button SE 48 sends a signal to UI 99. UI 99 responds by sending a signal to sender 32. Sender 32 responds by playing the music stored in stored entertainment 49. Entertainment is played to the caller. (As a converse example, the user does not press button SE 48. Consequently, at the conclusion of the hold message, no entertainment is played to the caller.) Handling system 10d remains idle (on hold) by interface 31 maintaining the off-hook condition, until the user answers the call. When the user answers, the off-hook condition of telephone 27d is detected by interface 31. Interface 31 responds by discontinuing the off-hook condition.

Alternately, entertainment 75 can be configured to function without hold message picker 74 (or without a solitary hold message depicted prior as hold message A 71, or without specific-time hold message picker 51). For example, the user has decided to put the caller on hold. The user does not press hold message button 83 but, instead, twice presses selected entertainment button SE 48. Sender 32 responds by playing and sending stored entertainment 49. Consequently, the caller is only played entertainment 49, i.e. no hold message. In this case, stored entertainment 49 serves as both the hold message and the entertainment. (Also, entertainment 75 can be configured to function without hold message picker 74 and, instead, to function with a solitary hold message, for example, solitary message A 71 described in the first example of this second embodiment.)

User-selected entertainment 75 can comprise an entertainment picker 76 hereafter referred to as E. Picks 76. E. Picks 76 functions to enable the user to pick an entertainment from a plurality of entertainment choices to pick from. An exemplary E. Picks 76 is depicted in FIG. 2b. The exemplary E. Picks 76 comprises entertainment selector 69, an entertainment pick storage 98 shown located at sender 32, a button EP 79 located at telephone 27d and a keypad 47 located at telephone 27d. For this example, the user can employ entertainment selector 69 to select a plurality of entertainment choices to be stored in pick storage 98, storage 98 shown as E. Picks: 1-9 & 01-09 and shown located at message sender 32. For this example, each of picks 1 through 9 comprises a song (music) 77. Each of picks 01 through 09 comprises an interesting sound 78. The user can employ selector 69 to select and download music 77 and/or sound 78 into sender 32, for example, via system 10d. Selector 69 can be configured to employ button EP 79 described below in the downloading process. For example, selector 69 can be configured such that pressing button EP 79 four times followed by one or more of the keys of keypad 47 signals selected content to be downloaded into a compartment in storage 98 associated with the keys of keypad 47 pressed. In other words, if keys “zero” and “two” are pressed, the entertainment will be loaded into a compartment associated with pick-02. Subsequently, during an incoming call, a user can consider their mood at that moment along with the identity of the caller and, accordingly, send the most appropriate entertainment by picking one of storage 98 E. Picks: 1-9 & 01-09. (For the example given of stored entertainment 49, the user can download one entertainment to subsequently be deployed by the user during an incoming call. For this example of E. Picks 76, the user can download a plurality of entertainment selections from which one can be picked by the user employing E. Picks 76 during an incoming call, the picked entertainment to then be played and sent by sender 32. Accordingly, the user can download music 77 and/or sound 78, or other, into pick storage 98 of E. Picks 76 in the manner as suggested prior for downloading entertainment into stored entertainment 49. Also, entertainment can be initially pre-loaded into storage 98 by a service provider or telephony equipment manufacturer or other.)

Further for this example, UI 99 of starter 92 is configured to receive instruction from a user via button EP 79 and keypad 47. Button EP 79 is electrically connected to (or connectable to) line 11a and located at telephone 27d. Button EP 79 is configured to send a control signal via line 11a to UI 99. Pressed button EP 79 can instruct UI 99 that E. Picks 76 is in operation. Pressed button EP 79 also activates keypad 47. (Keypad 47, comprising keys “1” through “0” and shown located at telephone 27d, has been described prior when employed in callback message picker 39.) When activated, each key when pressed is configured to send a signal via line 11a to UI 99. UI 99 responds by engaging interface 31 to go off-hook (if not already off-hook) and, after a two-second delay, by engaging sender 32 to play the stored E. Picks: 0-9 & 01-09 associated with the key pressed. Pressing key-1 engages pick-1. Pressing key-2 engages pick-2. Pressing key-3 engages pick-3, and so on through pick-09. (Button EP 79 and keypad 47 can be part of starter 92. In one variation, keypad 47 can be configured to send the signal to interface 31 and the signal to sender 32 directly, and without the user of starter 92.)

An example of operation of this second example of this second embodiment, employing E. Picks 76, will now be given (FIG. 2b). The embodiment operates as described above for the example of operation of the second example of this second embodiment (employing hold message picker 74) until the point where the user has pressed button 83. Sender 32 has responded by sending hold message C 73, “I'll be with you in a couple shakes” to the caller. (Interface 31 has gone off-hook.) The user now presses button EP 79 and presses key-3 of keypad 47. Key-3 responds by sending a signal to UI 99. UI 99 responds by sending a signal to sender 32. Sender 32 responds by playing the music stored as pick-3 of pick storage 98. The caller then hears the music and may enjoy. Sender 32 continues playing the music as handling system 10d remains idle (on hold), by interface 31 maintaining the off-hook condition, until the user answers the call (or caller hangs up). When the user answers, the off-hook condition of telephone 27d is detected by interface 31. Interface 31 responds by discontinuing the off-hook condition.

Alternately, E. Picks 76 can be configured to operate without hold message picker 74 (or without specific-time hold message picker 51). As an example, when the user has decided to place the caller on hold, the user presses button EP 79 followed by a key on keypad 47. The key sends a signal to UI 99. UI 99 responds by sending a signal to interface 31 and, after a two-second delay by sending a signal to sender 32. Interface 31 responds by going off-hook. Sender 32 responds by sending the appropriate music to the caller. Consequently, the caller will be played only whatever E. Picks: 0-9 & 01-09 pick from storage 98 that the user has chosen. In other words, the user's pick from E. Picks: 0-9 & 01-09 will serve as both the hold message and the entertainment. (Also, E. Picks 76 can be configured to function without hold message picker 74 or without specific-time hold message picker 51 and, instead, to function with a solitary hold message, for example, hold message A 71 described prior in the first example of this second embodiment. Further, E. Picks 76 can be configured to function such that the user provides a live hold message in place of, or in addition to, the pre-recorded/stored hold message. Also, E. Picks 76 can comprise entertainment picks displayed and picked from a graphical user interface, graphical user interface described later.)

Tiser 135 functions to provide the user with an advertiser hold message to selectively engage during an incoming call. An exemplary tiser 135 is depicted in FIG. 2b. The exemplary tiser 135 comprises a stored advertisement 136 shown as T.Z. 136 located at out-going message sender 32. For this example, sender 32 of message-then-hold circuitry 40 is configured to store and to deliver to a caller stored advertisement 136. Advertisers can pay to have stored advertisement 136 played by the called party. For each minute of play advertisement 136 gets, advertisers can pay the service provider a fee, and the service provider can in turn reduce the user's monthly bill by a percentage of the fee. As an example, Kmart agrees to pay the service provider $0.20 (i.e., 20 cents) each time an advertisement is played promoting their latest specials, and the service provider agrees to reduce the user's monthly service bill by $0.10 each time the user allows the Kmart advertisement to be played. Tracking (and thus accounting) of the number of times an advertisement is played, and by whom (i.e., the subscribers) can be tracked by a service-provider computer.

For this example, UI 99 (of starter 92) is configured to receive instruction from a user via a tiser button 138 shown as TZ 138, button TZ 138 electrically connected to (or connectable to) line 11a and located at telephone 27d. Button 138 is configured to send a control signal via line 11a to UI 99. UI 99 responds by signaling interface 31 to go off-hook (if not already off-hook) and by signaling sender 32. Provided that one of button 81, button 82 or button 83 of hold message picker 74 has been pressed prior during the incoming call, sender 32 responds by playing and sending advertisement 136 to the caller. (Button TZ 138 can be part of starter 92. In one variation, button 138 can be configured to send the signal to interface 31 and the signal to sender 32 directly, and without the user of starter 92.)

An example of operation of this second example of this second embodiment, employing tiser 135, will now be given (FIG. 2b). The embodiment operates as described above for the example of operation of the second example of the second embodiment (employing hold message picker 74) until the point where the user has pressed button 83. Sender 32 has responded by sending hold message C 73, “I'll be with you in a couple shakes” to the caller. (Interface 31 has gone off-hook.) The user is having trouble paying his cell phone bill and the person who the caller I.D. suggests is calling owes him money, 50 the user now presses button TZ 138. Pressed button TZ 138 sends a signal to UI 99. UI 99 responds by sending a signal to sender 32. Sender 32 responds by playing the advertisement stored in stored advertisement 136. When the user answers, the off-hook condition of telephone 27d is detected by interface 31. Interface 31 responds by discontinuing the off-hook condition.

Alternately, tiser 135 can be configured to function without hold message picker 74. As an example, the user has decided to put the caller on hold. The user does not press button 83 but, instead, twice presses button TZ 138. Sender 32 responds by playing and sending advertisement 136. (Also, tiser 135 can be configured to function without hold message picker 74 and, instead, to function with a solitary hold message such as hold message A 71 employed in the first example of this second embodiment. Further, tiser 135 can be configured to function such that the user provides a live hold message in the place of, or in addition to, the pre-recorded/stored hold message.)

Tiser 135 can be enhanced with an advertiser picker 137 shown as A.P. 137 located at message sender 32 in FIGS. 2b and 8. An exemplary advertiser picker 137 functions to provide the user with a choice of advertisers to pick from during an incoming call. As an example of operation of picker 137, button 138 is pressed-for-duration. Pressed-for-duration button 138 instructs UI 99 that tiser 135 is in operation and activates keys 0 through 9. Each pressed key 0 through 9 designates an advertisement stored in advertiser picks 137 to be played and sent by sender 32. Pressed key-1 plays and sends a McDonalds ad. Pressed key-2 plays and sends an IHOP ad and so forth. (Picks 137 can also employ keys 01 through 09, 001 through 009, etc. Picks 137 can comprise advertiser picks displayed and picked from a graphical user interface, graphical user interface described later.)

Message-then-hold circuitry 40 can comprise a content message-then-hold 55 shown in FIGS. 2b and 8. As an example of operation of content message-then-hold 55, responding to caller I.D. information provided with an incoming call, a user presses-for-duration control button 81 (for example). If button 81 had been pressed, but not for duration, hold message A 71, “I'll be right with you” would have been sent to the caller. However, with hold button 81 pressed-for-duration, UI 99 instructs message sender 32 to add message “to provide content” 56 shown as T.P.C. 56 to the message. In other words, sender 32 responds to pressed-for-duration button 81 by sending to the caller, “I'll be right with you to provide content”. Subsequent to sending the message, system 10 then remains idle until the content is delivered and the user answers the call, or until the content is delivered and the caller hangs up, or until the content is delivered and the system hangs up, or other. During the idle (on hold) period, the user can find, select and/or copy and send content (or a content's address or other) to the caller. The content can be content stored in the user's phone, stored at the service provider or stored on the internet, or other. Also, the hold message can be any of the described prior hold messages, or other, including any one of the messages of hold message picker 74, any one of messages stored in specific-time hold message storage 52, or other. Content sent to the caller can be content to be displayed on a display on the caller's telephone, content to be heard by the caller, content to be stored in the caller's phone or other.

Call handling system 10 can comprise an audio message selector 68. Message selector 68 functions to enable a user to select an audio message. An exemplary message selector 68 is shown in FIG. 2b. The exemplary selector 68 includes circuitry and/or programming to enable the user to select an audio message. The exemplary selector 68 is configured to select audio messages H.M. A 71, H.M.B 72 and H.M.C 73. The user finds a message, for example in a library of messages, to download to become H.M.A 71. The user selects the message and presses hold button 81 four times. Pressing button 81 four times signals message sender 32 to load the selected message into H.M.A 71. (During an incoming call, the user can then press button 81 and the selected hold message H.M.A 71 will be played to the caller as part of the operation of message-then-hold circuitry 40.) The user can employ the same selection process to download an audio message into H.M. B 72 (user employs button 82) and to download an audio message into H.M.C 73 (user employs button 83).

Message selector 68 can be employed by a user to select an audio message to be stored as any of the prior described audio messages including: callback message A 33, callback message B 34, callback message C 35, specific-time messages 36: 1-9 & 01-09, hold message A 71, hold message B 72, hold message C 73. Message selector 68 can be employed by a user to select to become any of the to be described audio messages (or other audio messages) including: Who-message 101, What/why-message 102, Who messages 107, What/why messages 108, stored advertisement 136, advertiser picks 137 and audio messages employed with message-then-record circuitry 310. A user can employ selector 68 to select an audio message, for example, to be download into message sender 32 from libraries of audio messages found on the internet via a computer or a WiFi connection (if system 10 is WiFi enabled) or via phone 27 if internet enabled, a recording device, libraries stored in handling system 10 itself or libraries stored at service provider 121, or from other sources. (Said libraries on the internet may be found on a service provider web site, a telephone manufacturer web site, or other. The stored information can also be stored on one or more memory devices which can be made accessible to the user via a service provider. The stored information can be stored elsewhere, for example, elsewhere at system 10 or elsewhere at telephone 27, or other.) Selector 68 can enable a user to record an (one or more) audio message to be stored.

In summary, the examples of the second embodiment (FIGS. 2a and 2b) preferably operate by: providing caller I.D. information to a user; receiving instruction from a user; going off-hook in response to the instruction received; sending a stored hold message to a caller in response to the instruction received; maintaining the off-hook condition until a user answers the incoming call (or the caller hangs up).

A third embodiment of telephone call handling system 10 is illustrated in FIGS. 3a and 3b. This third embodiment comprises caller I.D. circuitry 20 (described prior). This embodiment also comprises concert circuitry 50 and an orchestrator 93. (In one variation, this third embodiment comprises circuitry 20 and orchestrator 93, both located at a cell phone 165 (phone 165 described later) and interacts with, and can include, concert circuitry 50 located, for example, at service provider 121.)

Concert circuitry 50 functions to deliver entertainment simultaneously to a caller and to a user. An exemplary concert circuitry 50 is depicted in FIGS. 3a and 3b. The exemplary concert circuitry 50 comprises interface 31 (described prior), out-going message sender 32 (described prior) and an information signal provider 85.

Provider 85 functions to provide at least one signal to operate an information deliverer to deliver information to a user. An exemplary information signal provider 85 is depicted in FIGS. 3a and 3b. The exemplary provider 85 is electrically connected to (or connectable to) information deliverer 100 via line 11a. Deliverer 100 comprises one or more of: a telephone receiver 86, a telephone loudspeaker 87 and an earphone set 88 (telephones 27e and 270. Receiver 86, loudspeaker 87 and earphone set 88 are electrically connected to (or connectable to) line 11a.

Orchestrator 93 functions to receive instruction from a user to orchestrate concert circuitry 50. An exemplary orchestrator 93 is depicted in FIGS. 3a and 3b. The exemplary orchestrator 93 comprises user interface (shown as U.I.) 99 (described prior). UI 99 functions to receive instruction from a user.

A first example of this third embodiment is illustrated as system 10e in FIG. 3a. For this example, out-going message sender 32 of concert circuitry 50 is configured to provide stored entertainment 49 of user-selected entertainment 75 to a caller. Sender 32 is further configured to send entertainment 49 to information signal provider 85. Information signal provider 85 is configured to receive entertainment 49 from message sender 32 and to send entertainment 49 to deliverer 100 via line 11a. (Stored entertainment 49 and user-selected entertainment 75 described prior. Entertainment 49 can comprise music 77 and/or interesting sound 78 shown in FIGS. 2b, 3a, 3b and 8, described prior.) Stored entertainment 49 can comprise a song-last-played 111 (shown as S.L.P. 111 in FIGS. 2b, 3a, 3b and 8.) As an example, if handling system 10 is being employed as a music player (or other) and stored entertainment 49 (or pick storage 98 or other) is being played, message sender 32 is configured to store in song-last-played 111 the entertainment being played. When stored entertainment 49 is subsequently distinguished for play, sender 32 plays and sends song-last-played 111.

Further for this example, UI 99 of orchestrator 93 is configured to receive instruction from a user via a concert button 84 (shown as C 84) in conjunction with select entertainment button SE 48, buttons C 84 and SE 48 each electrically connected to (or connectable to) line 11a and located at telephone 27e. (Button SE 48 described prior.) UI 99 responds to a pressed button C 84 in conjunction with a pressed button SE 48 by sending a signal to interface 31 and, after a two second delay, by sending a signal to sender 32. Interface 31 responds by going off-hook. Sender 32 responds by playing and sending stored entertainment 49 to the caller. Sender 32 further responds by sending the played music to signal provider 85. (Buttons C 84 and SE 48 can be part of orchestrator 93. In one variation, button 81 can be configured to send the signal to interface 31 directly, and without the user of starter 92. In one variation, buttons C 84 and SE 48 can be configured to send the signal to interface 31 and the signal to sender 32 directly, and without the user of orchestrator 93.)

An example of operation of this first example of this third embodiment will now be given (FIG. 3a). A user's telephone is rung by an incoming ring signal provided by station 120 via line 11 and line 11a. Delivered with the ring signal is caller I.D. information. The information appears on display 21 (telephone 27e). The user recognizes the phone number on the display; i.e. the user essentially knows that his good friend Albert is calling. The user decides he'd like to share a song from his new Pink Lady album with Albert, the user having prior to the incoming call loaded the song into stored entertainment 49 of sender 32. Accordingly, the user presses concert button C 84. The user then presses select entertainment button SE 48. When pressed, buttons C 84 and SE 48 each send a control signal to UI 99. UI 99 responds to the succession of signals by sending a signal to interface 31 and, after a two-second delay, by sending a signal to sender 32. Interface 31 responds by going off-hook. Sender 32 responds by playing the song stored in stored entertainment 49 and by sending the played music to the caller via line 11 and switching station 120. Sender 32 further responds by sending the played music to signal provider 85. Provider 85 responds by sending the played music to earphone 88 (or loudspeaker 87 or both) of deliverer 100 and, thus, to the user (via line 11a). Both caller and user then enjoy the music.

Subsequently, the user decides he wants to speak with the caller while they both enjoy the music. The user answers his phone. Interface 31 responds to the off-hook phone by sending a signal to provider 85 and by communicably connecting caller and user. Provider 85 responds by discontinuing the music to earphone 88 and by instead sending the played music to telephone receiver 86. Caller and user now converse while the music plays. At conclusion to the concert/conversation, the user hangs up his phone. Interface 31 responds to the on-hook condition at telephone 27e by communicably disconnecting caller and user and by sending a signal to sender 32. Sender 32 responds by discontinuing the playing and sending of stored entertainment 49. (If the caller hangs up prior to the user hang-up, interface 31 can respond to the caller hang-up by discontinuing the off-hook condition.)

A second example of this third embodiment is illustrated as system 10f in FIG. 3b. This second example comprises the first example configured with one or more of: E. Picks 76 and an auto-hold 89, these additional features serving to enhance the performance. (E. Picks 76 described prior.)

A first example of this second example of this third embodiment, employing E. Picks 76, will now be given (FIG. 3b). For this example, out-going message sender 32 is configured to deliver to a caller one of a plurality of entertainment choices stored in pick storage 98 shown as E. Picks: 1-9 & 01-09. Sender 32 is further configured to deliver to signal provider 85 one of a plurality of entertainment choices stored in pick storage 98 E. Picks: 1-9 & 01-09. (Storage 98 can comprise music 77 and/or interesting sound 78, or other, described prior.) Information signal provider 85 is configured to receive one of pick storage 98 E. Picks: 1-9 & 01-09 from message sender 32 and to send the one of pick storage 98 E. Picks: 1-9 & 01-09 to deliverer 100 via line 11a.

Further for this example, UI 99 of orchestrator 93 is configured to receive instruction from a user via concert button C 84, E. Picks button EP 79 and one key, or two keys (or more) pressed in succession, from keypad 47, keypad 47 comprising keys 1 through 0. Button C 84, button EP 79 and keys 1 through 0 each are electrically connected to (or connectable to) line 11a and located at telephone 27f. UI 99 is also configured to send a signal to sender 32 as well as to send a signal to interface 31. (Button EP 79 and keypad 47, described prior, can be part of orchestrator 93. In one variation, buttons C 84, EP 79 and keypad 47 can be configured to send the signal to interface 31 and the signal to sender 32 directly, and without the user of orchestrator 93.)

An example of operation of this second example of this third embodiment, employing E. Picks 76, will now be given (FIG. 3b). A user's telephone is rung by an incoming ring signal provided by station 120 via line 11 and line 11a. Delivered with the ring signal is caller I.D. information. The information appears on display 21 (telephone 270. The user recognizes the phone number on the display; i.e. the user essentially knows that his brother Bobby is calling.

The user can consider their mood at that moment along with the identity of the caller and deploy the most appropriate entertainment by picking one of pick storage 98 E. Picks: 1-9 & 01-09. The user decides he'd like to share “sounds of nature” with Bobby, the user having prior to the incoming call loaded “sounds of nature” into E. Pick-04 of pick storage 98. Accordingly, the user presses concert button C 84. The user then presses button EP 79. The user then presses key-0 and key-4. Pressed button EP 79 activates keypad 47. Button C 84 followed by key-0 and key-4 each sends a control signal to UI 99. UI 99 responds to the succession of signals by sending a signal to interface 31 and, after a two-second delay, sending a signal to sender 32. Interface 31 responds by going off-hook. Sender 32 responds by playing E. Pick-04 from pick storage 98 and sending the played sound to the caller via line 11 and switching station 120. Sender 32 further responds by sending the played sound to signal provider 85. Provider 85 responds by sending the played sound to loudspeaker 87 of deliverer 100 and, thus, to the user (via line 11a). Both caller and user then enjoy sounds of nature.

Subsequently, the user decides he wants to speak with the caller while they both enjoy the sound. The user answers his phone. Interface 31 responds to the off-hook phone by sending a signal to provider 85 and by communicably connecting caller and user. Provider 85 responds by discontinuing the sound to loudspeaker 87 and by instead sending the played sound to telephone receiver 86. Caller and user now converse while the sound plays. At conclusion to the concert/conversation, the user hangs up his phone. Interface 31 responds to the on-hook condition by communicably disconnecting caller and user and by sending a signal to sender 32. Sender 32 responds by discontinuing the playing and sending of E. Pick-04.

A second example of operation of this second example of this third embodiment, employing E. Picks 76, will now be given (FIG. 3b). A user desires to employ handling system 10 as a music player. The user decides he wants to hear the music stored in E. Pick-6 of pick storage 98. To do so (with no incoming call present), the user presses button C 84 twice, then presses button EP 79 and then presses key-6. Pressed button EP 79 activates keypad 47. Each of the two presses of button C 84 sends a signal to UI 99 followed by a signal from the pressed key-6 also sent to UI 99. UI 99 responds to the succession of signals by sending a signal to sender 32. (No signal sent to interface 31.) Sender 32 responds by playing E. Pick-6 from pick storage 98 and sending the played music to signal provider 85. Provider 85 responds by sending the played music to earphone 88 (or loudspeaker 87 or both) of deliverer 100 and, thus, to the user (via line 11a).

Sometime later, the user's telephone now is rung by an incoming ring signal from station 120 via line 11 and line 11a. With the ring signal is caller I.D. information displayed on display 21 (telephone 27f.). The user does not recognize the phone number on the display. However, the user is in a social mood so he decides to share the music he is enjoying with this caller. To do so, the user again presses the concert button C 84. Pressed button C 84 sends a control signal to UI 99. UI 99 responds by sending a signal to interface 31 and, after a one-second delay, by sending a signal to message sender 32. Interface 31 responds by going off-hook. Sender 32 responds by sending the playing music (E. Pick-6) to the caller via line 11 and switching station 120. User and caller may enjoy the music. (Alternately, the user can send a music/sound to the caller other than the music/sound the user is listening to. As an example of operation, responsive to the caller I.D. information, the user presses-for-duration button C 84 then presses button EP 79 and key-4. Consequently, sender 32 plays and sends E. Pick-4 to the caller while the user may continue listening to E. Pick-6. The user may then discontinue the music (or sound) being sent to caller and user and answer the call, or other. As another example of operation, responsive to the caller I.D. information, the user presses for duration button SE 48. Consequently, sender 32 plays and sends stored entertainment 49 to the caller while the user may continue listening to E. Pick-6.)

Subsequently, the user decides he wants to speak with the caller while they both enjoy the music. The user answers his phone. Interface 31 responds to the off-hook phone by sending a signal to provider 85 and by communicably connecting caller and user. Provider 85 responds by discontinuing the music to earphone 88 and by instead sending the played music to telephone receiver 86. Caller and user converse while the music plays. When the user hangs up his phone, interface 31 responds to the on-hook condition by communicably disconnecting caller and user and by sending a signal to sender 32. Sender 32 responds by discontinuing the playing and sending of E. Pick-6. Alternately, the user can decide to discontinue the concert prior to (or while) speaking with the caller. In that case, for example, the user twice presses the concert button C 84. The two signals from C 84 are received by UI 99. UI 99 responds by sending a signal to sender 32. Sender 32 responds by discontinuing the playing and sending of E. Pick-6. The user then answers his phone and talks to the caller (or keeps talking to the caller).

A second example of this second example of this third embodiment, employing auto-hold 89, will now be given (FIG. 3b). (This second example comprises the first example of this second example of this third embodiment further comprising auto-hold 89.) Auto-hold 89 functions to automatically place a caller on hold. An exemplary auto-hold 89 comprises an auto-hold button 97 shown as AH 97 located at telephone 27f and a call detector 96 shown as C.D. 96 located at interface 31. Call detector 96 functions to detect an incoming call, for example, by detecting the presence of an incoming ring signal on line 11. When pressed, button AH 97 sends a signal to UI 99 via line 11a. UI 99 responds by waiting for a signal from call detector 96. Upon detecting a ring signal, call detector 96 responds by sending a signal to UI 99. If button AH 97 has been pressed, in response to the signal from detector 96, UI 99 delays three-seconds and then signals interface 31. Interface 31 responds by going off-hook. (Button AH 97 can be part of orchestrator 93. In one variation, button AH 97 can be configured to send the signal to interface 31 directly, and without the user of orchestrator 93)

An example of operation of this second example of this second example of this third embodiment, employing auto-hold 89, will now be given (FIG. 3b). The user first presses the auto-hold AH 97 button. The user desires to employ E. Picks 76 as a music player and, to do so, follows the procedure described above in the second example of operation of this second example of this third embodiment. Sender 32 responds by playing the E. Pick picked by the user and by sending the played music to signal provider 85. Provider 85 responds by sending the played music to earphone 88 of deliverer 100 and, thus, to the user (via line 11a).

Subsequently, the user's telephone receives an incoming ring signal from station 120 via line 11 and line 11a. With the ring signal is caller I.D. information displayed on display 21 (telephone 27f.). From the information, the user pretty much knows that Mark is calling. The user decides that rather than immediately answer the call, he'd prefer to take his time answering and, also, he wants Mark to hear the music that the user is listening to. Having previously activated auto-hold 89, the user simply waits. Call detector 96, upon detecting the presence of the incoming ring signal on line 11, responds by sending a signal to UI 99. UI 99 responds by delaying three seconds and then sending a signal to interface 31. Interface 31 responds by going off-hook. UI 99 also sends a signal to sender 32 (also after the three-second delay). Sender 32 responds by sending the music being played to the user to the caller via line 11 and station 120. Now, user and caller may simultaneously enjoy the music. (The user then can answer the call while the music continues to be played or can answer after the music has concluded. Alternately, the user can stop the playing music and then answer or can answer and then stop the playing, said answering and stopping as described above in the second example of operation of this second example of this third embodiment.

Also, message-then-hold circuitry 40 can comprise auto-hold 89. As an example of operation, the user first presses the auto-hold AH 97 button. The user then presses a hold message button, or buttons, including SE 48 and EP 79. Subsequently, auto-hold 89 detects an incoming call and signals interface 31 and sender 32. In response, interface 31 goes off-hook and sender 32 sends a hold message to the caller, including or not hold entertainment/content.

User-selected entertainment 75 and E. Picks 76 (or other) can be enhanced with a volume control 112 shown as VC 112 shown located at telephone 27 in FIGS. 2b, 3a, 3b and 8. An exemplary volume control 112 functions to enable a user to control the volume of stored entertainment 49 and/or pick storage 98 E. Picks: 1-9 & 01-09. The exemplary volume control 112 is electrically connected to (or connectable to) message sender 32 via line 11a and UI 99. (Volume control 112 can be further configured to control the volume of any/all messages/information sent from sender 32 to the caller.)

Concert circuitry 50 can be enhanced with a fader 113 shown in FIGS. 3a, 3b and 8. Fader 113 functions to fade out the entertainment. An exemplary fader 113 comprises fader button 114 shown as F 114 and fader circuitry 119 shown as F.C. 119. Button F 114 is electrically connected to (or connectable to) message sender 32 and to interface 31 via line 11a and UI 99. Pressed button F 114 turns on fader 113.

Pressed again button F 114 turns off fader 113. Interface 31 detects the user's phone off-hook and signals fader circuitry 119. When fader 113 is on, circuitry 119 responds to the signal by lowering the volume of the playing entertainment over a set or user adjustable period of time.

Concert circuitry 50, and also message-then-hold circuitry 40, can comprise a disk jockey 115, shown in FIGS. 2b, 3b and 8. Disc jockey 115 functions to enable the user to announce entertainment (or advertisement). An exemplary disc jockey 115 comprises button 116 shown as DJ 116 and disc jockey circuitry 126 shown as D.J. 126. Button 116 is electrically connected to (or connectable to) jockey circuitry 126 located at interface 31 via line 11a and UI 99. As an example of operation, pressed button DJ 116 instructs jockey circuitry 126 to connect the microphone of the user's telephone to line 11 such that the caller can hear the user's but the user can't hear the caller's voice. (Alternately, circuitry 126 can also allow the user to hear the caller's voice and, also, can be configured to provided a pre-recorded message via sender 32 to introduce the entertainment in place of, or in addition to, the live user introduction.)

Concert circuitry 50, and also message-then-hold circuitry 40, can comprise a shuffler 117, shown in FIGS. 2b, 3b and 8. Shuffler 115 functions to choose entertainment (or advertisement). An exemplary shuffler 117 comprises shuffler button 118 shown as SH 118 and shuffler circuitry 127 shown as S.H. 127. Button 118 is electrically connected to (or connectable to) shuffler circuitry 127 located at sender 32 via line 11a and UT 99. Pressed button SH 118 turns on shuffler 117. Pressed again SH 118 turns off shuffler 117. As an example of operation, with shuffler 117 on, the user presses concert button C 84. Shuffler circuitry 127 responds by randomly choosing one of storage 98 E. Picks: 1-9 & 01-09 (or one of some other storage) and plays and sends the entertainment to caller and user. As another example, with shuffler 117 on, the user presses one buttons 81, 82 or 83 of message picker 74 and then presses button EP 79. The respective hold message is played. Shuffler circuitry 127 then chooses and plays to the caller one of storage 98E. Picks: 1-9 & 01-09. (Button SH 118 can be part of starter 92 and/or part of orchestartor 93. In one variation, button SH 118 can be configured to send the signal to shuffler circuitry 127 directly, and without the user of orchestrator 93.)

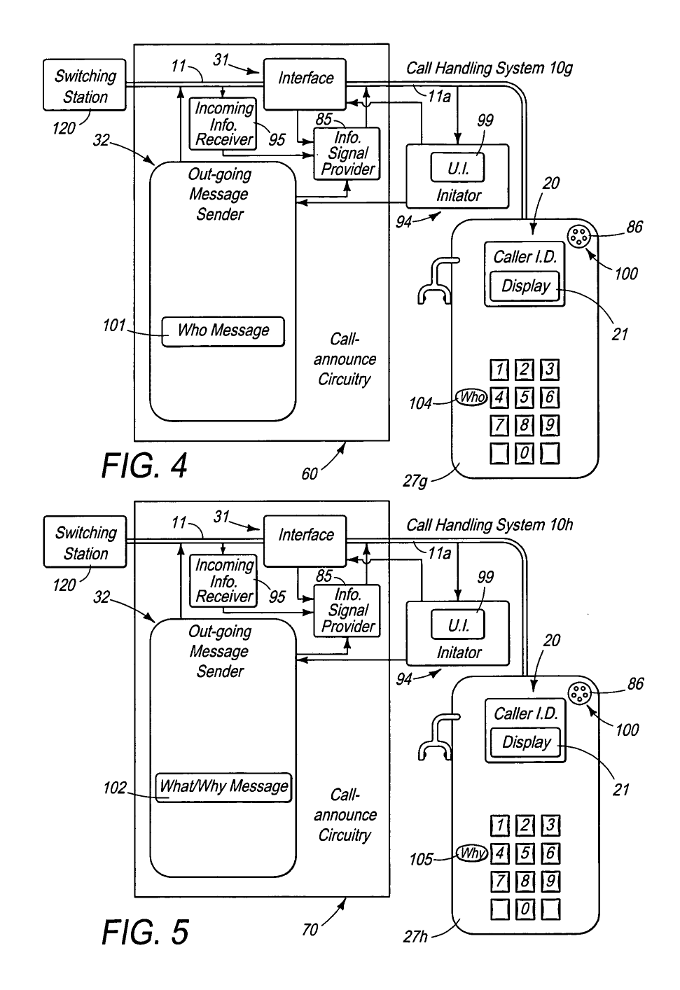

Concert circuitry 50, and also message-then-hold circuitry 40, can comprise a caller-picked entertainment 123, shown in FIGS. 2b, 3b and 8. Picked entertainment 123 functions to enable the caller to pick entertainment (or advertisement). An example of operation of the second example of the second embodiment (message-then-hold circuitry 40, employing E. Picks 76) employing an exemplary caller picked entertainment 123, will now be given. The embodiment operates as described for the example of operation of the second example of the second embodiment (employing hold message picker 74) until the point where the user has pressed button 83. Sender 32 has responded by sending hold message C 73, “I'll be with you in a couple shakes” to the caller. (Interface 31 has gone off-hook.) The user now presses-for-duration (e.g. pressed for 2 seconds or more) button EP 79. Pressed-for-duration button EP 79 instructs UI 99 to operate caller picked entertainment 123. UI 99 responds by sending a signal to message sender 32. Sender 32 responds by playing and sending to the caller, “To hear rap press (or say) one, to hear funk press two, to hear country press three”, and so on. The caller presses one and the pick is received at information receiver 95. (Receiver 95 is described later and shown in FIGS. 4, 5, 6 and 8. For this example, receiver 95 is configured to receive DTMF signals.) Receiver 95 responds by sending a signal to sender 32 (FIG. 8). Sender 32 responds by playing and sending pick-1 of storage 98 to the caller. (Entertainment 123 can also employ E. Picks 76, or other, when entertainment 123 is employed with circuitry 50.)

In summary, the examples of the third embodiment (FIGS. 3a and 3b) preferably operate by: providing caller I.D. information to a user; receiving instruction from a user; going off-hook in response to the instruction received; and delivering entertainment simultaneously to a caller and to a user in response to the instruction received.

A fourth embodiment of telephone call handling system 10 is illustrated in FIG. 4. This fourth embodiment comprises caller I.D. circuitry 20 (described prior). This embodiment also comprises call-announce circuitry configured to attain who-information 60, and an initiator 94. (In one variation, this fourth embodiment comprises circuitry 20 and initiator 94, both located at a cell phone 165 (phone 165 described later) and interacts with, and can include, circuitry 60 located, for example, at service provider 121.)

Call-announce circuitry 60 functions to answer a telephone call and to attain call-announce information input by a caller and to provide at least one signal to deliver at least some of the attained information to a user. An exemplary call-announce circuitry 60 is depicted in FIG. 4. The exemplary call-announce circuitry 60 comprises interface 31 (described prior), out-going message sender 32 (described prior), information signal provider 85 (described prior) and an incoming information receiver 95.

Information receiver 95 functions to receive information input by a caller. An exemplary information receiver 95 is depicted in FIG. 4. The exemplary receiver 95 is electrically connected to (or connectable to) line 11 and therefrom receives spoken information from the caller.

Initiator 94 functions to receive instruction from a user to initiate call-announce circuitry configured to attain who-information 60. An exemplary initiator 94 is depicted in FIG. 4. (Additionally, initiator 94 can function to receive instruction from a user to initiate call-announce circuitry configured to attain what/why-information 70, circuitry 70 described later.) The exemplary initiator 94 comprises user interface UI 99 (shown as U.I. 99). UI 99 functions to receive instruction from a user.

An example of this fourth embodiment is illustrated as system 10g in FIG. 4. For this example, out-going message sender 32 of call-announce circuitry 60 is configured to store and to send to a caller a who-message 101. Who-message 101 states (for example), “Whom may I say is calling?”

Further for this example, UI 99 of initiator 94 is configured to receive instruction from a user via a control button Who 104, button Who 104 electrically connected to (or connectable to) line 11a and located at telephone 27g. When pressed, button Who 104 sends a control signal to UI 99. UT 99 responds by sending a signal to interface 31 and, after a two-second delay, by sending a signal to sender 32. Interface 31 responds by going off-hook. Sender 32 responds by sending who-message 101 to the caller. (Button Who 104 can be part of initiator 94. In one variation, button 104 can be configured to send the signal to interface 31 and the signal to sender 32 directly, and without the user of initiator 94.)

An example of operation of this example of this fourth embodiment will now be given (FIG. 4). A user's telephone is rung by an incoming ring signal from station 120 via line 11 and line 11a. Delivered with the ring signal is caller I.D. information. The information appears on display 21 (telephone 27g). Display 21 shows the caller as “Private Caller”. Accordingly, the user does not know who's calling. The user presses button Who 104. Button Who 104 sends a control signal to UI 99. UI 99 responds by sending a signal to interface 31 and, after a two-second delay, by sending a signal to sender 32. Interface 31 responds by going off-hook. Sender 32 responds by sending who-message 101, “Whom may I say is calling?” to the caller. The caller then states his name, “Paul Bunyun”. Information receiver 95 receives the stated “Paul Bunyun” information. Receiver 95 forwards the information to information signal provider 85. Provider 85 forwards the information to telephone receiver 86 (or loudspeaker 87, or other) of information deliverer 100 via line 11a. Receiver 86 emits “Paul Bunyun”. The user hears the response and recognizes the caller. The user then answers the call (or not). (If not, after a given amount of delay, the caller can be forwarded to an answering machine or voice mail or other and interface 31 can discontinue the off-hook condition. (If the caller hangs up prior to the user answering or prior to said answering machine or voice mail, interface 31 can respond by discontinuing the off-hook condition.)

In summary, the example of the fourth embodiment (FIG. 4) preferably operates by: providing caller I.D. information to a user; receiving instruction from a user; going off-hook in response to the instruction received; sending a stored who-message to a caller in response to the instruction received; receiving who-information from a caller; and providing at least one signal to operate an information deliverer to deliver who-information to a user.

A fifth embodiment of telephone call handling system 10 is illustrated in FIG. 5. This fifth embodiment comprises caller I.D. circuitry 20 (described prior). This embodiment also comprises call-announce circuitry configured to attain what/why-information 70, and initiator 94 (initiator 94 described prior). (In one variation, this fifth embodiment comprises circuitry 20 and initiator 94, both located at a cell phone 165 (phone 165 described later) and interacts with, and can include, circuitry 70 located, for example, at service provider 121.)

Call-announce circuitry 70 functions to answer a telephone call and attain call-announce information input by a caller and to provide at least one signal to deliver at least some of the attained information to a user. An exemplary call-announce circuitry 70 is depicted in FIG. 5. The exemplary call-announce circuitry 70 comprises interface 31 (described prior), out-going message sender 32 (described prior), information signal provider 85 (described prior) and incoming information receiver 95 (described prior).

An example of this fifth embodiment is illustrated as system 10h in FIG. 5. For this example, out-going message sender 32 of call-announce circuitry 70 is configured to store and to provide to a caller a what/why-message 102. What/why-message 102 states (for example), “What may I say you are calling about?”

Further for this example, UI 99 of initiator 94 is configured to receive instruction from a user via a control button Why 105, button Why 105 electrically connected to (or connectable to) line 11a and located at telephone 27h. When pressed, button Why 105 sends a control signal to UI 99. UI 99 responds by sending a signal to interface 31 and, after a two-second delay, by sending a signal to sender 32. Interface 31 responds by going off-hook. Sender 32 responds by sending what/why-message 102 to the caller. (Button Why 105 can be part of initiator 94. In one variation, button 105 can be configured to send the signal to interface 31 and the signal to sender 32 directly, and without the user of initiator 94.)

An example of operation of this example of this fifth embodiment will now be given (FIG. 5). A user's telephone is rung by an incoming ring signal from station 120 via line 11 and line 11a. Delivered with the ring signal is caller I.D. information. The information appears on display 21 (telephone 27h). The user recognizes the phone number on the display; i.e. the user is mostly certain that his good friend Monte is calling. However, the user is extremely busy and doesn't have time for small talk. Therefore, the user presses button Why 105. Button Why 105 sends a control signal to UI 99. UI 99 responds by sending a signal to interface 31 and, after a two-second delay, by sending a signal to sender 32. Interface 31 responds by going off-hook. Sender 32 responds by sending what/why-message 102, “What may I say you are calling about?” to the caller. The caller then states, “I need my basketball back”. Information receiver 95 receives the stated information and forwards the information to information signal provider 85. Provider 85 forwards the information to telephone receiver 86 of information deliverer 100 via line 11a. Receiver 86 emits, “I want my basketball back”. The user hears the response, doesn't care to deal with this right now and doesn't answer the call. (After a given amount of delay, the call can be forwarded to a voice mail system, or other.)

In summary, the example of the fifth embodiment (FIG. 5) preferably operates by: providing caller I.D. information to a user; receiving instruction from a user; going off-hook in response to the instruction received; sending a stored what/why-message to a caller in response to the instruction received; receiving what/why-information from a caller; and providing at least one signal to operate an information deliverer to deliver what/why-information to a user.

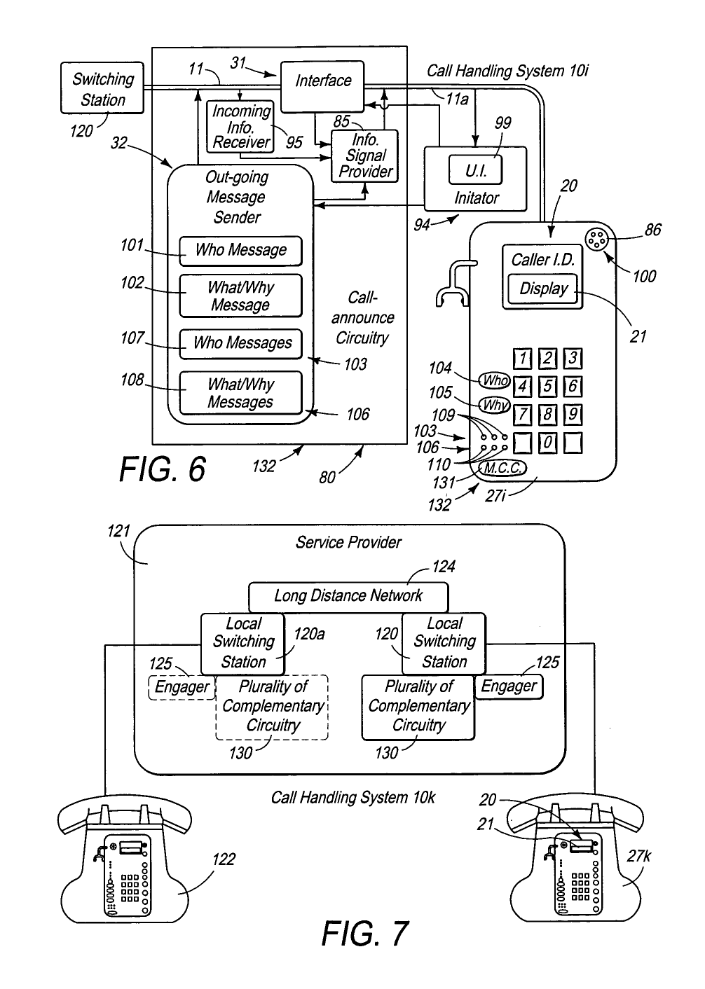

A sixth embodiment of telephone call handling system 10 is illustrated in FIG. 6. This sixth embodiment comprises caller I.D. circuitry 20 (described prior). This embodiment also comprises call-announce circuitry configured to attain who-information and what/why-information 80, and an initiator 94 (initiator 94 described prior). (In one variation, this sixth embodiment comprises circuitry 20 and initiator 94, both located at a cell phone 165 (phone 165 described later) and interacts with, and can include, circuitry 80 located, for example, at service provider 121.)

Call-announce circuitry 80 functions to answer a telephone call and attain call-announce information input by a caller and to provide at least one signal to deliver at least some of the attained information to a user. An exemplary call-announce circuitry 80 is depicted in FIG. 6. The exemplary call-announce circuitry 80 comprises interface 31 (described prior), out-going message sender 32 (described prior), information signal provider 85 (described prior) and incoming information receiver 95 (described prior).

An example of this sixth embodiment is illustrated as system 10i in FIG. 6. For this example, message sender 32 of call-announce circuitry 80 is configured to store and to provide to a caller who-message 101. Sender 32 is further configured to store and to provide to a caller what/why-message 102. When sent to a caller, who-message 101 provides to ask the caller to identify him or her self. When sent to a caller, what/why-message 102 provides to ask the caller the purpose of the call.

For this example, UI 99 of initiator 94 is configured to receive instruction from a user via control button Who 104 and, also, via control button Why 105, button Who 104 and button Why 105 each electrically connected to (or connectable to) line 11a and located at telephone 27i. When pressed, button Who 104 sends a control signal to UI 99. When pressed, button Why 105 sends a control signal to UI 99. UI 99 responds to each signal, respectively, by sending a signal to interface 31. After a two-second delay, UI 99 further responds to each by sending a signal to sender 32. Interface 31 responds by going off-hook. Sender 32 responds to pressed button Who 104 by sending who-message 101 to the caller. Sender 32 responds to pressed button Why 105 by sending what/why-message 102 to the caller.

An example of operation of this first example of this sixth embodiment will now be given (FIG. 6). A user's telephone is rung by an incoming ring signal provided by station 120 via line 11 and line 11a. Delivered with the ring signal is caller I.D. information. Display 21 shows a telephone number and name foreign to the user. The user presses button Who 104. Button Who 104 sends a control signal to UI 99. UI 99 responds by sending a signal to interface 31 and, after a two-second delay, by sending a signal to sender 32. Interface 31 responds by going off-hook. Sender 32 responds by sending who-message 101, “Whom may I say is calling?” to the caller. The caller then states his name, “Mike Dimple”. Information receiver 95 receives the stated “Mike Dimple” information and forwards the information to information signal provider 85. Provider 85 forwards the information to telephone receiver 86 of information deliverer 100 via line 11a. Receiver 86 emits “Mike Dimple”.

The user does not recognize this person. And so, the user then presses button Why 105. Sender 32 responds by sending what/why-message 102, “What may I say you are calling about?” to the caller. The caller then states, “I heard you were shopping for life insurance”. Information receiver 95 receives the stated information and forwards the information to information signal provider 85. Provider 85 forwards the information to telephone receiver 86 (and/or loudspeaker 87) of information deliverer 100 via line 11a. Receiver 86 emits, “I heard you were shopping for life insurance”. The user doesn't care to talk with this person and, therefore, does not answer the call. After a given amount of delay, the call can be forwarded to a voice mail system, or other. (Alternately, the user can choose to press button Who 104 but not followed by pressing button Why 105. Alternately, the user can choose to press button Why 105 followed by pressing Who 104, or can choose to press button Why 105 only.)

This sixth embodiment can be configured with a who message picker 103 and/or a what/why message picker 106 (FIG. 6), these additional features serving to enhance performance.

An exemplary who-message picker 103 comprises who-messages 107 located at sender 32 and who-buttons 109 located at telephone 27i. An exemplary what/why-message picker 106 comprises what/why-messages 108 located at sender 32 and why-buttons 110 located at telephone 27i. For this example, out-going message sender 32 is configured to play and send to a caller one of who-messages 107. Message sender 32 is further configured to play and send to a caller one of what/why messages 108. Who-buttons 109 and why-buttons 110 are each electrically connected to (or connectable to) line 11a and each sends a control signal to UI 99 when pressed. (Who-buttons 109 and why-buttons 110 can be part of initiator 94.)

Who-message picker 103 and what/why-message picker 106 each can be configured to operate as described for callback message picker 38 (FIG. 1b) or as described for hold message picker 74 (FIG. 2b). In other words, each pressed button of buttons 109 serves to instruct sender 32 (via line 11a and UI 99) to send the corresponding message from who-messages 107 to the caller. Each pressed button of buttons 110 serves to instruct sender 32 (via line 11a and UI 99) to send the corresponding message from what/why-messages 108 to the caller. (The fourth embodiment, FIG. 4, can further comprise who message picker 103. The fifth embodiment, FIG. 5, can further comprise what/why message picker 106.)

In summary, the example of the sixth embodiment (FIG. 6) operates by: providing caller I.D. information to a user; receiving instruction from a user; going off-hook in response to the instruction received; sending a stored who-message and/or sending a stored what/why-message to a caller in response to the instruction received; receiving who-information and/or what/why-information from a caller; and providing at least one signal to operate an information deliverer to deliver who and/or what/why information to a user.

Call announce circuitry configured to attain who information 60 and/or call announce circuitry configured to attain what/why information 70 can be configured to operate in conjunction with conventional telephone hardware and/or software to comprise a missed-call announce 132 shown in FIG. 6. Missed-call announce 132 functions to provide call announce information to a user regarding a missed-call. An exemplary missed call announce 132 comprises a missed call circuitry 131 shown as M.C.C. 131, circuitry 131 shown located at telephone 27i in FIG. 6 (and at telephone 27j in FIG. 8). Missed call circuitry 131 can comprise a conventional telephone component. For this example, missed call circuitry 131 is configured such that a user can select a missed call from circuitry 131 and the telephone will dial the number of the missed call. As an example of operation, the user scrolls through a list supplied by missed call circuitry 131 as displayed on display 21 and selects a missed call. The user then presses button Who 104 followed by, for example, a conventional telephone hardware telephone talk button. Circuitry 131 responds to the pressed talk button by dialing the selected missed-call number. When the telephone of the missed-call number is answered, interface 31 responds to the answering, as instructed by pressed button Who 104, by signaling message sender 32 (signaling shown in FIG. 8). Sender 32 responds by waiting three seconds and then playing a who-message such as, “Whom may I say has recently called 652-8834 (user's phone number)?” The response from the missed caller's telephone is then delivered to the user as prior described for the operation of call announce circuitry configured to attain who information 60.

Call handling system 10 can be bundled with an advertiser 128 shown as A. 128 in FIG. 8. Advertiser 128 functions to advertise, for example, a telephone manufacturer or service provider or other. As an example of operation of an exemplary advertiser 128, callback message A 33 states, “Please callback in one hour”. When bundled with advertiser 128, callback message A 33 can then state, “Rayphone, please callback in one hour”. (Advertiser 128 can also be bundled with callback message B 34, callback message C 35, each of specific-time messages 36: 1-9 & 01-09, stored entertainment 49, hold message A 71, hold message B 72, hold message C 73, each of storage 98 E. Picks: 1-9 & 01-09, Who-message 101, What/why-message 102, each of Who messages 107, each of What/why messages 108, or other.)

A seventh embodiment of telephone call handling system 10 is illustrated in FIG. 8. This seventh embodiment comprises caller I.D. circuitry 20 (described prior). This embodiment also comprises a plurality of complementary circuitry 130 and an engager 125. (In one variation, this seventh embodiment comprises circuitry 20 and engager 125, both located at a cell phone 165 (phone 165 described later) and interacts with, and can include, complementary circuitry 130 located, for example, at service provider 121.)

Plurality of complementary circuitry 130 functions to provide a plurality of complementary circuitry for a user to selectively engage. An exemplary plurality of complementary circuitry 130 is depicted in FIG. 8. Each circuitry of plurality of complementary circuitry 130, when engaged, can send a response to the source of an incoming call, the source as identified (or not) by caller I.D. 20.

The exemplary plurality of complementary circuitry 130 comprises: callback message circuitry 30 (FIGS. 1a and 1b); message-then-hold circuitry 40 (FIGS. 2a and 2b); concert circuitry 50 (FIGS. 3a and 3b); call announce circuitry configured to attain who-information 60 (FIG. 4), and call-announce circuitry configured to attain what/why-information 70 (FIG. 5).

Engager 125 functions to receive instruction from a user to selectively engage one or more of plurality of complementary circuitry 130. An exemplary engager 125 is depicted in FIG. 8. The exemplary engager 125 provides the prior described functionality of activator 91, starter 92, orchestrator 93 and initiator 94. Engager 125 comprises user interface (shown as U.I.) 99. UI 99 functions to receive instruction from a user.

An example of this seventh embodiment is illustrated as call handling system 10j in FIG. 8. This exemplary embodiment comprises a combining of the examples of handling system 10 illustrated in FIGS. 1a, 1b, 2a, 2b, 3a, 3b, 4 and 5.

But one example of operation of this seventh embodiment will now be given (FIG. 8). A user's telephone is rung by an incoming ring signal provided by station 120 via line 11 and line 11a. Delivered with the ring signal is caller I.D. information. Display 21 shows a telephone number and name recognized by the user as his friend Bud's cell phone. Plurality of complementary call handling circuitry 130 is available for the user to selectively engage via the associated buttons located on telephone 27j. The user is quite busy and, therefore, chooses between sending a callback message to the caller (callback message circuitry 30, FIGS. 1a and 1b), placing the caller on hold (message-then-hold circuitry 40, FIGS. 2a and 2b) or attain what/why-information from the caller (call announce circuitry configured to attain what/why-information 70, FIG. 5). (Because the user is quite busy and mostly certain that Bud is calling, the user does not see engaging call announce circuitry configured to attain who-information 60 as an option at this time. Because the user is quite busy, engaging concert circuitry 50 is also not an attractive option at this time.) The user decides to send a callback message to the caller. The user presses button 44. Button 44 sends a control signal to UI 99. UI 99 responds by sending a signal to interface 31 and, after a two-second delay, by sending a signal to sender 32. Interface 31 responds by going off-hook. Sender 32 responds by sending callback message B 34, “Please call back tomorrow” to the caller. The caller hears the message and understands to call the user back on the following day. At the conclusion to the sending of the message, message sender 32 sends a signal to interface 31. Interface 31 responds by discontinuing the off-hook condition. (Interface 31 can respond to a caller hang-up by discontinuing the off-hook condition.)

This seventh embodiment can be enhanced with a rapid-fire 140 shown as R.F. 140. Rapid-fire 140 functions to enable a next choice to be chosen from the one or more plurality of complementary circuitry 130 at will. An exemplary rapid-fire 140 is shown located at sender 32 in FIG. 8. An example of this seventh embodiment (FIG. 8) when enhanced with the exemplary rapid-fire 140 will now be given. One of plurality of complementary circuitry 130 has been engaged prior and, therefore, is presently being employed. Upon receiving a signal from a pressed control button, UI 99 of engager 125 is configured to engage a next choice of complementary circuitry (of plurality of complementary circuitry 130), the next choice of complementary circuitry engaged immediately. Upon receiving a signal from a pressed-for-duration control button, UI 99 of engager 125 is configured to engage a next choice of complementary circuitry (of plurality of complementary circuitry 130) the next choice of complementary circuitry engaged upon conclusion to the operation of the prior engaged complementary circuitry.

But one example of operation of this example of this seventh embodiment when enhanced with the exemplary rapid-fire 140 will now be given. A user's telephone receives an incoming ring signal from station 120 via line 11 and line 11a. Delivered with the ring signal is caller I.D. information. The caller I.D. information appears on display 21 (telephone 27j). The user recognizes the phone number on the display; i.e. the user is certain that the call is from his friend Molly's cell-phone. However, the user is extremely busy and, also, feeling just a bit playful. The user initially presses control button 43. Pressed button 43 implements callback message circuitry 30 (as depicted in FIGS. 1a and 1b). Callback message A 33 is sent to the caller, stating “Please call back in one hour”. However, before the sending of the message has concluded, the user presses control button 82. Pressed button 82 immediately engages message-then-hold circuitry 40 (as depicted in FIG. 2b.) Hold message B 72 is sent to the caller, stating “Hold your horses, I'll be there in a jiffy”. Sender 32 then plays and sends stored entertainment 49 to the caller. Handling system 10h remains idle (on hold, maintaining the off-hook condition) while entertainment 49 continues to be played and sent to the caller. After a period of time, the user presses button EP 79 and presses key-5 of keypad 47. Pressed button EP 79 followed by pressed key-5 immediately engages E. Picks 76. Sender 32 responds by discontinuing the playing and sending of stored entertainment 49 and by playing and sending to the caller the music stored as pick-5 in pick storage 98 (as depicted in FIG. 2b). Molly then hears the picked music and may enjoy. Sender 32 continues playing and sending the music as handling system 10d remains idle (on hold). A little while later, the user presses button EP 79 and presses key-8 of keypad 47. Sender 32 responds by immediately discontinuing the prior music and by playing and sending the music stored as pick-8 in pick storage 98. Molly then hears this next choice of picked music and may enjoy. Sender 32 continues playing and sending the music as handling system 10d remains idle (on hold).

After a minute or two, the user presses control button Who 104. Pressed button Who 104 immediately engages call-announce circuitry configured to attain who-information 60 (as depicted in FIG. 4). Who-message 101 is sent to the caller, stating “Whom may I say is calling?” The response from the caller (for example), “This is Molly” is attained and sent to the user. The user responds to the who-information by pressing control button Why 105. Pressed button Why 105 immediately engages call-announce circuitry configured to attain what/why-information 70 (as depicted in FIG. 5). What/why-message 102 is sent to the caller, stating “What may I say you are calling about?” The caller responds by stating (for example) something about her sick dog, but before the user hears the whole message, the user presses-for-duration control button C 84. The user then presses button EP 79 followed by key-0 and then key-4. Pressed-for-duration button C 84 engages concert circuitry 50 (as depicted in FIG. 3b). Upon the conclusion to the prior attaining of the what/why-information from the caller (when Molly has finished her message), E. Pick-04 is then played and sent to both the caller and user. Both caller and user then enjoy the sound of a hoot owl mating. Some 30 seconds later, the user presses button EP 79 and then presses key-6. Immediately, sender 32 discontinues the sound of the hoot owl mating and plays and sends E. Pick-6 to both caller and user. Both caller and user then enjoy the user's new Rock Fish single. Some 50 seconds later, the user decides to press control button Who 104. Pressed button Who 104 immediately engages call-announce circuitry configured to attain who-information 60 (as depicted in FIG. 4). Who message 101 is sent to the caller, stating (for example) “Who may I say is calling?” The response from the caller (for example), “Its Molly!” is attained and delivered to the user. Then the caller hangs up (for example). (Interface 31 can respond to the caller hang-up by discontinuing the off-hook condition.)

In summary, the example of the seventh embodiment (FIG. 8) preferably operates by: providing caller I.D. information to a user; providing a plurality of complementary circuitry for a user to engage; receiving instruction from a user; going off-hook in response to the instruction received; engaging one of the plurality of complementary circuitry in response to the instruction received; and sending a stored message and/or content to a caller, the stored message and/or content associated with the one of the plurality of complementary circuitry.

Each of activator 91 (FIGS. 1a & 1b), starter 92 (FIGS. 2a and 2b), orchestrator 93 (FIGS. 3a and 3b), initiator 94 (FIGS. 4, 5 and 6) and engager 125 (FIG. 8) can be more generally described as an outgoing information handler. Thus, in response to receiving instruction from a user via telephone 27, the outgoing information handler generates an instruction to interface 31 to go off-hook and to out-going message sender 32 to send information to the caller.

As can be seen from the foregoing, the present disclosure provides for a telephony system having a user telephone that can receive telephone calls. The user telephone includes a display device and a caller identification circuit (and/or programming) configured to display on the display device a caller identification identifying a source of a call to the user telephone. The system also includes a plurality of pre-recorded user-selectable responses. The telephony system includes circuitry (and/or programming) to allow the user to select, via the user telephone, one of the user-selectable responses based on the user viewing the source of the call as displayed on the display device. The system further includes circuitry (and/or programming) to transmit the response selected by the user for receipt at the source of the call.

As can be seen from the foregoing, the present disclosure provides for a telephony system, having a user telephone that can receive telephone calls. The user telephone includes a display device and a caller identification circuit (and/or programming) configured to display on the display device a caller identification identifying a source of a call to the user telephone. The system also includes a plurality of user-selectable complementary circuitry. The telephony system includes circuitry (and/or programming) to allow the user to select, via the user telephone, one of the user-selectable complementary circuitry based on the user viewing the source of the call as displayed on the display device. The system further includes circuitry (and/or programming) to transmit a response from the one of the user-selected complementary circuitry.

As can be seen from the foregoing, the present disclosure provides for a telephony system for use with a user telephone, the user telephone enabled to receive telephone calls and display a caller identification to a user of the user telephone on a display device, the caller identification identifying a source of a call to the user. The system interacts with and can include a plurality of pre-recorded user-selectable responses and includes circuitry and/or programming to allow the user to select, via the user telephone, one of the user-selectable responses based on the user viewing the source of the call as displayed on the display device. The system interacts with and can further include circuitry and/or programming to transmit the response selected by the user for receipt at the source of the call.

As can be seen from the foregoing, the present disclosure provides for a telephony system for use with a user telephone, the user telephone enabled to receive telephone calls and display a caller identification to a user of the user telephone on a display device, the caller identification identifying a source of a call to the user. The system interacts with and can include a plurality of user-selectable complementary circuitry and includes circuitry and/or programming to allow the user to select, via the user telephone, one of the user-selectable complementary circuitry based on the user viewing the source of the call as displayed on the display device. The system interacts with and can further include circuitry and/or programming to transmit a response from the one of the user-selected complementary circuitry.

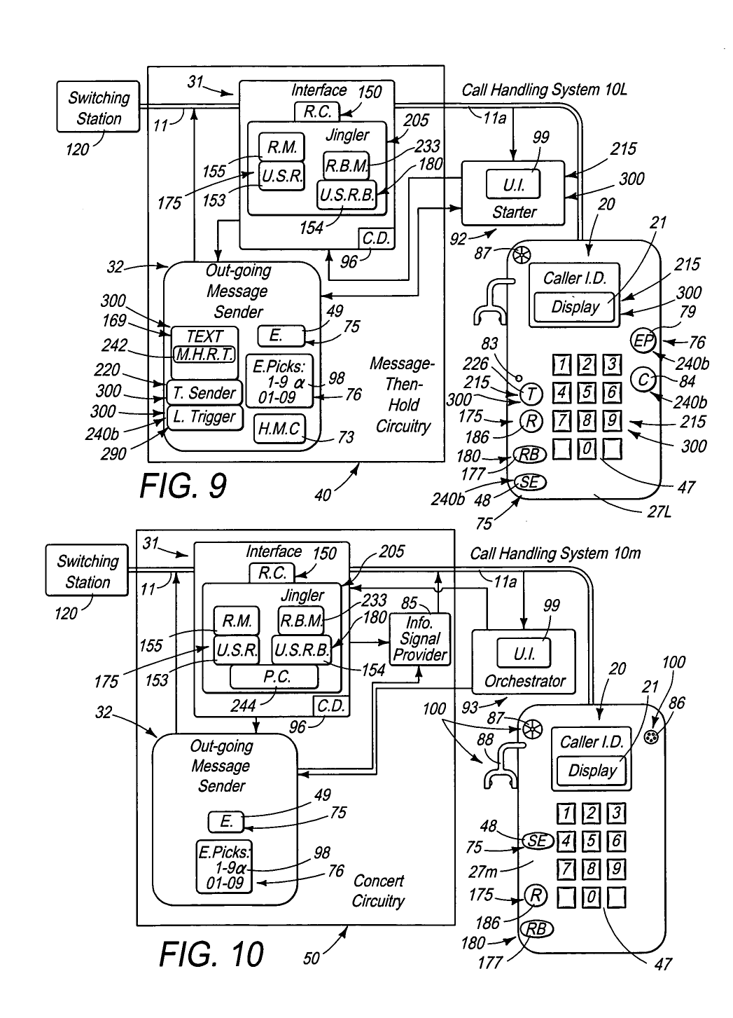

An eighth embodiment of telephone call handling system 10 is illustrated in FIG. 9. This embodiment includes caller I.D. circuitry 20 (described prior, which functions to provide caller I.D. information to a user), starter 92 (described prior, FIGS. 2a and 2b, which functions to receive instruction from a user to start message-then-hold circuitry 40) and a ring-back selector 180. The embodiment can further include message-then-hold circuitry 40 (described prior, FIGS. 2a and 2b), a ring circuitry 150 and a jingler 205. Message-then-hold circuitry 40 can include interface 31 (described prior). Interface 31 can include call detector 96 (described prior, FIG. 3b). (The eighth embodiment can be enhanced through inclusion of a text delivery 300 shown in FIG. 9 and described later.)

Ring-back selector 180 functions to enable a user to select a ring-back (and/or to select a second ring-back to replace a first ring-back). An exemplary ring-back selector 180 is depicted in FIG. 9. The exemplary selector 180 includes user-selected ring-back 154 (described below). Selector 180 also includes a selector button 177, shown as RB 177 located on telephone 27L. Button 177 is electrically connected to jingler 205 (described below) via line 11a. For this example, selector 180 further includes display 21 (display 21 described prior as part of caller I.D. circuitry 20). (Ring-back selector 180 can be employed in conjunction with and/or to enhance any of the embodiments one through twelve herein described or other embodiments or examples. Selector 180 can comprise a conventional telephone component and, therefore, has not been discussed in great detail.)

An example of operation of ring-back selector 180 will now be given. The user visits a ring-back store at a web site provided by service provider 121. The user chooses a ring-back and downloads the ring-back into a ring-back folder (located at telephone 27L or other). Subsequently, the user pushes selector button 177. Pushed button 177 instructs programming in ring-back selector 180 to display onto display 21 the ring-backs stored in the ring-back folder with a first ring-back highlighted. By again pushing button 177, the highlighted ring-back will sequence to the next forward ring-back. In this way, the user can scroll through the ring-backs stored in the ring-back folder until locating/highlighting a desired ring-back. Once highlighted, the user pushes button 177 for a given duration (e.g. 2 seconds). Programming in selector 180 recognizes the pushed-for-duration button 177 and responds by sending the chosen ring-back to jingler 205 (described below) to be stored as a user-selected ring-back 154.

Circuitry 150 functions to alert a user as to the presence of an incoming call and/or to alert a caller that a user is being alerted. An exemplary ring circuitry 150 is depicted in FIG. 9, shown as R.C. 150 located at interface 31. The exemplary ring circuitry 150 can include one or the other of a provided ring and a user-selected ring 153 (shown as U.S.R. 153). Ring circuitry 150 can further include one or the other of a provided ring-back and a user-selected ring-back 154 (shown as U.S.R. 154). Circuitry 150 can begin operation upon receiving a signal from call detector 96, the signal indicating that an incoming call has been detected.

An example of a provided ring will now be given. A provided ring comprises a non user-selected ring such as, for example, today's well known ring pause ring pause ring pause etc. delivered when service provider 121 provides a signal that operates a ringer to alert a user. A provided ring can also be or include a vibrator alert.

An example of user-selected ring 153 (FIGS. 9, 10, 11 and 12) will now be given. User-selected ring 153 comprises a ring selected by the user from a plurality of choices. Ring 153 can comprise today's common ring pause ring pause ring pause etc. Ring 153 can comprise a vibrator alert. Ring 153 can comprise user-selected content employed as a ring. The content can comprise the prior described music 77 and/or interesting sound 78, or other. The user can select the content at any time prior to receiving an incoming call. The content can then be stored as user-selected ring 153 for subsequent delivery to a user to indicate the presence of an incoming call.

An example of a provided ring-back will now be given. A provided ring-back comprises a non user-selected ring-back such as, for example, today's common ring pause ring pause ring pause etc. delivered when service provider 121 provides that sound to alert a caller that a user is being alerted.

An example of user-selected ring-back 154 (FIGS. 9, 10, 11 and 12) will now be given. User-selected ring-back 154 comprises a ring-back selected by a user from a plurality of choices. Ring-back 154 can comprise today's common ring pause ring pause ring pause etc. Ring-back 154 can comprise user-selected content employed as a ring-back. The content can comprise the prior described music 77 and/or interesting sound 78, or other. The user can select the content at any time prior to receiving an incoming call. The content can then be stored as user-selected ring-back 154 for subsequent delivery to a caller to indicate a user is being alerted as to the presence of an incoming call.

Ring 153 and, likewise, ring-back 154 can be stored at interface 31, at telephone 27, at mobile phone 165 (phone 165 described later), at service provider 121, or elsewhere to equal effect. As one example, ring-back 154 can be stored and delivered from service provider 121 to be received by the caller with provider 121 essentially simultaneously indicating the presence of the incoming call to a mobile phone where ring 153 has been stored. The mobile phone responds by delivering ring 153 to the user. As another example, ring-back 154 and ring 153 can both be stored at provider 121. In response to an incoming call, provider 121 then sends ring-back 154 to the caller's phone and ring 153 to the user's phone to be broadcast to the user. Also, ring 153 and, likewise, ring-back 154 can comprise a single content selection or can comprise multiple content selections whereby one of the multiple selections can be randomly, or other, chosen and delivered. Also, a provided ring, user-selected ring 153, a provided ring-back and user-selected ring-back 154 comprise conventional telephone components and, therefore, have not been discussed in great detail.

An example of operation of ring circuitry 150, when located at interface 31 as shown in FIG. 9 will now be given. An incoming telephone call ring signal from switching station 120 is detected by call detector 96. Detector 96 responds by signaling interface 31 and ring circuitry 150. Interface 31 responds by going off-hook. Circuitry 150 responds by sending user-selected ring 153 (or a prescribed ring) to the user's telephone and essentially simultaneously by sending user-selected ring-back 154 (or a prescribed ring-back) to switching station 120, thus to be received/heard by the caller. Consequently, the telephone user and the telephone caller both hear sound indicating the presence of the incoming call. When the user answers the incoming call, interface 31 responds to the off-hook condition at telephone 27 by going on-hook and by signaling circuitry 150. Circuitry 150 responds by discontinuing the sending of user-selected ring 153 and user-selected ring-back 154. This example exemplifies circuitry 150 located at interface 31 with an additional ring circuitry located at provider 121 (i.e. both circuitry send a ring to the user's telephone and a ring-back to the caller's telephone, first the ring circuitry of provider 121, however briefly, followed by circuitry 150). As another example, the first through sixth embodiments operate in conjunction with ring circuitry located at provider 121. In response to an incoming call, the ring circuitry there located sends a ring-back to the caller and a ring signal to the user's telephone. As another example, in response to an incoming call, service provider 121 can send a ring-back to the caller's telephone and a signal to a user's mobile phone. The mobile phone responds by delivering ring 153 to the user. In other words, ring circuitry can be located, for example, entirely at service provider 121, between provider 121 and telephone 27, entirely at telephone 27, in-part at provider 121 and in-part at telephone 27, or other. (Circuitry 150 can be implemented using existing telephone components.)

Jingler 205 functions to enable integration by ring circuitry 150 of one or more user-selections. Said user-selections can include selections made employing one or more of: ring-back selector 180, a ring-back duration selector 185 (described later), a ring-back terminator selector 195 (described later), a ring-back profile selector 200 (described later), a re-director selector 195 (described later) a phone-off ring-back profile selector 225 and a text selector 215 (described later). An exemplary jingler 205 is depicted in FIG. 9, shown located at interface 31. The exemplary jingler 205 can comprise circuitry and/or programming to enable user-selections to be employed by circuitry 150 in the alerting of a user as to the presence of an incoming call and/or in the alerting of a caller that a user is being alerted. Jingler 205 can be located at service provider 121, at telephone 27, between provider 121 and telephone 27, in-part at provider 121 and in-part at telephone 27, or other.

An example of this eighth embodiment is illustrated as call handling system 10L in FIG. 9. System 10L includes caller I.D. circuitry 20, starter 92 and ring-back selector 180. System 10L interacts with, and can include on or more of: message-then-hold circuitry 40, ring circuitry 150 and jingler 205. For this example, ring circuitry 150 and jingler 205 have been located at interface 31 of circuitry 40 and interface 31 includes call detector 96. Further in this example, detector 96 is electrically connected to (or connectable to) to interface 31 and to circuitry 150. Further in this example, message-then-hold circuitry 40 includes user-selected entertainment 75 (including button SE 48 and storage E. 49, all described prior) and also includes E. Picks 76 (including keypad 47 and storage 98, all described prior). (Alternately, circuitry 40 can include one or the other only of entertainment 75 and E. Picks 76.) System 10L can include telephone 27L (as well as loudspeaker 87, described prior).

A first example of operation of this example of this eighth embodiment will now be given. Prior to an incoming call, a user has employed ring-back selector 180 to select the sound of a mating bullfrog and that sound has been stored as user-selected ring-back 154 at jingler 205. Now, an incoming ring signal provided by station 120, via line 11, is received and detected by call detector 96. Detector 96 responds by signaling interface 31 and by signaling ring circuitry 150. Interface 31 responds by going off-hook. Circuitry 150 responds by sending the jingler 205 integrated user-selected ring-back 154, in this case the mating bull-frog sound, to switching station 120 and, thus, to be received/heard by the caller indicating the user is being alerted. Circuitry 150 further responds by sending a prescribed ring or jingler 205 integrated user-selected ring 153 to loudspeaker 87 to be heard by the user, thus indicating the presence of the incoming call.

(All embodiments herein described, as well as others not described, can optionally include a ring selector 175, FIGS. 9, 10, 11 and 12. As an example, selector 175 can include a selector button 186 shown as R 186 in FIGS. 9 and 10. Selector 175 can operate substantially as described for ring-back selector 180 to accomplish the selection of user-selected ring 153. Enabling the user to select ring 153 provides, for example, that the same or a like sound can then be chosen for ring 153 as selected for user-selected ring-back 154. User and caller can then simultaneously experience/share that sound choice. Also, all embodiments herein described, as well as others not described, can include a ring modifier 155, FIGS. 9, 10, 11 and 12. Modifier 155 can comprise circuitry and/or programming to recognize a condition and, in response, modify the ring. The ring can be a prescribed ring or user-selected ring 153. Lowering the volume, changing the equalization such as increasing the robustness, injecting an occasional beep, or other, can comprise the modification. A modified ring can serve to alert a user as to any number of occurrences. For example, a modified ring can inform the user that re-direct ring-back profile 172, described later, has been engaged. Modifier 155 can be user-enabled or not. Modifier 155 can be user-selected from a plurality of choices and can include a ring modifier selector. Also, all embodiments herein described, as well as others not described, can include a ring-back modifier 233, FIGS. 9, 10, 11 and 12. Ring-back modifier 233 can comprise the functionality as described above for modifier 155 with the exception that the ring-back is modified rather than the ring. Modifier 233 can comprise circuitry and/or programming to recognize a condition and, in response, modify the ring-back. The ring-back can be a prescribed ring or user-selected ring-back 154. As an example, modifier 233 can slowly increase the robustness of the ring-back from onset to termination.)

Delivered with the incoming ring signal is caller I.D. information. The information is displayed on display 21 (located at telephone 27L). The user can recognize the phone number on the display; i.e. the user can essentially knows who's calling. If the user is preoccupied (e.g. driving his car but figures he will be comfortable to answer the call shortly), upon considering his busy condition, the identity of the caller and the song playing (ring-back 154), the user then twice presses button SE 48 (for example). Twice-pressed button 48 sends a signal to UI 99. UI 99 responds to the twice-pressed button by sending a signal to ring circuitry 150 via interface 31. Circuitry 150 responds by discontinuing the sending of user-selected ring-back 154. (Interface 31 is already off-hook.) UI 99 further responds by sending a signal to sender 32. Sender 32 responds by playing and sending the entertainment stored in E. 49 to the caller. For this example, the entertainment can comprise a rock song. Because the entertainment has now changed from bullfrog mating to rock song, the caller can presume that the user has responded to the incoming call and presumably will answer the call shortly. Handling system 10 remains idle (on hold) by interface 31 maintaining the off-hook condition, while E. 49 is played to the caller, until the user answers the call. Further in response to twice-pressed button SE 48, ring circuitry 150 can activate ring modifier 155. Modifier 155 can respond by lowering the volume of the prescribed ring or user-selected ring 153 being sent to the user. The lowered-volume ring can serve to remind the user that the caller has been placed on hold. When the user answers the telephone, the off-hook condition of telephone 27L is detected by interface 31. Interface 31 responds by going on-hook and by sending a signal to sender 32 and to circuitry 150. Sender 32 responds by discontinuing the playing and sending of entertainment E. 49. Circuitry 150 responds by discontinuing the prescribed ring or ring 153 and the ring modifier 155. (Alternately, ring circuitry 150 can respond to twice pressed button 48 by discontinuing the ring, i.e. no ring and no ring modification.)

A second example of operation of this example of this eighth embodiment will now be given. Prior to an incoming call, the user has employed ring-back selector 180 to select a clip of the song Hard Day's Night by the Beattles, and that song clip has been stored in jingler 205 as user-selected ring-back 154. Subsequently, detector 96 detects an incoming call. Detector 96 responds by signaling interface 31 and by signaling ring circuitry 150. Interface 31 responds by going off-hook. Circuitry 150 responds by sending the jingler 205 integrated user-selected ring-back 154, in this case Hard Day's Night, to switching station 120 thus to be received/heard by the caller. Circuitry 150 further responds by sending a prescribed ring or jingler 205 integrated user-selected ring 153 to loudspeaker 87 to be heard by the user. Delivered with the incoming ring signal is caller I.D. information. The information appears on display 21 (at telephone 27L). The user recognizes the phone number on the display. If the user is otherwise occupied but figures he will be comfortable to answer the call shortly, and in light of his predisposition and upon considering the presumed identity of the caller, the user can now pick hold message C 73 and, to do so, presses button 83. Upon considering the identity of the caller and the song-being-played as ring-back 154, the user then presses the E. Picks EP 79 button and then presses key-3 of keypad 47. (In this example, the user has decided that this caller doesn't like The Beattles and, therefore, does not choose to send the caller another Beattles song but instead chooses to send a Lady GaGa song.) Button 83 sends a signal to UI 99. UI 99 responds by sending a signal to ring circuitry 150 and by sending a signal to sender 32. Ring circuitry 150 then responds by discontinuing the sending of ring-back 154 and by discontinuing the ring sent to the user. (Interface 31 is already off-hook.) Sender 32 responds by sending the hold message C 73, “I'll be with you in a couple shakes” to the caller. The caller can then hear the message and wait for the user to answer. At the conclusion to the sending of the message (as indicated by sender 32), UI 99 then responds to the pressed button EP 79 and pressed key-3 by sending a signal to sender 32. Sender 32 responds by playing and sending the music stored as pick-3 (Lady GaGa) of pick storage 98. The caller can then hear the music, and may enjoy it. Sender 32 continues playing the music as handling system 10L remains idle (interface 31 maintaining the off-hook condition) until the user answers the call (or caller hangs up). When the user answers, the off-hook condition of telephone 27d is detected by interface 31. Interface 31 responds by discontinuing the off-hook condition. Interface 31 can further respond by sending a signal to sender 32. Sender 32 can then respond by discontinuing the playing and sending of pick-3.

The eighth embodiment can be configured differently and/or operate differently than as described above. As one example, message-then-hold circuitry 40 of this eighth embodiment can employ one or more of the prior described functions and components shown in FIG. 2b (or other) including: solitary hold message A 71; hold message picker 74; specific-time hold message picker 51; user-selected entertainment 75; E. Picks 76; tiser 135; advertiser picks 137; content message-then-hold 55; Disc Jockey 115; fader circuitry 113; shuffler 117; and caller-picked entertainment 123.

In summary, the examples of the eighth embodiment (FIG. 9) preferably operate by: enabling a user to select a ring-back; providing caller I.D. information to a user; receiving instruction from a user to start message-then-hold circuitry (the instruction based on the ring-back selected and the caller I.D. information provided).

A ninth embodiment of telephone call handling system 10 is illustrated in FIG. 10. This embodiment includes caller I.D. circuitry 20 (described prior, which functions to provide caller I.D. information to a user), orchestrator 93 (described prior, FIGS. 3a and 3b, which functions to receive instruction from a user to orchestrate concert circuitry) and ring-back selector 180 (described prior, which functions to enable a user to select a ring-back). This embodiment can include concert circuitry 50 (described prior, FIGS. 3a and 3b), ring circuitry 150 (described prior) and jingler 205 (described prior). Concert circuitry 50 can include interface 31 (described prior). Interface 31 can include call detector 96 (described prior, FIG. 3b).

An example of this ninth embodiment is illustrated as call handling system 10m in FIG. 10. System 10m includes caller I.D. circuitry 20, orchestrator 93, and ring-back selector 180. System 10m interacts with, and can include one or more of: concert circuitry 50, ring circuitry 150 and jingler 205. For this example, circuitry 150 and jingler 205 have been located at interface 31 of circuitry 50, and interface 31 includes call detector 96. Further in this example: detector 96 is electrically connected to interface 31 and to circuitry 150; concert circuitry 50 includes user-selected entertainment 75 (including button SE 48 and storage E. 49, all described prior); and circuitry 50 includes E. Picks 76 (including button EP 79, keypad 47 and storage 78, all described prior). (Alternately circuitry 50 can include one or the other only of entertainment 75 and E. Picks 76.) System 10m can include telephone 27m (including loudspeaker 87, earphone 88 and telephone receiver 86, all described prior).

ONE EXAMPLE of operation of this example of this ninth embodiment will now be given. In this example, prior to an incoming call, the user has employed ring-back selector 180 to select a clip of the song Smoke on the Water. The clip is stored as user-selected ring-back 154 at jingler 205. Some time later, call detector 96 detects an incoming ring signal provided by station 120, via line 11. Detector 96 responds by signaling interface 31 and by signaling ring circuitry 150. Interface 31 responds by going off-hook. Circuitry 150 responds to the signal from detector 96 by sending the jingler 205 integrated user-selected ring-back 154 (in this case the Smoke on the Water clip) to switching station 120, thus to be received/heard by the caller indicating the user is being alerted. Circuitry 150 further responds by sending a prescribed ring or user-selected ring 153 to loudspeaker 87 to be heard by the user, thus indicating the presence of the incoming call. (Smoke on the Water can also be selected by the user to be user-selected ring 153 for delivery to the user. User and caller can then simultaneously experience/share Smoke on the Water, constituting a pre-concert enhancement to the upcoming concert experience to be delivered by concert circuitry 50. A pre-concert 244 is shown as P.C. 244, shown located at jingler 205 in FIG. 10)

Further in this example, delivered with the ring signal is caller I.D. information. The information is displayed on display 21 (telephone 27m). The user recognizes the phone number. It belongs to the cell phone of his good buddy Bob Big Boy. The user considers his mood at that moment, the presumed identity of the caller and ring-back 154 being played and deploys an appropriate entertainment by picking one of pick storage 98 E. Picks: 1-9 & 01-09. Taking into account that Bob is an avid fisherman, the user decides to continue with a “water theme”, so he decides to share “Whales Mating” with Bob (the user having prior to the incoming call loaded Whales Mating into E. Pick-07 of pick storage 98). Accordingly, the user presses concert button C 84 and, subsequently, presses button EP 79. The user then presses key-0 and key-7. Pressed button EP 79 activates keypad 47. Button C 84 followed by key-0 and key-7 each sends a control signal to UI 99. UI 99 responds to the succession of signals by sending a signal to ring circuitry 150, via interface 31, and to sender 32. (Interface 31 is already off-hook.) Circuitry 150 responds by discontinuing the sending of a ring to the user and by discontinuing the sending of ring-back 154 to the caller. Sender 32 responds by playing E. Pick-07 from pick storage 98 and by sending the played sound to the caller via line 11 and switching station 120. Sender 32 further responds by sending the played sound to signal provider 85. Provider 85 responds by sending the played sound to loudspeaker 87 and, thus, to the user (via line 11a). Both caller and user then may share/enjoy Whales Mating.

Subsequently, the user decides he wants to speak with the caller while they both listen to Whales Mating. The user then answers telephone 27m. Interface 31 responds to off-hook phone 27m by sending a signal to provider 85 and by communicably connecting caller and user (and by going on-hook). Provider 85 responds by discontinuing the sound to loudspeaker 87 and by instead sending the played sound to telephone receiver 86. Caller and user now converse while the sharing the nature musical experience. At conclusion to the concert/conversation, the user hangs up his phone. Interface 31 responds to the on-hook condition by communicably disconnecting caller and user and by sending a signal to sender 32. Sender 32 responds by discontinuing the playing and sending of E. Pick-07.

The ninth embodiment can be configured differently and/or operate differently than as described above. As one example, concert circuitry 50 of this ninth embodiment can employ one or more of the prior described functions and components shown in FIG. 3b (or other) including: user-selected entertainment 75; song-last-played 111; E. Picks 76; auto-hold 89; volume control VC 112; fader 113; disc jockey 115; shuffler 117 and caller-picked entertainment 123.

In summary, the examples of the ninth embodiment (FIG. 10) preferably operate by: enabling a user to select a ring-back; providing caller I.D. information to a user; and receiving instruction from a user to orchestrate concert circuitry (the instruction being based on the ring-back selected and the caller I.D. information provided).

As can be seen from the foregoing, the present disclosure provides for a telephony system for use with a user telephone, the user telephone enabled to receive telephone calls and to provide a caller identification to a user of the user telephone, for example, on a display device, the caller identification identifying a source of a call to the user. The system includes circuitry and/or programming to allow the user to select, via the user telephone, a content for delivery as a ring-back to a caller, the content selected from a plurality of user-selectable content. The system can further include circuitry and/or programming to transmit the ring-back to the caller. The system further includes circuitry and/or programming to allow the user to select, via the user telephone, a response based on the user considering the ring-back content being delivered to the caller and upon the user viewing the source of the call as displayed on the display device. The response can be selected from a plurality of pre-recorded user-selectable responses. The system can further include circuitry to transmit the response selected by the user to the source of the call.

Described prior information depicted stored at sender 32 can include one or more of: callback message A 33, callback message B 34, callback message C 35, specific-time messages 36: 1-9 & 01-09, stored entertainment 49, hold message A 71, hold message B 72, hold message C 73, storage 98 E. Picks: 1-9 & 01-09, Who-message 101, What/why-message 102, Who messages 107, What/why messages 108, stored advertisement 136, advertiser picks 137, message-then-hold related text 242. Said described prior information can be initially pre-loaded into, for example, sender 32 by a service provider or telephony equipment manufacturer or other. Said described prior information can be initially, and/or subsequently, loaded into, for example, sender 32 by a user. Said described prior information can be re-selected and again loaded into, for example, sender 32, re-selecting to include selecting a new/next/subsequent choice of information to load. A user can load information from any number of sources such as: libraries on the internet via a computer or a WiFi connection (if system 10 is WiFi enabled) or provider 121, a music player, a recording device, libraries stored in handling system 10 itself or libraries stored at service provider 121. (Said libraries on the internet may be found on a service provider web site, a telephone manufacturer web site, a music web site or other. The stored information can also be stored on one or more memory devices which can be made accessible to the user via a service provider. The stored information can be stored elsewhere, for example, elsewhere at system 10 or elsewhere at telephone 27, or other.)

The apparatus described herein can be implemented using known circuit components, which can include a programmable processor along with a computer-readable memory containing a series of computer executable instructions which can be executed by the processor. As an example, the apparatus can include telephony circuits for transmitting caller information (e.g., caller I.D.) to the called-phone, telephony circuits for establishing a communication link from a called-phone to a caller phone, telephony circuits for transmitting a stored message and/or content to a caller, telephony circuits for establishing a direct communication connection between a caller and a called party, telephony circuits for communicating attained information from a caller to a called party, and telephony circuits for generating an off-hook signal. (Functionality described implemented using circuitry can include implementation through programming.)

The computer executable instructions (stored in the computer-readable memory and executable by the programmable processor) can include a series of executable steps to perform the following: present a menu of selection options to a user via a graphical user display of messages and/or information to be provided to a calling party; receive an input (or instruction) from a user (i.e., a called party) via a user interface (e.g., a keyboard or a graphical user interface), use the received input to determine a specific message or information to be transmitted to a calling party; enable telephony circuitry to establish a telephonic communication connection with the called party and implement telephonic transmission of the specific message or information to the calling party; and enable a user to store in the computer-readable memory a series of user-selected messages and/or information to be potentially later communicated to a caller, and enable the user to label the stored messages and/or information such as with descriptive titles for later reference by the user.

It will be appreciated that the apparatus of the present disclosures has been described by examples (FIGS. 1a-10) of telephonic equipment (specifically, handset or telephone 27) which provide buttons for implementing various user-selection options described herein. (For example, telephone 27b of FIG. 1b provides buttons 43, 44 and 45 which allow a user to select various call-back messages.) However, when a user handset or telephone is provided with a graphical user interface (GUI), then the user can be provided with hierarchical menus in place of buttons. As an example, if the telephone 27j of FIG. 8 is provided with a GUI instead of the indicated buttons (48, 97, 104, 105, et seq.), the first menu (upon indication of an incoming call) can display to the user the following: the caller I.D. (if known), and two touch-screen selections as follows: “answer call” or “options”. Selection of “answer call” allows the user (or called party) to answer the call, while selection of “options” presents to the user a new screen on the GUI offering the user the following options: “callback”, “hold”, “concert” and “get more info”. Selection of the “hold” option presents to the user a new screen on the GUI offering the user the following options: “please hold”, “hold for one minute”, or such other “hold” menu options as a user may program into the handset. (Failure to select one of the “hold” options can cause a default “hold” message to be sent to the caller.)

Likewise, by selecting the “callback” option, the user is presented (via the GUI) a new menu with the following options: “call back later”, “call back in 1 hour”, “call back in select time”, “never call back”, and such other “callback” menu options as a user may program into the handset. By selecting “call back in select time” the user can be presented with a keypad menu to allow the user to enter the time in minutes, hours or days to be sent to the caller specifying when the caller should call back. In like manner, by selecting the “get more info” option from the initial-call menu, a secondary menu can be presented to the user allowing the user to select a “who” or “what/why” message to be sent to the caller. Each menu can also be provided with “answer” or “end call” options should the user change his or her mind during the menu selection process (e.g., if the user decides after selecting the “callback” menu option that the user would instead prefer to take the call at that time, the user can select the “answer” option on the presently-presented menu screen).

Further, the music and/or sound options described herein can be provided as additional menu options. For example, in the “hold” menu one option can be “hold with entertainment”. The “hold with entertainment” option can provide another menu of entertainment options, including “default music”, “default sound”, “selected music”, “selected sound”, “pick music”, “pick sound”, and “live streaming radio”. By selecting any one of the “pick music”, “pick sound”, and “live streaming radio” menu options, a further (respective) menu is presented to the user allowing the user to select the respective music, sound or radio station to be provided to the caller during the hold period. (The “live streaming radio” menu option assumes that the users handset allows for wireless internet connectivity.) Said menu presented to the user allowing the user to select the respective music, sound or radio station can provide the selections on the display as icons, pictures, graphics or other, representative of said music, sound or radio station. As an example, a sound choice may be a train whistle and, therefore, a graphic of an antique steam locomotive is presented on the display/screen.

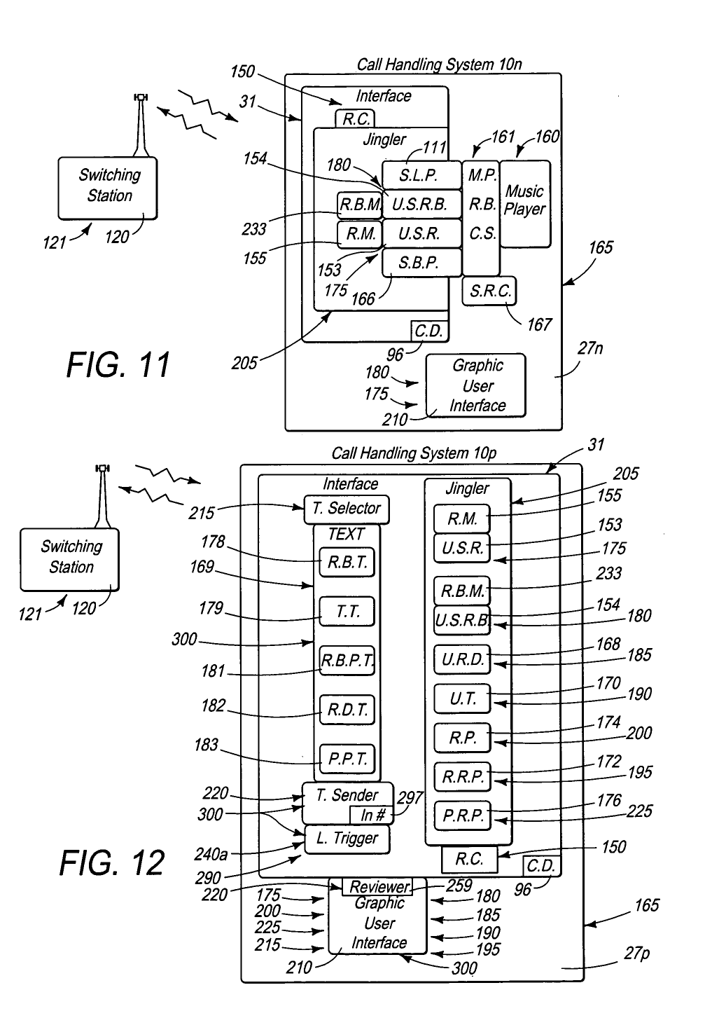

A tenth embodiment of telephone call handling system 10 is illustrated in FIG. 11. This embodiment includes ring-back selector 180 (described prior, which functions to enable a user to select a ring-back), and telephone 27 and wherein telephone 27 comprises a mobile phone 165, a music player 160 and a music player and ring-back content sharer 161. This embodiment can include jingler 205 (described prior), ring circuitry 150 (described prior), interface 31 (described prior) and call detector 96 (described prior). The call handling system can be enhanced through inclusion of one or both of a song-last-played 111 and a song-being-played 166.

Mobile phone 165 can function to facilitate the selection of content for play as a music player and/or for the ring-back. Mobile phone 165 can further function to facilitate delivery of the ring-back to a caller. An exemplary mobile phone 165 is depicted in FIG. 11. The exemplary mobile phone 165 can comprise a cell phone, a satellite phone, or other. Mobile phone 165 transmits and receives signals for electronic communication with, for example, switching station 120 of service provider 121. Phone 165 can provide that content can be accessed, via service provider 121, from provider 121, and/or from the internet, or from other. Said content can then be employed for play by music player 160 (described below), can be employed as user-selected ring-back 154, and can be employed as both ring-back 154 and user-selected ring 153. Additionally, ring-back 154 can be delivered from phone 165 to the user. Delivery from phone 165 functions to provide the user freedom from the service provider's control over the selection and use of ring-back 154 (as when delivered from provider 121). Ring-back 154 can be delivered to a caller from phone 165 when phone 165 includes, for example, interface 31, call detector 96, and ring circuitry 150. Call detector 96 can detect an incoming call and signal interface 31 and circuitry 150. Interface 31 can respond by going off-hook. Circuitry 150 can then respond by sending ring-back 154 to the caller.

Music player 160 can function to enable a user to select content (music) for play to the user. An exemplary music player 160 is depicted in FIG. 11. The exemplary player 160 can be located at mobile phone 165. The user can employ phone 165 to access content (music) via provider 121 located on the internet or at service provider 121 (or other). The user can then select located content and download that content (via phone 165) into music player 160 to be stored, for example, in a library/folder in player 160. (Alternately, the content can be stored at service provider 121, or other. Alternately, music/content can be downloaded from a computer or an external music player or other into player 160, for example, as described prior regarding music 77 and sounds 78. Alternately, content can be pre-loaded into phone 165 by, for example, a telephone manufacturer, or other.) The user can then select a desired content/song from amongst the library/folder of stored music in player 160. The music can be played by player 160 to be heard from loudspeaker 87 (described prior) or earphone 88 (described prior) or other. (Music player 160 can comprise a conventional music-selecting component and, therefore, has not been described in great detail. Also, handling system 10, when comprising E. Picks 76, can be employed as a music player as indicated previously.)

Music player and ring-back content sharer 161 functions to enable a given content to be employed for both music player output and as a ring-back. An exemplary music player and ring-back content sharer 161 is depicted in FIG. 11. The exemplary sharer 161 can comprise circuitry and/or programming to provide for said employment of content by both player 160 and ring-back 154. Content, such as a song for example, can be chosen by the user and stored in player 160, or phone 165, or at provider 121, or somewhere else. Sharer 161 can then simply provide that said content is employable by player 160 and as ring-back 154. Sharer 161 can comprise a content to ring-back converter 167 (or other).

Content to ring-back converter 167 functions to enable content (songs) for play by player 160 to be configured for employment as user-selected ring-back 154 (or as both ring-back 154 and ring 153). (Or visa versa, i.e. converter 167 can function to enable content for play as ring-back 154, or as both ring-back 154 and ring 153, to be employed for play by player 160.) An exemplary content to ring-back converter 167 is depicted in FIG. 11. The exemplary converter 167 can comprise circuitry and/or programming which enables the playing of content by both player 160 and as ring-back 154. As an example, a song can be available for selection/download by a user, and which has been indexed prior, and said pre-indexed song can be simply downloaded into a library/folder (stored somewhere) for play by player 160. Converter 167 can then simply provide that the pre-indexed song can also be employed for play as ring-back 154 (i.e. additionally stored in a ring-back folder for example). When the pre-indexed song is subsequently played by circuitry 150 as ring-back 154, play of the song begins at the point where indexed (instead of at the start as when played by player 160).

As another example, content to ring-back converter 167 can comprise circuitry and/or programming whereby when a user desires to employ content chosen for output by music player 160 as ring-back 154 (or both ring-back 154 and ring 153), the circuitry and/or programming generates a clip of said content. The clip is then stored for play as ring-back 154.

As another example, converter 167 can comprise circuitry and/or programming whereby the user can designate a preferred segment of the content (can designate a clip), the preferred segment (clip) for play by circuitry 150 as ring-back 154 (or as both 154 and 153). Converter 167 can comprise user-selectable “ring” options displayed on a graphic user interface 210 (hereafter referred to as GUI 210, described prior) shown located on mobile phone 165. As an example of designating a preferred segment, an opening menu can include a “ring” icon. The user touches the “ring” icon. A next screen presents a plurality of ring options including “select ring type”. The user then touches the “select ring type” icon. A next screen presents a plurality of ring type options, for example: “user-selected ring”, “user-selected ring-back” and “user-selected ring and user-selected ring-back”. For this example, the user touches “user-selected ring-back”. A next screen presents “SELECT” and “LIBRARY” icons. The user prior has paused a chosen song playing on player 160, the place of pause comprising the user's desired beginning point for ring-back 154 and, so, the user touches the “SELECT” icon. Programming in converter 167 checks that a song is being played by player 160 and that that playing has been paused. The programming then fashions a clip of the chosen song, the clip having the user-chosen beginning point (and having a pre-specified length or other). The clip is then stored as ring-back 154. (Touching “LIBRARY” brings up a library of prior loaded user-selected ring-backs 154 for the user to choose from. Choosing from the library comprises one example of ring-back selector 180.)

An example of this tenth embodiment is illustrated as telephone call handling system 10n in FIG. 11. System 10n includes ring-back selector 180, mobile phone 165, music player 160 and music player and ring-back content sharer 161. Ring-back selector 180 and music player 160 are located at mobile phone 165. System 10n interacts with, and can include, jingler 205, ring circuitry 150, interface 31 and call detector 96, all shown located at mobile phone 165. Also, this tenth embodiment can be enhance by inclusion of one or both of a song-last-played 111 and a song-being-played 166, both also shown in FIG. 11.

An example of operation of this example of this tenth embodiment will now be given. Prior to an incoming call, a user downloads into music player 160 the new release by his favorite band. The song is stored in music player 160 (along with many others). Subsequently, the user plays the song until locating a desirable segment. Player 160 is configured to forward, reverse and pause play. The user employs the forward and reverse to subsequently achieve a positioning at the beginning of the desirable segment where the user pauses play. The user then employs converter 167, via GUI 210, and touches a “user-selected ring and user-selected ring-back” icon. Further employing converter 167, the user then touches a “SELECT” icon. Converter 167 responds by checking that player 160 is currently playing and that that playing has been paused. Converter 167 then makes a clip of the chosen song with the clip having the user-chosen beginning point. The clip is then stored as ring 153 and as ring-back 154, both shown located at jingler 205. Some time later, call detector 96 detects an incoming call and responds by signaling interface 31 and ring circuitry 150. Interface 31 responds by going off-hook. Circuitry 150 responds by sending the clip of the new release, now stored as ring 153, to alert the user and by sending the clip of the new release, now stored as ring-back 154, to switching station 120 (provider 121) and, thus, to the caller. Both user and caller can listen and enjoy, sharing the experience of listening to the new release until user answers or caller hangs up (as detected by interface 31). (Content can be shared by player 160, ring-back 154 and, also, ring 153. The user can then utilize the shared content to be ring-back 154 or ring 153 whenever the user sees fit. Conversely, the user can also then employ the shared content as ring-back 154 and as ring 153 such that when an incoming call is received, the shared content is simultaneously played as both 154 and 153.)

An example of song-last-played 111 has been given prior (FIGS. 2b, 3a and 3b). Another example will now be given. For this example, song-last-played 111 (shown as S.L.P. 111) is located at jingler 205. For this example, song-last-played 111 comprises the last song (content) played by music player 160. When player 160 starts the playing of a song (content), that song can be simultaneously (or other) stored as song-last-played 111. Content sharer 161 can include circuitry and/or programming to employ song-last-played 111 (or a clip, or other, of song-last-played 111) to be ring-back 154. Subsequently, when an incoming call is detected, circuitry 150 plays and sends ring-back 154 (comprising some or all of the content of song-last-played 111) to be heard by the caller to indicate that the user is being alerted. (Circuitry 150 can additionally send ring 153, with ring 153 also comprising some or all of the content of song-last-played 111.)

An example of operation of this example of this tenth embodiment when enhanced by inclusion of song-last-played 111 will now be given. Prior to an incoming call, a user has been listening to music played by music player 160. The last song played on player 160 was Beet It by Michael Jackson. As the song began playing the song was stored at jingler 205 as song-last-played 111. Content sharer 161 then makes a clip from song-last-played 111 and stores the clip as ring-back 154. Some time later, call detector 96 detects an incoming call sent from switching station 120 to mobile phone 165. Detector 96 responds by signaling interface 31 and ring circuitry 150. Interface 31 responds by going off-hook. Circuitry 150 responds by sending a ring to alert the user as to the presence of the incoming call. Circuitry 150 further responds by sending ring-back 154 (now comprising the clip of song-last-played 111) to station 120 thus to be received/heard by the caller to indicate that the user is being alerted. The caller can then listen to Beet It and enjoy until the user answers the call or the caller hangs up. (Circuitry 150 can additionally send song-last-played 111 as ring 153 to the user. Consequently, both user and caller can then listen and enjoy, sharing the Beet It experience. Alternately, circuitry 150 can send some other ring-back to the caller and send song-last-played 111 as ring 153 to the user. In one variation, ring circuitry 150 can be located in whole or in part at service provider 121 and song-last-played 111 can be provided as ring-back 154 and/or as ring 153 by service provider 121.)

An example of song-being-played 166 (shown as S.B.P. 166), shown located at jingler 205, will now be given. Song-being-played 166 comprises the song (content) presently being played by music player 160. Content sharer 161 can include circuitry and/or programming to employ song-being-played 166 (live, or as a clip, or other) to be ring-back 154 (and also to be ring 153). Subsequently, when an incoming call is received, circuitry 150 can then send ring-back 154 (comprising some form of song-being-played 166) to be heard by the caller. In other words, as one example, song-being-played 166 as it's being played, i.e. live, can be sent from player 160, by song sharer 161, to circuitry 150. Circuitry 150 then forwards the live song to be heard by the caller. As another example, as song-being-played 166 is being played by player 160, a clip of song-being-played 166 can be sent by sharer 161 to circuitry 150. Circuitry 150 can then forward the clip to be heard by the caller. (An example of a song-being-played by a music player employed with concert circuitry 50 has been given prior. Additionally, a song-being-played by a music player can be employed with music-then-hold circuitry 40 as the hold message and/or the hold entertainment, or other.)

An example of operation of this example of this tenth embodiment, when enhanced by inclusion of song-being-played 166 will now be given. A user is listening to L.A. Woman being played by music player 160. Call detector 96 detects an incoming call delivered from switching station 120 (provider 121) to mobile phone 165. Detector 96 responds by signaling interface 31 and ring circuitry 150. Interface 31 responds by going off-hook. Circuitry 150 responds by sending a vibrator alert to phone 165 to alert the user as to the presence of the incoming call. Circuitry 150 further responds by sending ring-back 154 to the caller. Song-being-played 166, as it's being played i.e. live, is being sent by sharer 161 from player 160 to circuitry 150. Circuitry 150 is then forwarding the live song, L.A. Woman, now comprising ring-back 154, to switching station 120 and, thus, to be received/heard by the caller to indicate that the user is being alerted. The caller can then listen to L.A. Woman and enjoy, while the user also listens to L.A. Woman via player 160 and enjoys, until the user answers the call or the caller hangs up. (System 10p, or other embodiments, can be configured such that if player 160 is playing a song/content, then song-being-played 166 is sent as ring-back 154. However, if player 160 is not playing a content, song-last-played 111 or other can then be sent as ring-back 154 instead of song-being-played 166. In one variation, ring circuitry 150 can be located in whole or in part at provider 121 and song-being-played 166 can be provided as ring-back 154 and as ring 153 by provider 121.)

In summary, the examples of the tenth embodiment (FIG. 11) preferably operate by: enabling the user to select content for employment as a ring-back; enabling the user to select content for play as a music player; enabling a given content to be employable for both music player play and for the ring-back; and facilitating the selection of content for the play as a music player and/or for the ring-back and/or facilitating delivery of the ring-back to a caller.

As can be seen from the foregoing, the present disclosure provides a telephony system for use with a user telephone, the user telephone enabled to receive telephone calls. The system includes circuitry and/or programming to allow the user to select a content from a plurality of content choices. The system further includes circuitry and/or programming to enable the selected content to be employed by a music player and as a ring-back sent to the caller. The system can further include circuitry and/or programming to enable the content to be further employed as a ring sent to the user. The system further includes a mobile phone to facilitate the selection of content and/or to facilitate delivery of the ring-back to a caller.

An eleventh embodiment of telephone call handling system 10 is illustrated in FIG. 12. This embodiment includes one or more of: ring-back selector 180 (further described below), a ring-back duration selector 185, a ring-back terminator selector 190 and a ring-back profile selector 200. This embodiment can include ring circuitry 150 (described prior), jingler 205 (described prior), interface 31 (described prior), call detector 96 (described prior) and telephone 27p. Telephone 27p can include a mobile phone 165 (phone 165 further described below). The call handling system can be enhanced through inclusion of one or more of: a re-direct selector 195, a phone-off selector 225 and a text delivery 300. The call handling system can be enhanced, for example, by employing ring-back profile selector 200 in combination with re-direct profile selector 195, by employing selector 200 in combination with selector 195 and/or with selector 225, by employing selector 195 in combination with selector 225, by combining selector 200 with delivery 300, by combining selector 195 with delivery 300, by combining selector 225 with delivery 300, or other combinations. (This eleventh embodiment can also be employed in combination with any of embodiments one through ten herein described or other embodiments and examples.)

One example of ring-back selector 180 has been given prior when being employed with the eighth embodiment (FIG. 9), having selector 180 comprising user-selected ring-back 154, selector button 177 and display 21. Another example of selector 180, for employment with this eleventh embodiment (FIG. 12), will now be given. As stated prior, ring-back selector 180 functions to enable a user to select a ring-back (and/or to select a second ring-back to replace a first ring-back). For this example, selector 180 includes user-selected ring-back 154 (described prior) and also includes graphic user interface GUI 210 (described prior). A user can be provided with a plurality of choices for a ring-back and the user's selection from those choices employing GUI 210, can be stored as user-selected ring-back 154.

An example of operation of this example of ring-back selector 180 (FIG. 12) will now be given. A “ring” option is included on an opening display on GUI 210. The user touches the “ring” icon. A next screen presents ring options, one option being “choose ring-back”. The user then touches the “choose ring-back” icon. A next screen presents the contents of a ring-back folder. The contents comprise ring-backs downloaded into the folder prior. (Ring-backs can be purchased from service provide 121, or other, or can reside pre-stored in the user's telephone, for example in a mobile phone, or other.) The user can select a ring-back from the ring-back folder contents by touching the ring-back icon. That ring-back can then be stored, for example at jingler 205, as user-selected ring-back 154.

Ring-back duration selector 185 functions to enable a user to select a ring-back duration (and/or to select a second ring-back duration to replace a first ring-back duration). An exemplary ring-back duration selector 185 is depicted in FIG. 12. The exemplary selector 185 includes GUI 210 (described prior) and also includes a user-selected ring-back duration 168 (shown as U.R.D. 168). A user can be provided with a plurality of choices for duration of a ring-back and the user's selection from those choices employing GUI 210, can be stored as ring-back duration 168. (Duration selector 185 can be employed with any of the embodiments one through eleven herein described or other embodiments or examples.)

An example of operation of ring-back duration selector 185 will now be given. A user-selectable “ring” option is included on an opening display on GUI 210. The user touches the “ring” icon. A next screen presents ring options with one of the options being “choose ring-back duration”. The user then touches the “choose ring-back duration” icon. A next screen presents a plurality of duration options, for example: five seconds, 10 seconds, 15 seconds, 20 seconds, 25 seconds, 30 seconds, 40 seconds, 50 seconds, 60 seconds and continuous (continuous meaning that a ring-back is sent until the user answers or the caller hangs up). The user then touches an icon representing a chosen duration. The chosen duration is then stored, for example at jingler 205, as user-selected ring-back duration 168.

Terminator selector 190 functions to enable a user to select a terminator (and/or to select a second terminator to replace a first terminator). An exemplary terminator selector 190 is depicted in FIG. 12. The exemplary selector 190 includes GUI 210 (described prior) and also includes user-selected terminator 170 (shown as U.T. 170). A user can be provided with a plurality of choices for terminating the providing of a ring-back and the user's selection from those choices employing GUI 210, can be stored as user-selected terminator 170. (Terminator selector 190 can be employed with any of the embodiments one through eleven herein described or other embodiments or examples.)

An example of operation of terminator selector 190 will now be given. A user-selectable “ring” option is included on an opening display on GUI 210. The user touches the “ring” icon. A next screen presents ring options with one of the options being “terminators”. The user then touches the “terminators” icon. A next screen presents a plurality of terminator options. For example: “not available message” (a voice or other message sent to the caller stating that the caller is not available); “call back in 15 minutes” (a voice or other message sent to the caller suggesting that the caller call the user back, the example given in 15 minutes); “user call back in 15 minutes” (a voice or other message sent to the caller suggesting that the user will call the caller back, the example given in 15 minutes); “not available, please call back message” (a voice or other message sent to caller suggesting as said); “hang up” (instructs interface 31 to go on-hook); “go to voice messaging” (instructs circuitry 150 to forward the call to a voice messaging system, said messaging system can be located at telephone 27 or at service provider 121, or at other); and “no terminator” (employed with the prior given “continuous” duration, thus no terminator employed). The user then touches a chosen terminator. The chosen termination is then stored, for example at jingler 205, as user-selected terminator 170.

Ring-back profile selector 200 functions to enable a user to select a ring-back profile (and/or to configure a second ring-back profile to replace a first ring-back profile). An exemplary ring-back profile selector 200 is depicted in FIG. 12. The exemplary selector 200 includes GUI 210 (described prior) and also includes a ring-back profile 174 (shown as R.P. 174). Profile selector 200 enables a user to select a ring-back profile by employing at least two of ring-back selector 180 (described prior), ring-back duration selector 185 (described prior) and terminator selector 190 (described prior). The user's selection is then stored as ring-back profile 174. (Ring-back profile selector 200 can be employed with any of the embodiments one through eleven herein described or other embodiments or examples.)

An example of operation of ring-back profile selector 200 will now be given. A “ring” option can be included on an opening display on GUI 210. The user touches the “ring” icon. A next screen presents ring options with one of the options being “choose ring-back profile”. The user then touches the “choose ring-back profile” icon. A next screen presents the profile options: “choose ring-back”, “choose ring-back duration”, “choose ring-back terminator” and “DONE”. The user, for example, touches “choose ring-back”. A next screen presents the contents of a ring-back folder. The user selects a ring-back from the ring-back folder contents presented by touching that ring-back icon. The ring-back choice is then stored, for example at jingler 205, in ring-back profile 174.

A next screen again presents the profile options: “choose ring-back”, “choose ring-back duration”, “choose ring-back terminator” and “DONE”. The user then, for example, touches “choose ring-back duration”. A next screen presents a plurality of duration options. The user can select a ring-back duration from the duration options presented by touching that duration icon. The ring-back duration choice is then stored in profile 174. A next screen again presents the profile options: “choose ring-back”, “choose ring-back duration”, “choose ring-back terminator” and “DONE”. The user then, for example, touches “choose ring-back terminator”. A next screen presents a plurality of terminator options. The user selects a terminator from the terminator options presented by touching that terminator icon. The terminator choice is then stored in profile 174. A next screen again presents the profile options: “choose ring-back”, “choose ring-back duration”, “choose ring-back terminator” and “DONE”. The user then, for example, touches “DONE”. The “DONE” selection instructs selector 200 that profile 174 is complete and ready for implementation. Subsequently, an incoming call is detected. In response, ring circuitry 150 delivers profile 174 to the caller.

Mobile phone 165 has been described prior employed with the tenth embodiment. When employed with this eleventh embodiment, phone 165 can function to facilitate the selection of content for play as one or more of ring-back 154, ring-back profile 200, re-direct profile 195 and phone-off profile 225, or other. Phone 165 can further function to facilitate delivery of one or more of: ring-back 154, ring-back duration 168, terminator 170, ring-back profile 200, re-direct profile 195 and phone-off profile 225, or other. Phone 165 can provide that content can be accessed, and accessed mobily, via service provider 121, from provider 121 and/or from the internet, from a phone manufacturer web site or other. Libraries of content can be accessed providing choices that can be employed as ring-back 154, choices that can be employed as ring-back duration 168 and choices that can be employed as terminator 170 (whether ring-back 154, duration 168 or terminator 170 are employed, or not, as part of profile 200, profile 195 or profile 225). Additionally, delivering features such as ring-back 154, duration 168, terminator 170, ring-back profile 200, re-direct profile 195 and phone-off profile 225 from phone 165 provides the user freedom from the service provider's control over the selection and use of said features when delivered from provider 121. (Alternately and/or additionally, libraries of content can be stored in phone 165.) Said features can be delivered to a caller from phone 165 when phone 165 includes, for example, interface 31, call detector 96 and ring circuitry 150. As an example of operation, call detector 96 detects an incoming call and signals interface 31 and circuitry 150. Interface 31 responds by going off-hook. Circuitry 150 responds by sending the particular feature to the caller.

An example of this eleventh embodiment is illustrated as telephone call handling system 10p in FIG. 12. System 10p includes one or more of: ring-back selector 180, ring-back duration selector 185, ring-back terminator selector 190 and ring-back profile selector 200. System 10p interacts with, and can include ring circuitry 150, jingler 205, interface 31 and call detector 96 (all shown located at telephone 27p). Jingler 205 can include circuitry and/or programming to time the elapsed ring-back duration. System 10p also can include telephone 27p and with telephone 27p comprising mobile phone 165. Also, this eleventh embodiment can be enhanced through inclusion of one or more of: a re-direct selector 195, a phone-off selector 225 and a text selector 215, all three shown in FIG. 12. (Each of selectors 195, 225 and 215 can be employed with other embodiments and examples described herein, or other, or can be employed stand-alone such as described for profile 200 and profile 225 of this system 10p. Also, system 10p can optionally include ring selector 175 as suggested prior. The user can then select the same or like sound for ring 153 as selected for ring-back 154 enabling the listening experience to be shared and remind the user of his choice for ring-back 154. Also as suggested, system 10p can optionally include ring modifier 155 and/or ring-back modifier 233.)

An example of operation of this eleventh embodiment, employing the example of ring-back selector 180 shown in FIG. 12, will now be given. The user just bought a new song by his favorite band. The user converts the song into a ring-back and downloads the ring-back into a ring-back folder on his mobile phone 165. Subsequently, the user employs ring-back selector 180 to select the ring-back from the ring-back folder, as presented on GUI 210. The chosen ring-back is then stored as user-selected ring-back 154 at jingler 205. Some time later, detector 96 detects an incoming call and signals circuitry 150. Circuitry 150 responds by sending the clip of the new song by his favorite band, stored as ring-back 154, to alert the caller that the user is being alerted.

An example of operation of this eleventh embodiment, employing the example given of ring-back duration selector 185, will now be given. The user prefers not to be charged for playing a ring-back from his mobile phone. He has heard that his service provider 121 does not charge for incoming calls of duration 30 seconds or less. Consequently, the user employs ring-back duration selector 185 and selects a “20 seconds” ring-back duration option presented on GUI 210. The 20-seconds choice is then stored as user-selected ring-back duration 168 at jingler 205. Subsequently, detector 96 detects an incoming call and signals circuitry 150. Circuitry 150 responds by sending a ring-back to the caller for the user-selected 20-seconds (stored as duration 168) as timed by jingler 205.

An example of operation of this eleventh embodiment employing the example given of terminator selector 190 will now be given. The user is working in the garden. He figures he'll be done working in some 30 minutes. Consequently, the user decides to leave his mobile phone 165 on a nearby table to keep dirt out of it and employs terminator selector 190 and selects a “call back in 30 minutes” terminator option presented on GUI 210. The user's selection is then stored as user-selected terminator 170 at jingler 205. Subsequently, detector 96 detects an incoming call and signals circuitry 150. Circuitry 150 responds by sending a ring-back to the caller for a specified maximum duration as timed by jingler 205. The user fails to answer the call within said maximum duration. Jingler 205 signals circuitry 150. Circuitry 150 responds by employing terminator 170. Consequently, a stored voice (or other) message is sent to the caller suggesting that the caller call the user back in 30 minutes.

An example of operation of this eleventh embodiment, employing the example given of profile selector 200 and wherein selector 200 includes ring-back selector 180 and ring-back duration selector 185, will now be given. (For this example, a non user-selected terminator is employed.)

The user wishes to share a clip of a new song release he recently stored in his mobile phone 165. To do so, the user employs ring-back selector 180 and selects the clip to be his ring-back. The selection is then stored as user-selected ring-back 154. The user wants whomever calls to hear a significant part of the new release now comprising his ring-back. Consequently, the user employs ring-back duration selector 185 to select a “60 seconds” ring-back duration option presented on GUI 210. The 60-seconds choice is then stored as user-selected ring-back duration 168. (Ring-back 154 and ring-back duration 168 have been stored in ring-back profile 174, shown located at jingler 205.)

Subsequently, detector 96 detects an incoming call and signals circuitry 150. Circuitry 150 responds by sending the newly chosen ring-back 154 to the caller. The user does not answer the call because he wants the caller to hear the entire 60 seconds of the song. He has employed modified ring 155 to interject a beep into the ring 153 he is hearing to let him know that only five seconds remains of the 60-second time period allotted by duration 168. However, if he fails to timely answer as timed by jingler 205, jingler 205 can respond by signaling circuitry 150. Circuitry 150 responds by implementing a non user-selected terminator, for example, forwarding the caller to a voice mail service.

An example of operation of this eleventh embodiment, employing the example given of profile selector 200 and wherein selector 200 includes ring-back selector 180 and ring-back terminator selector 190, will now be given. For this example, a non user-selected ring-back duration is employed.

The user wishes to send a message to the world in general and to her ex-boyfriend in particular. Therefore, she clips from a song the line, “You deserted me in my darkest hour” and loads the clip into the ring-back folder in her mobile phone 165. She then employs ring-back selector 180 and selects the clip to be her ring-back. The selection is then stored as user-selected ring-back 154. The user then employs terminator selector 190 to select a terminator that compliments her chosen ring-back. The user selects a “Never call back” voice message terminator option presented on GUI 210. The “Never call back” choice is then stored as user-selected terminator 170. (Ring-back 154 and ring-back terminator 170 have been stored in ring-back profile 174, shown located at jingler 205.)

Subsequently, detector 96 detects an incoming call and signals circuitry 150. Circuitry 150 responds by sending the user's clip from the song to the caller and the user does not answer the call because she does not want to talk to anybody. The ring-back 154, “You deserted me in my darkest hour”, plays for a non user-selected ring-back duration. Circuitry 150 responds to the conclusion to the set ring-back duration by implementing terminator 170. Consequently, the terminator 170, “Never call back” is played to the caller.

An example of operation of this eleventh embodiment, employing the example given of profile selector 200 and wherein selector 200 includes ring-back duration selector 185 and ring-back terminator selector 190, will now be given. (For this example, a non user-selected ring-back is employed.)

The user had neither time nor money nor inclination to buy a high-end mobile phone. Consequently, his mobile phone 165 sends a prescribed ring-back to the caller. Additionally, phone 165 comprises his only phone. When at home, he uses phone 165 in the place of a landline telephone. As such, he places mobile phone 165 on a table and goes about his business. As part of this strategy, he employs ring-back duration selector 185 to select a duration that allows him ample time to get to the phone. Accordingly, the user selects a “45 seconds” ring-back duration option presented on GUI 210. The 45-seconds choice is then stored as user-selected ring-back duration 168.

The user dislikes the cat and mouse aspect to employing an answering service. Besides, he finds that just looking at a received-calls record provided on his phone works similarly well. Furthermore, he figures that if he hasn't answered in the 45 seconds, he must be temporarily out of ear-shot from phone 165, but not for long. In light of these factors, the user employs terminator selector 190 to select an “I'm not available, please call back” voice message terminator option presented on GUI 210. The selected voice message is then stored as user-selected terminator 170. (Ring-back duration 168 and ring-back terminator 170 have been stored in ring-back profile 174, shown located at jingler 205.)

Some time later, detector 96 detects an incoming call and signals circuitry 150. Circuitry 150 responds by sending the prescribed ring-back to the caller for the up to 45 seconds allotted by ring-back duration 168. The user is deep asleep and does not answer. (He has chosen “Birds of Nature” as his ring 153 and they put him to sleep during a previous incoming call.) Jingler 205 times the duration and responds by signaling circuitry 150 when the 45 seconds are up. Circuitry 150 responds by implementing terminator 170. Consequently, “I'm not available, please call back” is sent to the caller.

An example of operation of this eleventh embodiment, employing the example given of profile selector 200 and wherein selector 200 includes ring-back selector 180, ring-back duration selector 185 and ring-back terminator selector 190, will now be given.

The user employs mobile phone 165 as his business phone. He has recorded an informational message clip pertaining to the business, has loaded the clip into the ring-back folder on phone 165 and then employs ring-back selector 180 to select the message clip to be his ring-back. The selection is stored as user-selected ring-back 154. The user knows that the message clip runs for 42 seconds. Accordingly, the user employs ring-back duration selector 185 to select a “user entered” ring-back duration option presented on GUI 210. The user then enters 42 on a key-pad provided by GUI 210 to indicate the 42 seconds The 42 seconds choice is then stored as user-selected ring-back duration 168. Because phone 165 is operated for business purposes, the user employs terminator selector 190 to select a “user-recorded” terminator option presented on GUI 210. The user user-recorded terminator option provides that the user can record a personalized message. He records a message such as “I have no idea how my mobile phone and I got separated, but please call back in 25 minutes and I'm sure we'll be re-united by then”. The personalized message is then stored as user-selected terminator 170. (Ring-back 154, ring-back duration 168 and ring-back terminator 170 have been stored in ring-back profile 174, shown located at jingler 205.)

Some time later, detector 96 detects an incoming call and signals circuitry 150. Circuitry 150 responds by sending the informational message clip (ring-back 154) from circuitry 150 to the caller. The business owner fails to answer within the 42-second time period allotted by ring-back duration 168 (e.g. he's currently occupied with a customer). Jingler 205 times the duration and responds by signaling circuitry 150 when the 42 seconds are up. Circuitry 150 responds by implementing terminator 170. The voice message “I have no idea how my mobile phone and I got separated, but please call back in 25 minutes and I'm sure we'll be re-united by then” is sent to the caller.

System 10p can be enhanced through inclusion of re-direct selector 195. Re-direct selector 195 functions to enable a user to select a re-direct ring-back profile (and/or to select a second re-direct ring-back profile to replace a first re-direct ring-back profile). An exemplary re-direct selector 195 is depicted in FIG. 12. The exemplary selector 195 includes GUI 210 (described prior) and also includes a re-direct ring-back profile 172 (shown as R.R.P. 172). A user is enabled to select from a plurality of choices, one or more of: a ring-back, a ring-back duration and a ring-back terminator. The user's selection from those choices, via GUI 210, is then stored as re-direct ring-back profile 172. Jingler 205 can comprise circuitry and/or programming for monitoring caller I.D. information and circuitry and/or programming for monitoring terminators sent. Jingler 205 can then employ the caller I.D. information in combination with the terminator-sent information to determine if a caller has been sent a terminator and said caller is subsequently calling back within a specified period of time. If so, jingler 205 can then employ and send re-direct ring-back profile 172 to the caller (for example, sent in the place of ring-back profile 174, or other). (Re-direct selector 195 can be employed in conjunction with and/or to enhance any of the embodiments one through eleven herein described or other embodiments or examples. Selector 195 can also be employed stand-alone, i.e. in conjunction with and/or to enhance the operation of a conventional telephone.)

An example of operation of re-direct selector 195 will now be given. A “ring” option is included on an opening display on GUI 210. The user touches the “ring” icon. A next screen presents ring options with one of the options being “choose re-direct ring-back profile”. The user touches the “choose re-direct ring-back profile” icon. A next screen presents profile options: “choose ring-back”, “choose ring-back duration”, “choose ring-back terminator”, “choose calling back period” and “DONE”. The user, for example, touches “choose ring-back”. A next screen presents the contents of a ring-back folder. The user selects a ring-back from the folder and the ring-back choice is stored in profile 172.

A next screen again presents the profile options: “choose ring-back”, “choose ring-back duration”, “choose ring-back terminator”, “choose calling back period” and “DONE”. The user then, for example, touches “choose ring-back duration”. A next screen presents a plurality of duration options. The user selects a ring-back duration and the ring-back duration choice is then stored in profile 172. A next screen again presents the profile options: “choose ring-back”, “choose ring-back duration”, “choose ring-back terminator”, “choose calling back period” and “DONE”. The user then, for example, touches “choose ring-back terminator”. A next screen presents a plurality of terminator options. The user selects a terminator and the terminator choice is stored in profile 172. A next screen again presents the profile options: “choose ring-back”, “choose ring-back duration”, “choose ring-back terminator”, “choose calling back period” and “DONE”. The user then, for example, touches “choose calling back period”. A next screen presents a plurality of calling back period options. The user selects a period from the period options presented by touching the period choice icon, for example, the user selects “40 minutes”. The 40-minute calling back period choice is then stored in profile 172. A next screen again presents the profile options: “choose ring-back”, “choose ring-back duration”, “choose ring-back terminator”, “choose calling back period” and “DONE”. The user then, for example, touches the “DONE” icon. The “DONE” selection instructs selector 195 that profile 172 is ready for implementation. Subsequently, jingler 205 determines from caller I.D. information that a particular caller has been sent a terminator and said caller is subsequently calling back within the user-specified 40-minute calling back period. Jingler 205 instructs circuitry 150 and circuitry 150 responds by employing re-direct ring-back profile 172 as the ring-back profile sent to the calling back caller.

An example of operation of this eleventh embodiment when enhanced with re-direct selector 195 (FIG. 12) will now be given. The user has employed re-direct selector 195 and has chosen a two-verse clip of the song I Gotta Be Me as the re-direct ring-back. The user has selected 26 seconds as the re-direct ring-back duration (26 seconds coinciding with the duration of the two-verse clip). The user has chosen to record a personalized message to be the re-direct terminator, the message for example, “I'm so sorry I've missed you again, please call back in 10 minutes or I'll call you back”. The user has chosen 40 minutes as the re-direct period option. The four choices are stored in re-direct ring-back profile 172 shown located at jingler 205.

An incoming call is received, not answered, and a terminator is sent to the caller. (For this example, the ring profile 174 sent to this caller is that described prior for the example of operation of this eleventh embodiment, employing selector 200, wherein selector 200 includes ring-back selector 180, duration selector 185 and terminator selector 190. In other words, ring-back 154 comprises the informational message clip, duration 168 comprises 42 seconds and terminator 170 comprises the user recorded personalized call back message.) Jingler 205 has noted the caller I.D. and time of day associated with the terminator-sent call. The caller calls back some 36 minutes later. Jingler 205 recognizes the caller I.D. and further recognizes that this caller has called back within the user-selected 40-minute re-direct period. Therefore, jingler 205 instructs circuitry 150 to implement re-direct ring-back profile 172. The caller is played the two-verse I Gotta Be Me clip. If the user does not answer within 26-second re-direct ring-back duration, the re-direct terminator, “I'm so sorry I've missed you again, please call back in 10 minutes or I'll call you back.” will be sent to the caller. (A second, third etc. redirect having the same or different selections by the user can be implemented.)

System 10p can be enhanced through inclusion of phone-off selector 225. Phone-off selector 225 functions to enable a user to select a phone-off ring-back profile (and/or to select a second phone-off ring-back profile to replace a first phone-off ring-back profile). An exemplary phone-off selector 225 is depicted in FIG. 12. System 10p, when enhanced with selector 225 can include mobile phone 165. The exemplary selector 225 includes GUI 210 (described prior) and also includes a phone-off ring-back profile 176 (shown as P.R.P. 176). For this example, a user is enabled to select from a plurality of choices, one or more of: a ring-back, a ring-back duration and a ring-back terminator. The user's selection from those choices employing GUI 210, is then stored as phone-off ring-back profile 176. Jingler 205 can comprise circuitry and/or programming for monitoring whether mobile phone 165 is operational or has been turned off. If phone 165 is off, jingler 205 can then implement and send phone-off ring-back profile 176 to the caller (for example, in place of the otherwise sent ring-back profile 174 when phone 165 is operational.) (Phone-off profile selector 225 can be employed in conjunction with and/or to enhance any of the embodiments one through eleven herein described or others. Selector 225 can also be employed stand-alone, i.e. in conjunction with and/or to enhance the operation of a conventional telephone.)

An example of operation of phone-off selector 225 will now be given. A “ring” option is included on an opening display on GUI 210. The user touches the “ring” icon. A next screen presents ring options with one of the options being “phone-off ring-back profile” which the user touches. A next screen presents profile options: “choose ring-back”, “choose ring-back duration”, “choose ring-back terminator”, and “DONE”. The user then completes selection of profile 176 as described prior for selection of profile 174, i.e. the user chooses a ring-back, chooses a ring-duration, chooses a terminator and, then, touches DONE. The user's choices are stored in profile 176.

An example of operation of this eleventh embodiment when enhanced with phone-off selector 225 (FIG. 12) will now be given. Phone-off selector 225 can operate substantially as described for user-selected ring-back profile 200 with the exception that profile 200 operates while phone 165 is operational and profile 225 operates while phone 165 is turned off. Accordingly, the user's selections for profile 225 can reflect the off condition of phone 165. As an example of user choices, the user might select a four-verse clip of the song such as Dream Baby by Roy Orbison. The user might then select a 44-second ring-back duration to coincide with the duration of the four-verse clip. The user might then choose to send the call to voice messaging as a terminator. The voice-messaging message might then be a user-recorded personalized message such as, “I've gone fishin', or at least I hope I have. Leave a message, Dude!” The user's choices for ring-back, duration and terminator are stored in phone-off profile 176, shown located at jingler 205.

Some time later, detector 96 detects an incoming call and signals circuitry 150. Jingler 205 recognizes that phone 165 is off and, so, implements phone-off profile 176. Consequently, circuitry 150 responds to the signal from detector 96 by sending Dream Baby to the caller for 44 seconds. No one answers because phone 165 is off. Circuitry 150 responds to the expiration of the 44 seconds (as timed by jingler 205) by sending the caller to voice messaging where, “I've gone fishin', or at least I hope I have. Leave a message, Dude!” is sent to the caller. The caller may leave a message.

This eleventh embodiment can be enhanced through inclusion of a text delivery 300. Text delivery 300 functions to enable a user-selected text message to be sent to one of a calling telephone or to a called telephone. An exemplary text delivery 300, which can be used to enhance this eleventh embodiment, is depicted in FIG. 12. For this exemplary text delivery 300, delivery 300 includes a text selector 215, a text storage 169, a delivery trigger 290 and a text sender 220.

Text selector 215 functions to enable a user to select a text message prior to a telephone call (and/or to select a second text message prior to a telephone call to replace a first text message). An exemplary text selector 215 is depicted in FIG. 12 (shown as T. Selector 215 located at interface 31). The exemplary selector 215 includes GUI 210. For this example, GUI 210 includes programming to facilitate the selection and storage of text. A user can be provided with a plurality of choices for text and the user's selection from those choices, via GUI 210, can be stored in text storage 169 (described below). The user can employ GUI 210, via mobile phone 165, to select text from an internet site provided by service provider 121 or from an internet site of a telephone manufacturer or from other. GUI 210 can include programming to provide the user with a keypad (or other data entry device) to enable the user to write a text message. The user can employ selector 215 to load the selected text message or the written text message into text storage 169. For this example, GUI 210 is electrically connected to (or connectable to) storage 169. (GUI 210 can include voice-to-text software to convert a spoken message into text.) (Text selector 215 can be located at telephone 27, at service provider 121 or elsewhere, for example, selector 215 can be located at a computer, selected text stored, for example, at telephone 27 or at service provider 121, or at other.)

ONE EXAMPLE of operation of text selector 215 will now be given. A user-selectable “ring” option is included on an initial display on GUI 210. The user touches the “ring” icon. A next screen presents ring options with one of the options being “text”. The user then touches the “text” icon. A next screen presents text options, for example, “pre-scripted text”, “personalized text” and “prescribed text”. The user then touches either “pre-scripted text”, “personalized text”, or “prescribed text”. (Pre-scripted text can comprise text written by other than the user and available for the user to employ. Personalized text can comprise text written by the user. Prescribed text can comprise text written and nested with, for example, a pre-recorded message or a song (content) or other, nested by, for example, the source of the message, song or other.)

A next screen presents a plurality of ring-back related text function options. For example: “ring-back text”, “terminator text”, “ring-back profile text”, “re-direct text” and “phone-off profile text”. The user then chooses a function by touching the representative icon on the display of GUI 210. If the user has previously chosen “pre-scripted text”, a next screen presents pre-scripted text options pertaining to the user's choice from the given text function options. For example, ring-back text: “content type pre-scripted”, “pre-scripted other messages”. Terminator text: “pre-scripted terminator messages”, “pre-scripted other messages”. Ring-back profile text: “pre-scripted ring-back profile messages”, “pre-scripted other messages”. Re-direct text: “pre-scripted re-direct messages”, “pre-scripted other messages”. Phone-off profile text: “pre-scripted phone-off messages”, “pre-scripted other messages”. Upon the user selecting one of the pre-scripted text options, a next screen presents a plurality of pre-scripted text messages that the user can choose from. For example, if the user has chosen “pre-scripted re-direct messages” then pre-scripted text messages such as “I'm anxious to talk with you too!” and “I'd bet I'm home, come give me a knock” would be available for the user to choose from. The user chooses a pre-scripted text message pertaining to the chosen ring-back related function and that choice is then stored in text storage 169 under the function. For example, if the user is selecting ring-back text, the selection is stored in text storage 169 under ring-back text 178. (If the user has chosen “pre-scripted other messages”, under any of the functions, the plurality of pre-scripted text messages presented on the display of GUI 210 don't necessarily pertain to the given text function. For example a pre-scripted other message might be “Pluto is certainly green this time of year”.)

If the user has previously chosen “personalized text”, a next screen enables the user to enter a personalized text message pertaining to the user's choice from the given text function options, for example entered on a keypad provided by GUI 210. For example, for ring-back text, the user might enter “Dude, I just saw these guys in concert”. For example, for terminator text, the user might enter “Bet you wish you knew what I am doing”. For example, for ring-back profile text, the user might enter “Can you believe the color of eyes on that Sally Walters” (the text message sent as the only message sent during the ring-back profile duration). For example for re-direct text, the user might enter “I'm busier than a kitty cat at a mouse convention”. For example for phone-off profile text, the user might enter “call me next year, I just met the Alice of my dreams in Wonderland”. The user's choice for a personalized text message pertaining to the chosen ring-back related function is then stored in text storage 169 under the function. For example, if the user is selecting re-direct text, the selection is stored in text storage 169 under re-direct text 182.

Further on the example, if the user has previously chosen “prescribed text”, a next screen presents the prescribed text options “check for prescribed text” and “Quit”. Upon the user touching the “check for prescribed text” option, text selector 215 looks for a prescribed text message nested with the ring-back related function associated to the user's text function choice. For example, if the user has selected “terminator text”, selector 215 looks for a prescribed text message nested with the terminator stored in terminator 170. If a prescribed text message is found, a next screen presents the options: “Select” and “Quit”. Upon the user touching “Select”, the prescribed text message nested with the chosen ring-back related function is then stored in text storage 169 under the function. For example, if the user is selecting re-direct text, the prescribed text message is stored in text storage 169 under re-direct text 182. (Selecting “Quit” returns, for example, to the initial display on GUI 210.)

Text storage 169 functions to store at least one text message. An exemplary text storage 169 is depicted in FIG. 12, shown as TEXT 169 and shown located at interface 31. Text storage 169 can include circuitry and/or programming to facilitate the storing of the at least one text message. The at least one text message can be a message selected employing text selector 215. (Text storage 169 can be located at telephone 27, at service provider 121 or elsewhere.)

Delivery trigger 290 functions to initiate a sending. An exemplary delivery trigger 290 is depicted in FIG. 12. The exemplary delivery trigger 290 can include one or more of a linked trigger 240 and a deployed trigger 250. When enhancing the eleventh embodiment, delivery trigger 290 is depicted comprising linked trigger 240. (Delivery trigger 290 can be located at telephone 27, at provider 121, or can be located elsewhere.)

Linked trigger 240 functions to link a sending to some other activity. Linked trigger 240 can function to link a sending (including the sending of a text message) to the sending of one or more of: an audio message and/or an audio content, an image (picture), video, a user-selected audio message and/or a user-selected audio content, a user-selected image, a user-selected video, a user-deployed audio message and/or a user-deployed audio content, a user-deployed image, a user-deployed video, a user-picked audio message and/or a user-picked audio content, a user-picked image, a user-picked video, or other. Linked trigger 240 can function to link the sending of a text message to one or more telephone events such as: a receipt of an incoming call, an answering of an incoming call, a user hang-up, a caller hang-up, receipt of an incoming call placed from a specific telephone, a timed duration subsequent to or prior to a telephone event, or other.

An exemplary linked trigger 240 is shown as L. Trigger 240a in FIG. 12. The exemplary trigger 240a includes circuitry and/or programming to link the sending of a text message to the sending of an audio message and/or of an audio content. (The audio message and/or audio content can be user-selected, or other.) For this example, trigger 240a is electrically connected to (or connectable to) text sender 220 and to jingler 205. For this example, selector 215 serves to enhance this eleventh embodiment and, accordingly, a text message stored in storage 169 can comprise: a ring-back text 178 (shown as R.B.T. 178), a terminator text 179 (shown as T.T. 179), a ring-back profile text 181 (shown as R.B.P.T. 181), a re-direct text 182 (shown as R.D.T. 182) or a phone-off profile text 183 (shown as P.P.T. 183). Accordingly, linked trigger 240a can serve to send to the caller: ring-back text 178 to accompany ring-back 154; terminator text 179 to accompany terminator 170; ring-back profile text 181 to accompany ring-back profile 174; re-direct text 182 to accompany re-direct ring-back profile 172 or phone-off profile text 183 to accompany phone-off ring-back profile 176.)

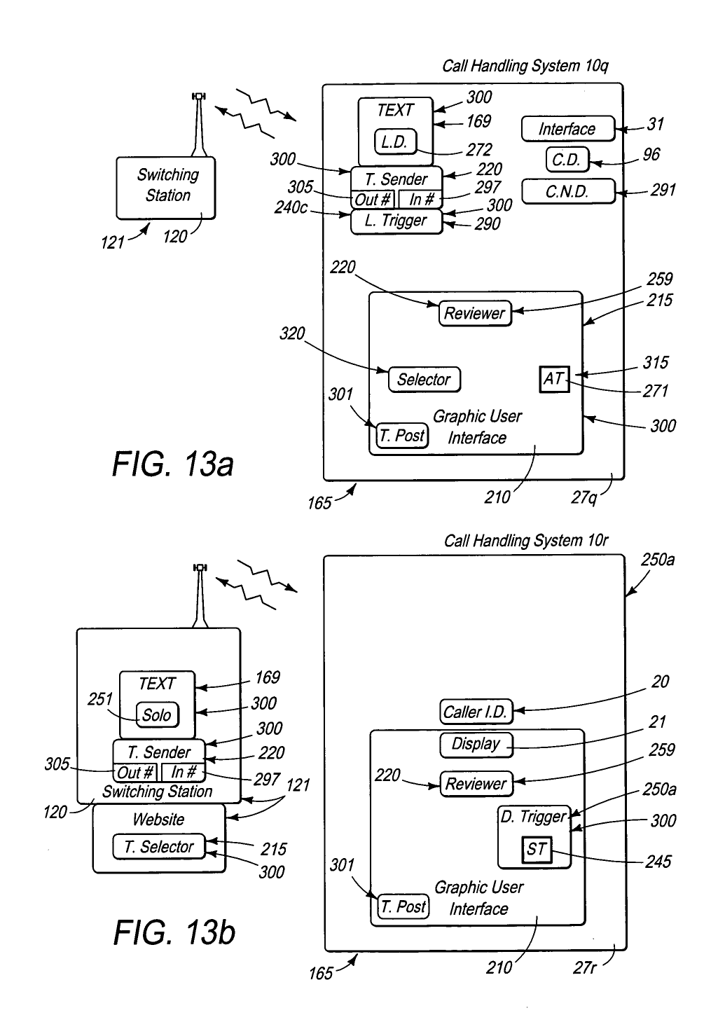

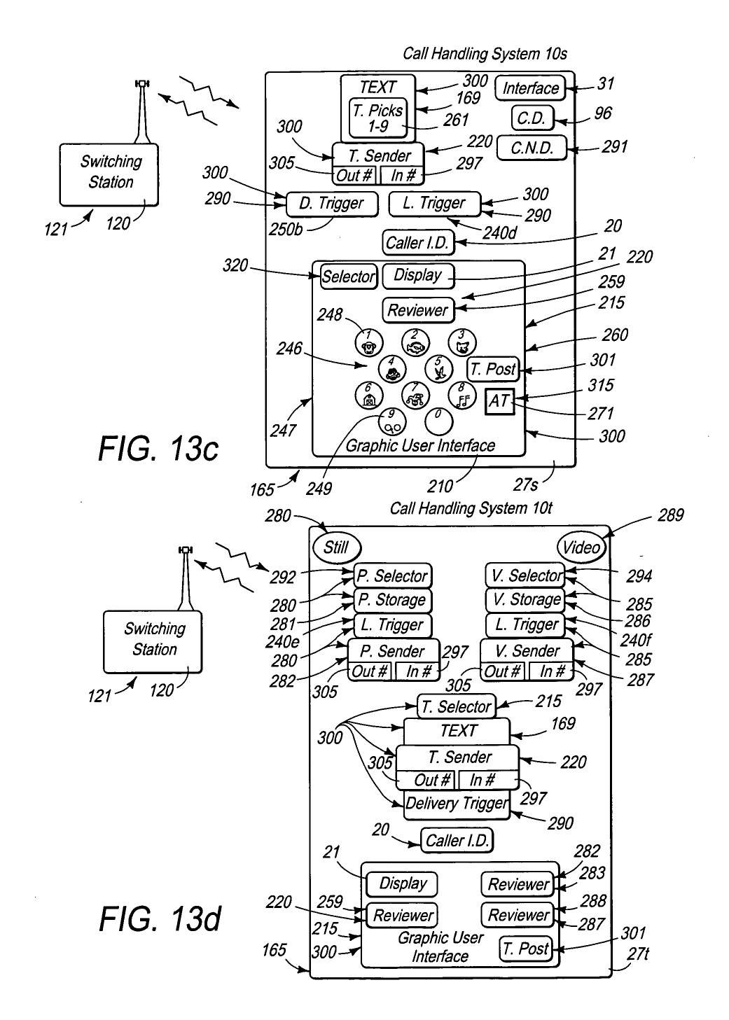

Text sender 220 functions to send a text message to one of a calling telephone or to a called telephone. An exemplary text sender 220 is depicted in FIG. 12 (shown as T. Sender 220 located at interface 31) and is depicted in FIGS. 13a through 13d (shown as T. Sender 220). Sender 220 can include circuitry and/or programming to send a stored text message to a calling telephone. Different ways can be envisioned to address a text message for delivery to the calling telephone. A serial number associated with the calling telephone can be included with the incoming ring signal. A text message can be sent to an address on file at provider 121 associated with that serial number. A text message sent by the user during an incoming call can be understood by provider 121 to be delivered to the calling telephone.

For this exemplary eleventh embodiment (and for the exemplary twelfth embodiment), to send a text message to a calling telephone (i.e. incoming call to the user), as but one example, text sender 220 can include circuitry and/or programming for obtaining the caller I.D. information included with the ring signal of an incoming call. Sender 220 can store the obtained caller I.D. information, for this example, at storage In Number 297, hereafter referred to and shown in FIG. 12 and FIGS. 13a through 13d as In # 297. Sender 220 can then employ the telephone number stored at IN # 297 to designate, to provider 121 for example, where the text message is to be delivered. Provider 121 can then deliver the text message to the designated telephone. (This arrangement differs from the current state of the art wherein a user must first open a menu, then enter the telephone number of the calling party and then instruct to send the text message.)

Text sender 220 can include circuitry and/or programming to send a stored text message to a called telephone. Different ways can be envisioned to address a text message for delivery to a called telephone. As one example, a text message sent by the user during an outgoing call can be understood by provider 121 to be for delivery to the telephone number dialed by the user.

For this exemplary eleventh embodiment (and for the exemplary twelfth embodiment), to send a text message to a called telephone (i.e. outgoing call from the user), as but one example, text sender 220 can include circuitry and/or programming for obtaining the telephone number dialed by a user when placing a telephone call. Sender 220 can store the obtained called (dialed) telephone number, for this example, at storage Out Number 305, hereafter referred to and shown in FIG. 12 and FIGS. 13a through 13d as OUT # 305. Sender 220 can then employ the telephone number stored in OUT # 305 to designate, to provider 121 for example, where the text message is to be delivered. Provider 121 can then deliver the text message to said desired destination. (This arrangement differs from the current state of the art wherein a user must first open a menu, then enter the telephone number of the calling party and then instruct to send the text message.)

Herein has been stated “at the time of the telephone call”. (Once example of such statement, “Deployed trigger 250 functions to enable a user to initiate a sending at the time of the telephone call.”) The statement “at the time of the telephone call” designates the time period from receipt of an incoming ring signal (prior to the call being answered) until the time when the call ends (caller or user hang up). The statement “at the time of the telephone call” also designates the time period from when the user has finished dialing the number to place an outgoing call (prior to the call being answered) until the time when the call ends (caller or user hang up).

Sender 220 can continue to store the caller I.D. information stored at IN # 297 until the arrival of a next incoming call at which time sender 220 can then store at IN # 297 the caller I.D. information associated with said next incoming call and can delete the prior stored incoming call caller I.D. information. The statement “at the time of the telephone call” can also include the above suggested time period from when sender 220 stores the caller I.D. information until sender 220 deletes the information upon the arrival of a next incoming call.

For this exemplary text sender 220, sender 220 is electrically connected to (or connectable to) text storage 169 and to switching station 120 via a wireless connection. Also, sender 220 can include a text reviewer 259 (shown as Reviewer 259 and shown located on GUI 210). Text reviewer 259 functions to display to the user a text message that is to be sent and/or that has been sent to the caller. Displaying the message can serve to affirm the content of a message that the user has chosen. Displaying the message can enable the user to share the experience of receiving the message with the caller. (Text sender 220 can be located at telephone 27 or can be located at service provider 121 or can be located elsewhere.)

ONE EXAMPLE of operation of this eleventh embodiment when enhanced with text delivery 300, with delivery trigger 290 comprising linked trigger 240a, will now be given (FIG. 12). The user has clipped from a song the line, “You deserted me in my darkest hour” and employs the clip as ring-back 154 (and as ring 153). The user selects a duration of 13-seconds as ring-back duration 168. The user selects a “Never call back” voice message as terminator 170. The user then employs text selector 215, selects “personalized text” and, subsequently selects “ring-back profile text”. The user then types on a keyboard provided by GUI 210 the text, for example, “I gave you my heart and you tossed it aside like an old worn out tire”. The text message is stored in text storage 169 under ring-back profile text 181.

Some time later, detector 96 detects an incoming call and signals circuitry 150. Circuitry 150 responds by beginning operation of ring-back profile 200. Accordingly, profile 200 sends the song clip “You deserted me in my darkest hour” (ring-back 154) to the caller (and ring 153 to the user). The clip is sent for 13 seconds as dictated by duration 168 after which the “Never call back” terminator 170 voice message is sent to the caller. Linked trigger 240a recognizes the onset of sending the song clip (the onset of the ring-back profile) and responds by instructing text sender 220 to send the text message stored in text storage 169 under ring-back profile text 181. Sender 220 responds by sending the text message to the calling telephone. Accordingly, at the onset of the sending of the song clip, the text message “I gave you my heart and you tossed it aside like an old worn out tire” is sent by sender 220 to the calling phone. (No other text message is sent. Re-direct text 182 and phone-off profile text 183 can each likewise comprise just one text message. Alternately, ring-back profile text 181, re-direct text 182 and phone-off profile text 183 can each comprise a text message for ring-back 154 and, subsequently, a text message for terminator 170, or other.)

Text delivery 300 can be employed to enhance, linked to, and/or in conjunction with, any of the herein-disclosed embodiments one through eleven and thirteen through fifteen, or other embodiments or examples. Wherever delivery 300 is employed, delivery trigger 290 can comprise linked trigger 240 such that the sending of a text message to a caller can be linked to the sending of any audio message and/or of any audio content/entertainment herein described, can be linked to the sending of an image (picture) and/or of a video, can be linked to one or more telephone operations such as: a receipt of an incoming call, an answering of an incoming call, a user hang-up, a caller hang-up, a caller answering, or other. For example, linked trigger 240 can link the sending of a text message to the sending of any pre-recorded audio message and/or of any audio content/entertainment sent in conjunction with: call back message circuitry 30, message-then-hold circuitry 40, concert circuitry 50, call announce circuitry configured to attain who information 60, call announce circuitry configured to attain what/why information 70, call announce circuitry configured to attain who information and what/why information 80 or message-then-record circuitry 310. (Text delivery 300 can also be configured to cause the sending of a mixed-media message, i.e. two or more of text, audio, image and video, sent to the calling telephone. In one variation, delivery 300 can be configured to send an image, such as a picture of the user, or to send a video clip to the caller.)

As one example of text delivery 300 comprising linked trigger 240 linking the sending of a text message to the sending of an audio message and/or of a content/entertainment herein described, an exemplary text delivery 300 enhancing the eighth embodiment is depicted in FIG. 9. (Said depiction in FIG. 9 also comprises an example of delivery 300 enhancing the second embodiment.) The exemplary delivery 300 of FIG. 9 includes text selector 215 and linked trigger 240. The exemplary delivery 300 can include text storage 169 and can include text sender 220. For this example, storage 169, text sender 220 and linked trigger 240 have been shown located at message sender 32. Text selector 215 is shown located at telephone 27L.

For this example, text selector 215 includes a text selector button 226, shown as T 226 and shown located on telephone 27L, and includes display 21 (selector 215 and display 21 described prior). Button T 226 is electrically connected to UI 99 of starter 92 via line 11a. (UI 99 described prior.) For this example, starter 92 includes circuitry and/or programming and memory to facilitate the selection of a text message via button T 226 and display 21 and also, to facilitate the storage of a text message in text storage 169. Selector 215 can include keypad 47 (described prior). Keypad 47 can be electrically connected to (or connectable to) UI 99 via line 11a and UI 99. Keypad 47 can include letters of the alphabet on each key such that the user can type a text message employing keypad 47, the text message comprising a personalized text. (Text can be entered in a manner as can be presently conventionally accomplished employing a keypad. Alternately, selector 215 can include a keyboard enabling the user to type a text message. Also, text selector 215 can include a voice-to-text converter. Also, text sender 220 can include text reviewer 259, described prior).

For this example, text storage 169 comprises message-then-hold related text 242, shown as M.H.R.T. 242. Message-then-hold related text 242 can comprise a text message associated with a pre-recorded audio message and/or with an audio content/entertainment. Text 242 can comprise a text message associated with a function such as, for example, a function prior described for employment utilizing message-then-hold circuitry 40 (FIG. 2b). Said message, content, function can include: solitary hold message A 71, messages of hold message picker 74, specific-time hold message picker 51, user-selected entertainment 75, picked entertainment E. Picks 76, tiser 135, advertiser picks 137, content message-then-hold 55, disc jockey 115, fader circuitry 113, shuffler 117, caller-picked entertainment 123.

For this example, text sender 220 is electrically connected to (or connectable to) text storage 169 and to line 11. (Sender 220 functions to send a stored text message to one of a calling telephone or to a called telephone.)

For this example, delivery trigger 290 of text delivery 300 comprises linked trigger 240b, shown as L. Trigger 240b in FIG. 9. The exemplary trigger 240b includes circuitry and/or programming to link the sending of a text message to a user-initiated sending of an audio message and/or of an audio content. Said user-initiated sending of an audio message and/or of an audio content can comprise one or more of: a user-deployed audio message (including a user-picked audio message) and a user-deployed audio content (including a user-picked audio content). (Said user-deployed and user-picked messages and/or contents can be user-selected or other.) For this example, linked trigger 240b serves to initiate the sending of a text message stored in message-then-hold related text 242 by linking said sending to the sending of an audio message and/or of an audio content (or of other) to be sent to the calling telephone (sent from message sender 32). For this example, trigger 240b is electrically connected to (or connectable to) text sender 220 and to message sender 32.

ONE EXAMPLE of operation of text delivery 300 when employed to enhance the eighth embodiment will now be given (FIG. 9). To deliver text along with a given hold message, the user employs the following example procedure. Prior to a telephone call, the user pushes text selector button T 226. The user then pushes the hold button associated with a hold message the user desires to send text along with. For example, the user pushes button T 226 followed by hold button 83 (button 83 associated with hold message C 73, shown as H.M. C 73). The user then pushes button T 226 twice to access pre-scripted text, once-for-duration to enter personalized text or three times to check for prescribed text.

As a first example, the user has then pushed button T 226 twice to access pre-scripted text. Twice pushed button T 226 instructs starter 92 to display onto display 21 pre-scripted text stored in starter 92 and available to be sent with hold message C 73 with a first pre-scripted text message highlighted (the pre-scripted text pre-loaded into phone 27L by the phone manufacturer, for example). By again pushing button T 226, the highlighted text message sequences to the next forward text message. In this way, the user can scroll through the pre-scripted hold text messages stored in phone 27L until locating/highlighting a desired text message. Once highlighted, the user pushes button T 226 for a given duration (e.g. 2 seconds). Starter 92 recognizes the pushed-for-duration button T 226 and responds by storing the selected pre-scripted text message in a compartment linked to hold message C 73, the compartment located in message-then-hold related text 242 of text storage 169. The selected text message might be for example, “If dogs could fly, birds would have tails. They can't so I'll be right with you!” Some time later, the user responds to an incoming call (after viewing the caller I.D. displayed on display 21) by pressing hold button 83. Sender 32 responds by sending hold message C 73 “I'll be with you in a couple shakes” to the calling telephone. Linked trigger 240b recognizes the sending of hold message C 73 and instructs text sender 220 to send the pre-scripted text message linked to message C 73, said message stored in message-then-hold related text 242. Sender 220 responds by sending the text message to the calling telephone. Consequently, “If dogs could fly, birds would have tails. They can't so I'll be right with you!” is sent to the calling telephone.

As a second example, the user has then pushed button T 226 once-for-duration to enter personalized text. The user then enters a text message by employing keypad 47 to type the text message. The typed message is stored in a compartment linked to hold message C 73, the compartment located in message-then-hold related text 242 of text storage 169. Later, the user responds to an incoming call be pressing button 83. Sender 32 responds by sending hold message C 73 to the calling telephone. Linked trigger 240b recognizes the sending of hold message C 73 and instructs text sender 220 to send the personalized text message linked to message C 73, said message stored in message-then-hold related text 242. Sender 220 responds by sending the text message to the calling telephone.

As a third example, the user has then pushed button T 226 three times to check for prescribed text. Three times pushed button T 226 instructs UI 99 of starter 92 to check for a prescribed text message associated with hold message C 73. (As an example, hold voice message C 73 can comprise a message pre-recorded by the telephone manufacturer. The manufacturer can nest a prescribed text message to message C 73.) Upon finding a prescribed text message, starter 92 sends a signal to display 21. In response, display 21 displays a message such as “O.K.”. Understanding that the prescribed text message is available, the user pushes button T 226 for a predetermined duration or longer. UI 99 of starter 92 recognizes the pushed-for-duration button T 226 and responds by storing the prescribed text message in a compartment linked to hold message C 73, the compartment located in message-then-hold related text 242 of text storage 169. Some time later, the user responds to an incoming call (perhaps after viewing the caller I.D. displayed on display 21) by pressing button 83. Button 83 sends a signal to sender 32 via UI 99. Sender 32 responds by sending hold message C 73 to the calling telephone. Linked trigger 240b recognizes the sending of message C 73 and instructs text sender 220 to send the prescribed text message linked to message C 73, said message stored in message-then-hold related text 242. Sender 220 responds by sending the text message to the calling telephone. (The prescribed text message can comprise wording different than the voice message. Also, a prescribed text can be the song title and/or artist name belonging to a song being delivered, for example.)

In summary, the examples of the eleventh embodiment (FIG. 12) preferably operate by: enabling a user to select one or more of: a ring-back, a ring-back duration, a ring-back terminator and a ring-back profile; and enabling one or more of: a user-selected ring-back, a user-selected ring-back duration, a user-selected terminator and a user-selected ring-back profile to be sent to a caller as part of indicating that the user is being alerted as to the presence of the incoming call. The examples of the eleventh embodiment can further operate by enabling a user to select a text message and to send the text message to the calling telephone.

As can be seen from the foregoing, the present disclosure provides for a telephony system for use with a user telephone, the user telephone enabled to receive telephone calls. The system can include circuitry and/or programming to enable a user to select from the plurality of content and/or response choices. The system can further include the plurality of content and/or response choices. The system can further include circuitry and/or programming to employ the selection or selections in functions related to delivering a ring-back to a caller. The system can further include circuitry and/or programming to implement the functions related to delivering a ring-back to a caller.

A twelfth embodiment of telephone call handling system 10 is illustrated in FIGS. 13a, 13b, 13c and 13d. This embodiment includes text delivery 300 (described prior, which functions to enable a user-selected text message to be sent to one of a calling telephone or to a called telephone. An exemplary text delivery 300 is depicted in FIGS. 13a, 13b, 13c and 13d. The exemplary delivery 300 includes text selector 215 (described prior, which functions to enable a user to select a text message), text storage 169 (described prior, which functions to store one or more text messages, delivery trigger 290 (described prior, which functions to initiate a sending and text sender 220 (described prior, which functions to send a text message to one of a calling telephone or a called telephone.

The twelfth embodiment can further include caller I.D. circuitry 20 (described prior, which functions to provide caller I.D. information to a user). This embodiment can be enhanced through inclusion of a text picker 260. This embodiment can be enhanced through inclusion of an instant text post 301. The call handling system can also be enhanced through inclusion of one or more of a still camera delivery 280 and a video delivery 285. This embodiment can be enhanced through inclusion of an icon selector 247. This embodiment can include a linked trigger enabler 315 and/or a link selector 320. (This twelfth embodiment can be employed in combination with, or as an enhancement to, any of embodiments one through eleven and thirteen through fifteen herein described or other embodiments and examples.)

For this twelfth embodiment, trigger 290 is depicted comprising at least one of linked trigger 240 and a deployed trigger 250. Linked trigger 240 (described prior) functions to link a sending to some other activity. The sending can comprise one or more of: an audio message, an entertainment/content, a text message, an image, a video or can comprise other. For this twelfth embodiment, the sending can comprise a text message. Trigger 240 can include circuitry and/or programming to link the sending of a text message to some other activity. (When this twelfth embodiment is enhanced through inclusion of camera delivery 280 and/or video delivery 285, the sending can also comprise a picture and/or a video. Trigger 240 can then include circuitry and/or programming to link the sending of a picture and/or video to some other activity.) An exemplary linked trigger 240 is shown as L. Trigger 240c in FIG. 13a.

Deployed trigger 250 functions to enable a user to initiate a sending at the time of the telephone call. The sending can comprise one or more of: an audio message, an entertainment/content, a text message, an image, a video or the sending can comprise other. For this twelfth embodiment, the sending can comprise a text message. Trigger 250 can include circuitry and/or programming to respond to a user's instruction by dispatching a signal to initiate a sending. An exemplary deployed trigger 250a is depicted in FIG. 13b. The exemplary deployed trigger 250a is located at telephone 27r.

A first example of this twelfth embodiment is illustrated as call handling system 10q in FIG. 13a. System 10q includes text selector 215, text storage 169, delivery trigger 290 and text sender 220, all shown located at telephone 27q. This first example of this twelfth embodiment can further include linked trigger enabler 315 and/or link selector 320 (both described later). For this example, telephone 27q comprises mobile phone 165 (phone 165 described prior). System 10q can include telephone 27q and, thus, can include phone 165. (This first example also can include interface 31, call detector 96 and/or call number detector 291, all described prior.)

For this example, text selector 215 includes GUI 210. GUI 210 includes programming to facilitate the selection of a text message. The user can employ GUI 210, via an internet enabled phone 165, to select a text message from an internet site provided by service provider 121 or a from an internet site of a telephone manufacturer or from other (as described prior). (A text message can be downloaded from a text message storage on a PC or other. A selected text message can be pre-scripted and/or prescribed, or other. Also, the user can employ GUI 210 to select a previously selected text messages stored, for example, in stand-alone text 251 and/or in pick storage 261, both described later.) Selector 215 can comprise employing GUI 210 whereby GUI 210 can include programming to provide the user with a keypad (or other data entry device) to enable the user to write a text message. For this example, storage 169 comprises a linked-deliver storage 272 (shown as L.D. 272). Text storage 169 provides for storing a text message in storage 272. The user can employ selector 215 to load a selected text message (selected text can include user-written text) into linked-deliver storage 272. GUI 210 can be electrically connected to (or connectable to) storage 169. Text sender 220 can include circuitry and/or programming to send a stored text message to a calling telephone. Sender 220 can be electrically connected to (or connectable to) text storage 169 and to switching station 120 via a wireless connection. (GUI 210 can include voice-to-text software to convert a spoken message into text. Sender 220 can include the described prior text reviewer 259.)

For this example, delivery trigger 290 comprises linked trigger 240c (trigger 240 described prior). For this example, trigger 240c includes circuitry and/or programming to receive signal input and to respond to said signal input by initiating the sending of a text message. Said signal input can be tied to some other activity (as described prior). Said tied to some other activity can include tied to a telephone operation. As an example of being tied to a telephone operation, trigger 240c can be tied to one or more of: interface 31, call detector 96 (both described prior) and calling number detector 291 (described below). Detector 96 can be electrically connected to (or connectable to) trigger 240c and can function to detect an incoming call. Trigger 240c is electrically connected to (or connectable to) text sender 220. Upon detecting an incoming call, detector 96 sends a signal to trigger 240c. Trigger 240c can respond by instructing text sender 220 to send a text message stored in linked-deliver storage 272. Sender 220 can respond by sending the text message to the calling telephone.

Interface 31 can be electrically connected to (or connectable to) trigger 240c (or can be electrically connected to, or connectable to, any trigger 240 herein described). For all herein given employments of interface 31, interface 31 can function to detect one or more of: the user's answering of an incoming call, a hang-up by the other party, a hang-up by the user, the other party answering, the other party not answering, a message recording device of the other party, a conversation in progress—i.e. communicable connection between user and the other party, (or other). Upon detecting the user's answering of an incoming call, a hang-up by the other party, a hang-up by the user, the other party answering, the other party not answering, a message recording device of the other party, a conversation in progress—i.e. communicable connection between user and the other party, (or other), interface 31 can respond by signaling trigger 240c (trigger 240). Trigger 240c can respond by instructing text sender 220 to send a text message stored in linked-deliver storage 272. As another example of being tied to a telephone operation, linked trigger 240c can include a calling number detector 291, shown as C.N.D. 291 in FIG. 13a. Number detector 291 includes programming and/or software to enable a user to input, for example, the telephone number of a would-be caller. Detector 291 can be electrically connected to (or connectable to) trigger 240c. Subsequently, detector 291 monitors the telephone number (caller I.D. information 20) associated with each incoming call. Upon detecting said input telephone number, detector 291 can respond by signaling trigger 240c. Trigger 240c can respond by instructing text sender 220 to send a text message stored in linked-deliver storage 272. GUI 210 can include programming to receive user instruction via an auto-trigger icon 271 (shown as AT 271 in FIG. 13a). Icon 271 can be presented to the user by GUI 210 on an initial display, for example, when the user turns on mobile phone 165, or can be presented by GUI 210 at some other time. Touching icon 271 can serve to enable or disable trigger 240c.

A first example of operation of this first example of this twelfth embodiment will now be given (FIG. 13a). For this example, linked trigger 240c has been preset by the telephone manufacturer electrically connected to interface 31 to receive signal input therefrom indicating a user hang-up. The user employs text selector 215 (in this case GUI 210) to select a text message stored on the hard drive of his personal computer. The user employs GUI 210 (selector 215) to download the selected text message into linked-deliver storage 272.

Some time later, the user's telephone rings from a ring signal sent by switching station 120 (provider 121). Text sender 220 obtains and stores the caller I.D. information included with the ring signal of the incoming call at storage IN # 297 (supplanting prior stored caller I.D. information at IN # 297 associated with the prior incoming call). The user answers the call. When the conversation has concluded, the user hangs up. The hang up is detected by interface 31. Interface 31 responds by signaling trigger 240c. Trigger 240c responds by signaling text sender 220. Sender 220 responds by sending the text message stored in linked-deliver storage 272 of storage 169. Sender 220 employs the caller I.D. information stored at IN # 297 to designate (for example, to service provider 120) that the text message be delivered to the telephone from where the incoming call originated.

A second example of operation will now be given (FIG. 13a). For this example, linked trigger 240c has been preset by the telephone manufacturer electrically connected to caller detector 96 to receive signal input therefrom indicating the presence of an incoming call. For this example, system 10q includes link enabler 315, enabler 315 comprising auto-trigger icon 271. The user employs text selector 215, in this case a keyboard provided by GUI 210, to write a text message such as “I'm sure glad you called!” The user then further employs GUI 210 (selector 215) to load the written text message into linked-deliver storage 272. Next, GUI 210 presents a screen displaying auto-delivery icon 271 to the user. The user declines to touch icon 271 and, thus, trigger 240c is not enabled to send the text. However, each time the user turns on mobile phone 165, GUI 210 presents auto-delivery icon 271 on an initial screen. Some time later, the user turns on phone 165 and touches icon 271. Touching icon 271 enables linked trigger 240c.

Some time later, the user's telephone rings from a ring signal sent by switching station 120 (provider 121). Text sender 220 obtains and stores the caller I.D. information included with the ring signal of the incoming call at storage IN # 297 (supplanting prior stored caller I.D. information at IN # 297 associated with the prior incoming call). Detector 96 detects the incoming call and responds by signaling linked trigger 240c. Because trigger 240c has been enabled, trigger 240c responds by signaling text sender 220. Sender 220 responds by sending the text stored in linked-deliver storage 272 of storage 169. Consequently, sender 220 sends the text message “I'm sure glad you called!” to the calling telephone number stored at IN # 297.

A third example of operation will now be given (FIG. 13a). For this example, system 10q includes link selector 320. The user employs link selector 320 (via GUI 210) to select an activity to link the sending of a text message to. The user selects “auto-call back” (from a plurality of activity choices). The user then employs text selector 215 (in this case GUI 210) to select a text message stored on the website the user's service provider. The user employs GUI 210 (selector 215) to download the text message into linked-deliver storage 272.

Some time later, the user's telephone rings from a ring signal sent by switching station 120 (provider 121). Text sender 220 obtains and stores the caller I.D. information included with the ring signal of the incoming call at IN # 297 (supplanting prior stored caller I.D. information associated with the prior incoming call). Incoming call detector 96 detects the incoming call and responds by sending a signal to U.I. 99 of activator 91. U.I. 99 responds by sending a signal to linked trigger 240c and a signal to call back message circuitry 30. Circuitry 30 sends a callback message to the caller. Trigger 240c responds by signaling text sender 220. Sender 220 responds by sending the text message stored in text storage 272 of storage 169. Sender 220 employs the caller I.D. information stored at IN # 297 to designate that the text message be delivered to the telephone from where the incoming call originated.

A fourth example of operation will now be given (FIG. 13a). For this example, linked trigger 240c has been preset by the telephone manufacturer electrically connected to calling number detector 291 to receive signal input therefrom indicating that a caller designated by the user is calling. For this example, system 10q includes mobile phone 165. Including phone 165 in system 10q provides that detector 291 can be located phone 165 so the user does not require internet access hardware to input the calling phone number. (Including phone 165 also provides that enabler 315 and/or selector 320 can be located at phone 165, again, eliminating the need for internet access hardware.) The user employs text selector 215, in this case a keyboard provided by GUI 210, to write a text message such as “My apple tree is growing bananas!” The user then further employs GUI 210 (selector 215) to load the written text message into linked-deliver storage 272.

A few days later, the user's telephone rings from a ring signal sent by switching station 120 (provider 121). Text sender 220 obtains and stores the caller I.D. information included with the ring signal of the incoming call at IN # 297 (supplanting prior stored caller I.D. information associated with the prior incoming call). Calling number detector 291 detects that the calling phone has been designated by the user. Detector 291 responds by signaling linked trigger 240c. Trigger 240c responds by signaling text sender 220. Sender 220 responds by sending the text stored in linked-deliver storage 272 of storage 169. Consequently, sender 220 sends the text message “My apple tree is growing bananas!” to the calling telephone stored at IN # 297.

A fifth example of operation will now be given (FIG. 13a). For this example, system 10q includes link selector 320. For this example, interface 31 is configured to detect a called party answering. The user employs link selector 320 (via GUI 210) to select an activity to link the sending of a text message to. The user selects “called party answering” (from a plurality of activity choices). The user then employs text selector 215 (in this case GUI 210) to select a text message stored on the website the user's service provider. The user employs GUI 210 (selector 215) to download the text message into linked-deliver storage 272.

Some time later, the user calls the called party. Text sender 220 obtains and stores the dialed telephone number at OUT # 305 (supplanting a prior stored telephone number associated with the prior outgoing call). Interface 31 detects that the called party has answered. Interface 31 responds by sending a signal to linked trigger 240c. Trigger 240c responds by signaling text sender 220. Sender 220 responds by sending the text message stored in text storage 272 of storage 169. Sender 220 employs the called telephone number stored at OUT # 305 to designate that the text message be delivered to the called telephone.

In addition to the above given examples of linked trigger 240c operating responsive to signal input tied to a telephone operation and/or incoming calling number detection, trigger 240 (including trigger 240c and any/all of the other examples herein given of trigger 240) can operate to initiate a sending to a caller in conjunction with, to enhance, or linked to, for example: the prior described auto-callback 41 (FIG. 1b) and/or the prior described auto-hold 89 (FIG. 3b) and/or the sending of an audio message and/or the sending of an entertainment and/or the sending of an image and/or the sending of a video and/or the sending of other. As one example, upon detecting an incoming call, call detector 96 can initiate the sending of a callback message to the caller (auto-callback 41) and, at the same time can dispatch a signal to, for example, trigger 240c. Trigger 240c can respond by initiating the sending of a text message. A time delay can be implemented between the time a call is detected and the time trigger 240 initiates a sending. As another example, trigger 240 can be configured to initiate a sending linked to, for example, the sending of a callback message (or hold message or other) and can be further configured to initiate a sending of one or more follow-up (or other) sendings.

Linked trigger 240 functions to link a sending to some other activity. Linked trigger 240 is depicted in FIGURES herein comprising a diagrammatic block. Trigger 240 can comprise circuitry and/or programming. Conversely, trigger 240 can merely be an electrical connection between, for example, two components. As an example, linked trigger 240c of system 10q (shown in FIG. 13a) has been described electrically connected to (or connectable to) interface 31 to receive signal input therefrom. Trigger 240c is also electrically connected to (or connectable to) text sender 220. Trigger 240c responds to a signal from interface 31 by sending a signal to sender 220. For this example, trigger 240 can constitute, for example, interface 31 and sender 220 merely electrically connected to one another (directly connected or connected via a wire or otherwise connected).

Handling system 10 can comprise a linked trigger enabler 315. Enabler 315 functions to enable the user to selectively enable and/or disable one or more functions activated by linked trigger 240 (or to selectively enable and/or disable the activation of a function). The above described auto-delivery icon 271 comprises one example of trigger enabler 315, shown in FIG. 13a. The exemplary enabler 315 employs GUI 210. GUI 210 includes circuitry and/or programming to enable the user to selectively enable and/or disable a linked sending, for this example a linked sending of one or more text messages. When enabled, a text message will be sent initiated by linked initiate 240c. When disabled, a text message will not be sent. Functions herein disclosed that can employ linked initiate 240 to be initiated linked to an activity and, thus, that can be enabled/disabled by enabler 315 include: sending of an audio message, sending of an entertainment, sending of an image, sending of a video, auto-callback 41, auto-hold 89 and sending of other. Any of the herein-disclosed embodiments employing the linked initiating of a sending (linked trigger 240) can comprise enabler 315.

Handling system 10 can comprise a link selector 320. Link selector 320 functions to enable a user to select an activity from a plurality of activity choices, a linking of a sending to a caller can then be linked to the selected activity. An exemplary link selector 320 is shown as Selector 320 in FIG. 13a. The exemplary selector 320 employs GUI 210. GUI 210 includes circuitry and/or programming to enable the user to select an activity a linking of a sending, for this example a text message, to a caller to then be linked to the selected activity. For the example illustrated in FIG. 13a, selector 320 enables a user to select an activity, that activity will then signal linked trigger 240c to initiate activation of text sender 220. Activity choices available for a user employing selector 320 to select from can include: the user's answering of an incoming call, a hang-up by the other party, a hang-up by the user, the other party answering, the other party not answering, a message recording device of the other party, a conversation in progress—i.e. communicable connection between user and the other party, prescribed calling number detection (calling number detector 291), audio message sending, entertainment sending, image sending, video sending, time-delayed sending (for example, sending linked to a timer), and other. Any of the herein-disclosed embodiments employing the linked initiating of a sending (linked trigger 240) can comprise Selector 320.

A second example of this twelfth embodiment is illustrated as call handling system 10r in FIG. 13b. System 10r includes text selector 215, text storage 169, delivery trigger 290 and text sender 220. For this example, telephone 27r comprises mobile phone 165 (phone 165 described prior). System 10r can include telephone 27r and, thus, can include phone 165. For this example, text selector 215, text storage 169, and text sender 220 are shown located at service provider 21 (selector 215 shown as T. Sender 215). For this example, delivery trigger 290 comprises deployed trigger 250, trigger 250 shown located at telephone 27r.

For this second example, system 10r can also include caller I.D. circuitry 20 also shown located at telephone 27r. Circuitry 20 is shown employing GUI 210 to serve as display 21 to display caller I.D. information to the user (display 21, described prior, shown in FIG. 13b located on GUI 210). For this example, text selector 215 can be located on a website of service provider 121, said website programmed to facilitate and/or enable the selection of a text message. (Text message selection can comprise any of the examples herein given of selector 215 or other. Also, the user can employ selector 215 to select a previously selected text stored, for example, in the prior described linked-deliver text storage 272 and/or in the to-be-described pick storage 261 described later.) Selector 215 can comprise, for example, employing the keyboard of a personal computer to provide the user with a keypad to enable the user to write a text message. For this example, text storage 169 comprises a stand-alone text storage 251 (shown as Solo 251). Text storage 169 provides for storing a text message in storage 251. The user can employ selector 215 to load a selected text message into stand-alone text storage 251. The website of service provider 121 (including selector 215) can be electrically connected to (or connectable to) storage 169. Text sender 220 can include circuitry and/or programming to send a stored text message to a calling telephone. Sender 220 can be electrically connected to (or connectable to) text storage 169 and to switching station 120. (GUI 210 can include voice-to-text software to convert a spoken message into text. Sender 220 can include the described prior text reviewer 259.)

For this example, delivery trigger 290 comprises deployed trigger 250 (deployed trigger 250 described prior). An exemplary deployed trigger 250 is shown as D. Trigger 250a in FIG. 13b. The exemplary deployed trigger 250a is located at telephone 27r. The exemplary deployed trigger 250a can employ GUI 210 (described prior) to respond to the user's instruction by dispatching a signal to initiate a sending of a text message at the time of the telephone call. Deployed trigger 250a can comprise a selected text icon 245. GUI 210 can include programming to receive and respond to instruction from the user via the user touching selected text icon 245 shown as ST 245 located on the touch-screen of GUI 210. GUI 210 can be electrically connected to (or connectable to) text sender 215. GUI 210 can respond to the user touching icon 245 by sending a signal to sender 215. Sender 215 can respond to the signal by sending a text message stored in a stand-alone text storage 251 to the calling phone.

Handling system 10r can comprise selector 215, storage 169 and sender 220 located at provider 121 with deployed trigger 250 located at telephone 27. Thus it can be appreciated that system 10r works in conjunction with a telephone 27r having deployed trigger 250 located thereon thus enabling the telephone user to employ trigger 250 to initiate the sending of a text message at the time of the telephone call.

A first example of operation of this second example of this twelfth embodiment will now be given (FIG. 13b). A user has employed text selector 215 (selector 215 located at a website operated by service provider 121, the user accessing the website via an online personal computer) to select a text message he found in a library on a website owned by service provider 121 and to load the text message into stand-alone text storage 251. The message reads “dogs do it when cats can't”.

Some time later, the user's telephone (telephone 27r) rings from a ring signal sent by switching station 120. Text sender 220 obtains and stores the caller I.D. information included with the ring signal of the incoming call at storage IN # 297 (supplanting prior stored caller I.D. information associated with the prior incoming call stored at IN # 297). Provided on the touch-screen of GUI 210 is selected text icon 245 of deployed trigger 250a. The user decides to touch icon 245. Touched icon 245 instructs GUI 210 to dispatch a signal to text sender 220. Sender 220 responds by sending the text message stored in stand-alone text storage 251. Sender 220 employs the stored caller I.D. information to designate that the text message be delivered to the telephone from where the incoming call originated. The user can then answer the call or not. (The text message “dogs do it when cats can't” arrives at the calling telephone. The text message can also be sent to and displayed on reviewer 259).

A second example of operation will now be given (FIG. 13b). Telephone 27r is internet enabled. A user has employed text selector 215 (selector 215 located at a website operated by service provider 121, the user accessing the website via phone 27r) to select a text message from a text storage in phone 27r and to load the text message into stand-alone text storage 251. The message reads “Buddies for life”. Selector 215 loads the message into stand-alone text storage 251.

Some time later, telephone 27r rings from a ring signal sent by switching station 120. Text sender 220 obtains and stores the caller I.D. information included with the ring signal of the incoming call at IN # 297 (supplanting prior stored caller I.D. information associated with the prior incoming call). Provided on the touch-screen of GUI 210 is selected text icon 245 of deployed trigger 250a. The user answers the call, and while chatting with the user decides he'd like to send the stored text message. The user touches icon 245. Touched icon 245 instructs GUI 210 to dispatch a signal to text sender 220. Sender 220 responds by sending the text message stored in stand-alone text storage 251. Sender 220 employs the caller I.D. information stored at IN # 297 to designate that the text message be delivered to the telephone from where the incoming call originated. Consequently the text message “Buddies for life” has been sent to the calling telephone while they chat. The caller can indicate that the text message has arrived. (Both caller and user can be enabled to read the text message simultaneously.)

A third example of operation will now be given (FIG. 13b). A user has employed text selector 215 (selector 215 located at a website operated by service provider 121) to select/load a text message from a website operated by the manufacturer of telephone 27r into stand-alone text storage 251. The text message reads “flowers have many pedals so why are you going so slow?”

Some time later, telephone 27r rings from a ring signal sent by switching station 120. Text sender 220 obtains and stores the caller I.D. information included with the ring signal of the incoming call at IN # 297 (supplanting prior stored caller I.D. information associated with the prior incoming call stored at IN # 297). Provided on the touch-screen of GUI 210 is selected text icon 245 of deployed trigger 250a. The user answers the call, chats with the caller and then hangs up. A few minutes later (prior to receiving a next incoming call), the user decides he'd like to send the just chatted with caller the text message. The user handles the phone and touches icon 245. Touched icon 245 instructs GUI 210 to dispatch a signal to text sender 220. Sender 220 responds by sending the text message stored in stand-alone text storage 251. Sender 220 employs the caller I.D. information stored at IN # 297 to designate that the text message be delivered to the telephone from where the incoming call originated. Consequently the text message “flowers have many pedals so why are you going so slow?” has been sent to the calling telephone.

A fourth example of operation will now be given (FIG. 13b). For this example, system 10r includes caller I.D. circuitry 20. A user has employed text selector 215 (selector 215 located at a website operated by service provider 121) to load into stand-alone text storage 251a text message he has written on the keyboard of the personal computer he is employing to access the website. The message reads “a parrot can only sing if her eyes are green!”

Some time later, the user's telephone (telephone 27r) rings from a ring signal sent by switching station 120 indicating an incoming call. Included with the ring signal is caller I.D. information. Circuitry 20 obtains and provides the information on the touch-screen of GUI 210 (GUI 210 serving as display 21). Text sender 220 also obtains the caller I.D. information and stores the information at IN # 297 (supplanting prior stored caller I.D. information associated with the prior incoming call). Also provided on the touch-screen of GUI 210 is selected text icon 245 of deployed trigger 250a. The user recognizes the caller I.D. information and, thus, is certain his girlfriend is calling. The user wants to share the text message he has loaded and, so, the user touches selected text icon 245. Touched icon 245 instructs GUI 210 to dispatch a signal to text sender 220. Sender 220 responds by sending the text message stored in stand-alone text storage 251. Sender 220 employs the caller I.D. information stored at IN # 297 to designate that the text message be delivered to the telephone from where the incoming call originated. Consequently the text message “a parrot can only sing if her eyes are green!” has been sent to his girlfriend's telephone. Subsequently, the user answers the call or the user declines to answer (or the girlfriend hangs up).

A fifth example of operation will now be given (FIG. 13b). Telephone 27r is internet enabled. A user has employed text selector 215 (selector 215 located at a website operated by service provider 121, the user accessing the website via phone 27r) to select a text message from a text storage in phone 27r and to load the text message into stand-alone text storage 251. The message reads “Who cares”. Selector 215 loads the message into stand-alone text storage 251.

Some time later, the user places a telephone call. Text sender 220 obtains and stores the dialed telephone number as OUT # 305 (supplanting a prior stored dialed telephone number stored in OUT # 305 associated with the prior outgoing call). Provided on the touch-screen of GUI 210 is selected text icon 245 of deployed trigger 250a. The called party answers the call, and while chatting, the user decides he'd like to send the stored text message. The user touches icon 245. Touched icon 245 instructs GUI 210 to dispatch a signal to text sender 220. Sender 220 responds by sending the text message stored in stand-alone text storage 251. Sender 220 employs the telephone number stored at OUT # 305 to designate that the text message be delivered to the called telephone. Consequently the text message “Who cares” has been sent to the called telephone while they chat.

This twelfth embodiment can include a text picker 260. Picker 260 functions to enable a user to pick a text message from a plurality of text message choices to pick from. An exemplary text picker 260 is depicted in FIG. 13c. The exemplary picker 260 includes GUI 210 (described prior). GUI 210 is electrically connected to (or connectable to) deployed trigger 250b and is electrically connected to (or connectable to) linked trigger 240d shown as L. trigger 240d. GUI 210 includes programming to receive and to respond to instruction from the user via the user touching an icon. Said icon can be located in an icon array 246 shown located on the touch-screen of GUI 210. Icon array 246 can include icons, “1” through “0” as shown. GUI 210 can respond to the user touching an icon by signaling deploy trigger 250b and/or by signaling linked trigger 240d. Trigger 250b can include circuitry and/or programming to receive signal input and to respond to said signal input by initiating the sending of a text message. Trigger 250b can respond to a signal from GUI 210 by instructing text sender 220 to send text stored in a pick storage 261 (described later) shown located in text storage 169. Linked trigger 240d includes circuitry and/or programming to receive signal input and to respond to said signal input by initiating the sending of a text message. Linked trigger 240d can respond to a signal from GUI 210 by waiting for a signal indicating an activity, for example, a signal tied a telephone operation (or other). As an example, trigger 240d can be awaiting a signal indicating a detected hang-up by a user (detected by, for example, the prior described interface 31, interface 31 being electrically connected to, or connectable to, trigger 240d). Upon receiving the signal indicating the detected user hang-up, trigger 240d can respond by instructing text sender 220 to send text stored in pick storage 261 (described later). (Picker 260 can be employ in conjunction with linked trigger 240d only, can be employed in conjunction with deployed trigger 250b only or can be employed in conjunction with both trigger 240d and trigger 250b. When employed in conjunction with both, picker 260 can be employed in conjunction with both during the same telephone call or in conjunction with one or the other during a telephone call depending, for example, on a user's instruction. GUI 210 can be programmed to enable a user to implement said instruction. Also, exemplary picker 260 can be employed by a user at any time during “at the time of the telephone call”.)

A third example of this twelfth embodiment is illustrated as call handling system 10s in FIG. 13c. System 10s includes text selector 215, text storage 169, text picker 260, delivery trigger 290 and text sender 220, all shown located at a telephone 27s. For this example, telephone 27s comprises mobile phone 165 (phone 165 described prior). System 10s can include telephone 27s and, thus, can include phone 165. For this third example, system 10s can include caller I.D. circuitry 20. For this example, circuitry 20 includes GUI 210. Circuitry 20 is shown employing GUI 210 to serve as display 21 to display caller I.D. information to the user (display 21, described prior, shown in FIG. 13c located on GUI 210). For this example, text selector 215 includes GUI 210. GUI 210 includes programming to facilitate the selection and storage of a text message. The user can employ GUI 210, via an internet enabled phone 165 for example, to select a text message from an internet site provided by service provider 121 or a from an internet site of a telephone manufacturer or from other. The user can employ GUI 210 to select a text message from a storage located on a PC, etc. (A selected text message can be pre-scripted and/or prescribed, or other.) Selector 215 can comprise employing GUI 210 whereby GUI 210 can include programming to provide the user with a keypad (or other data entry device) to enable the user to write a text message.

For this example, text storage 169 comprises pick storage 261, shown as T. Picks 1-9. Storage 169 provides for storing a plurality of text messages in storage 261 T. Picks: 1-9. The user can employ selector 215 to load said selected text (selected text can include user-written text) into pick storage 261. (Alternately, a plurality of text messages can be pre-loaded into, for example, phone 165 by, for example, a telephone manufacturer, or other. Text selector 215 can then operate by enabling the user to select text messages from the pre-loaded plurality, the selections to be stored, for example, in storage 161. Alternately, storage 261 T. Picks 1-9, or some other storage, can be pre-loaded with text messages and those messages can be represented by pre-set icons displayed on GUI 210. Also, text message selection can comprise any of the examples herein given of selector 215 or other.) GUI 210 can be electrically connected to (or connectable to) storage 169. Text sender 220 can include circuitry and/or programming to send a stored text message to a calling telephone. Sender 220 can be electrically connected to (or connectable to) text storage 169 and to switching station 120 (provider 121) via a wireless connection.

For this example, system 10s comprises text picker 260 (described prior). For this example, text picker 260 can be employed in conjunction with deployed trigger 250b. Thus, deployed trigger 250b is electrically connected to (or connectable to) picker 260 and to text sender 220. For this example, text picker 260 can be employed in conjunction with linked trigger 240d. Thus, linked trigger 240d is electrically connected to (or connectable to) picker 260 and to text sender 220. Text picker 260, via GUI 210, can enable the user to pick one of the text messages stored in pick storage 261 T. Picks 1-9. As an example, the user touches one of the icons “1” through “0” located on icon array 246. Each icon is associated with a text message stored in storage 261. In other words, touching the icon picks a text message from storage 261 T. Picks: 1-9. For example, touching icon “1” picks text message “1” stored in T. Picks: 1-9, touching icon “2” picks text message “2” stored in T. Picks: 1-9, etc. through text message “9”. (For picker 260 and also for all other herein described pickers employing GUI 210, touching icon “0” can provide access to a next group of icons, icons “01” through “09”, those icons then displayed on the screen of GUI 210, replacing the prior displayed icons “1” through “9”. For text picker 260, touching icon “01”, for example, would pick a text message “01” stored in a storage such as pick storage 261, etc. Touching icon “0” twice can provide access to a next group of icons, icons “001” through “009” and so forth.)

For this example, picker 260 can be configured such touching an icon on GUI 210 can send a signal from GUI 210 to deployed trigger 250b. Trigger 250b signals sender 220. Sender 220 responds by sending a text message associated with the icon pressed to the caller. For this example, picker 260 can be configured such that touching an icon on GUI 210 for a duration can send a signal from GUI 210 to linked trigger 240d. Trigger 240d waits for receipt of a signal from a linked-to activity and upon receiving dispatches a signal to sender 220. Sender 220 responds to the signal by sending a text message associated with the icon pressed to the caller. (For this example, system 10s can also comprise the prior described link selector 320 and, for this example, selector 320 can include circuitry and/or programming to time events. For this example, system 10s can include the prior described link enabler 315, text reviewer 259, interface 31, call detector 96 and calling number detector 291.)

(For this example, deployed trigger 250b is depicted comprising a diagrammatic block for illustrative convenience. In actuality, GUI 210 including icons “1” through “9” of icon array 246 (also of icons “01” through “09” etc.) comprise trigger 250b. The example above has a touched icon “1” through “9” affecting GUI 210 to signal trigger 250b. Trigger 250b in turn signals sender 220. Absent the illustrative convenience, GUI 210 can be directly connected to (or connectable to) sender 220. In that case, a touched icon “1” through “9” affects GUI 210 to directly signal sender 220. To be clear, for system 10s, a touched for duration icon “1” through “9” affects GUI 210 to signal linked trigger 240d.)

(Also, from the text message picks stored in pick storage 261, or from messages stored elsewhere, a message can be chosen randomly, or other, and sent to the caller, for example, said choosing and sending in a manner similar to that described prior for shuffler 117. Also, text selector 215 can enable the user to select groups of text messages, for example groups having a common subject or action or other. A group can include icons therein nested that, for example, automatically post on GUI 210 when the group is loaded into, for example, storage 261. In one variation, a group can be selected by subject, or other, wherein the user knows the subject but not the messages. Upon touching an icon, the associated text message is sent to the caller and to reviewer 259. Both caller and user can then share the experience of reading the message for the first time. GUI 210 can include voice-to-text software to convert a spoken message.)

A first example of operation of this third example of this twelfth embodiment will now be given (FIG. 13c). The user employs text selector 215 to select interesting text messages from a library of text messages stored by the manufacturer of telephone 27s in telephone 27s. The user employs text selector 215 to load a selected text message into each of text message “1” through text message “9” of storage 261 T. Picks 1-9.

Some time later, telephone 27s rings from a ring signal sent by switching station 120. Text sender 220 obtains and stores the caller I.D. information included with the ring signal of the incoming call (supplanting prior stored caller I.D. information associated with the prior incoming call). The user answers the call. Provided on the touch-screen of GUI 210 is icon array 246 of text picker 260. The user thinks this caller would enjoy the message he has loaded into text message “6” of pick storage 261, “birds fly high but dogs laugh louder”. The user touches icon “6”. Touched icon “6” instructs GUI 210 to dispatch a signal to text sender 220. Sender 220 responds by sending the text associated with icon “6” stored as text message “6” in storage 261 T. Picks 1-9. Sender 220 employs the stored caller I.D. information to designate that the text message be delivered to the telephone from where the incoming call originated. Consequently the text message, “birds fly high but dogs laugh louder” is sent to the caller.

A second example of operation of this third example of this twelfth embodiment will now be given (FIG. 13c). For this example, system 10s includes caller I.D. circuitry 20. The user's telephone 27s is wifi enabled. The user employs telephone 27s employs to visit a text message library located on the internet. From the library, the user employs text selector 215 to select interesting text messages and employs text selector 215 to load a selected text message into each of text message “1” through text message “9” of storage 261 T. Picks 1-9. The user remembers he has loaded into text message “1” of pick storage 261 the text “The sky may be gray but the sun shines warm”. The user decides to touch icon “1”. Touched icon “1” instructs GUI 210 to dispatch a signal to text sender 220. Sender 220 responds by sending the text associated with icon “1” stored as text message “1” in storage 261 T. Picks 1-9. Sender 220 employs the stored caller I.D. information to designate that the text message be delivered to the telephone from where the incoming call originated. Consequently the text message “The sky may be gray but the sun shines warm” is sent to his stepmother's telephone.

The user reluctantly answers the call. While chatting with Stepmom, the user decides to send her a linked message. The user touches icon “7” for a duration. (The user has prior loaded into text message “7” of pick storage 261 the text message “Don't call back”.) Touched for a duration icon “7” instructs GUI 210 to dispatch a signal to linked trigger 240d. Trigger 240d waits for a signal from interface 31. When the conversation has concluded, the user hangs up. The hang up is detected by interface 31. Interface 31 responds by signaling trigger 240d. Trigger 240d responds by signaling text sender 220. Sender 220 responds by sending the text associated with icon “7” stored as text message “7” in storage 261 T. Picks 1-9. Consequently the text message, “Don't call back” is sent to Stepmom's telephone.

This twelfth embodiment can be enhanced through inclusion of an instant text post 301. Instant text post 301 functions to post a text message sent from the other party of a telephone call in progress for viewing by a user. An exemplary instant text post 301, which can be used to enhance this twelfth embodiment is depicted in FIGS. 13a, 13b, 13c and 13d (shown as T. Post 301 located at GUI 210). For this exemplary instant text post 301, post 301 can firstly include circuitry and/or programming to recognize that a telephone call is in progress. A telephone call in progress can include a call being sent or received but not yet answered. A telephone call in progress can include an answered telephone call and not yet hung up by either of the user or the other party. As one example, post 301 can employ interface 31 to detect said call in progress.

Secondly, for this exemplary instant text post 301, post 301 can include circuitry and/or programming to obtaining the location/address of the other party's telephone. As one example, if the call originated as incoming, post 301 can attain caller I.D. information included with the ring signal of an incoming call to then store the caller's telephone number, and if the call originated as outgoing, post 301 can store the telephone number dialed by the user (at telephone 27).

Thirdly, for this exemplary instant text post 301, post 301 can include circuitry and/or programming to detect that a text message has been received, circuitry and/or programming to obtain the origination location/address of an incoming text message and circuitry and/or programming to post a text message to a display. As one example, present telephone text messaging includes the telephone number of the sending telephone of a text message. Post 301 can store the telephone number included with an incoming text message.

Finally, for this example, when post 301 detects that a text message has been received, post 301 checks for signal information from interface 31 indicating a call in progress. If a call is in progress, post 301 then compares the location/address of the other party's telephone with the location/address of the incoming text message. If the telephone address and the text address match, post 301 can then immediately post the incoming text message to the user's display (for this embodiment GUI 210). The user is enabled to read the text while conversing with the other party. They can discuss the text. While instant text post 301 is here disclosed as an enhancement to this twelfth embodiment, post 301 can be employed on any telephone or cell phone adapted to receive and display text messages. (Instant text post 301 can be enhanced with a text post enabler, said enabler can operate to enable and/or disable post 301. Said enabler can operate similarly to the prior described link enabler 315.)

This twelfth embodiment can be enhanced through inclusion of a still camera delivery 280. Still camera delivery 280 functions to enable a user-selected picture to be sent to one of a calling telephone or to a called telephone. An exemplary still camera delivery 280, which can be used to enhance this twelfth embodiment, is depicted in FIG. 13d. For this exemplary still camera delivery 280, delivery 280 includes a picture selector 292, a picture storage 281, delivery trigger 290 and a picture sender 282.

Picture selector 292 functions to enable a user to select a picture (and/or to select a second picture to replace a first picture) said selecting prior to the telephone call. An exemplary picture selector 292 is depicted in FIG. 13d. The exemplary selector 292 includes GUI 210. For this example, GUI 210 includes programming to facilitate the selection and storage of a picture (or of pictures). A user can be provided with a plurality of choices for pictures and the user's selection from those choices, via GUI 210, can be stored in picture storage 281 (described below). The user can employ GUI 210, via mobile phone 165, to select a picture or pictures from an internet site or from a file containing pictures located on a computer or from a file containing pictures located in phone 165 or from a file containing pictures in a camera or from other. The user can employ selector 292 to load the selected picture into picture storage 281. Employing selector 292 to select a picture can include taking a picture and loading the picture into, for example, storage 281. For this example, GUI 210 is electrically connected to (or connectable to) storage 281. (GUI 210 has been described prior employed in the operation of ring-back selector 180, duration selector 185, terminator selector 190, profile selector 200 and text selector 215. GUI 210 can be programmed similarly to function as picture selector 292.) (Picture selector 292 can be located at telephone 27, at service provider 121 or elsewhere, for example, selector 292 can be located at a computer, selected text stored, for example, at telephone 27 or at service provider 121, or at other.)

Picture storage 281 functions to store one or more pictures. An exemplary picture storage 281 is depicted in FIG. 13d, shown as Picture Storage 281. Storage 281 can include circuitry and/or programming to facilitate the storing of one or more pictures. The one or more pictures can comprise a picture selected employing picture selector 292. (Storage 281 can alternately be located at service provider 121, or other.) (Picture storage 281 can be located at telephone 27, at service provider 121 or elsewhere.)

Delivery trigger 290 (described prior) functions to initiate a sending. An exemplary delivery trigger 290 is depicted in FIG. 13d. The exemplary trigger 290 can include one or more of a linked trigger 240 and a deployed trigger 250. When employed with still picture delivery 280 to enhance this twelfth embodiment, delivery trigger 290 is depicted comprising linked trigger 240e. The exemplary trigger 240e includes circuitry and/or programming to link the sending of a picture to the sending of a text message. For this example, trigger 240e can be electrically connected to (or connectable to) picture sender 282 and to text sender 220. When text sender 220 sends a text message, sender 220 can respond by sending a signal to trigger 240e. Trigger 240e can respond by sending a signal to picture sender 282. Picture sender 282 can respond by sending a picture. (For this example, trigger 240e can be linked to (triggered by) any text delivery 300 related activity. (Trigger 240e can be located at telephone 27, at service provider 121 or elsewhere.)

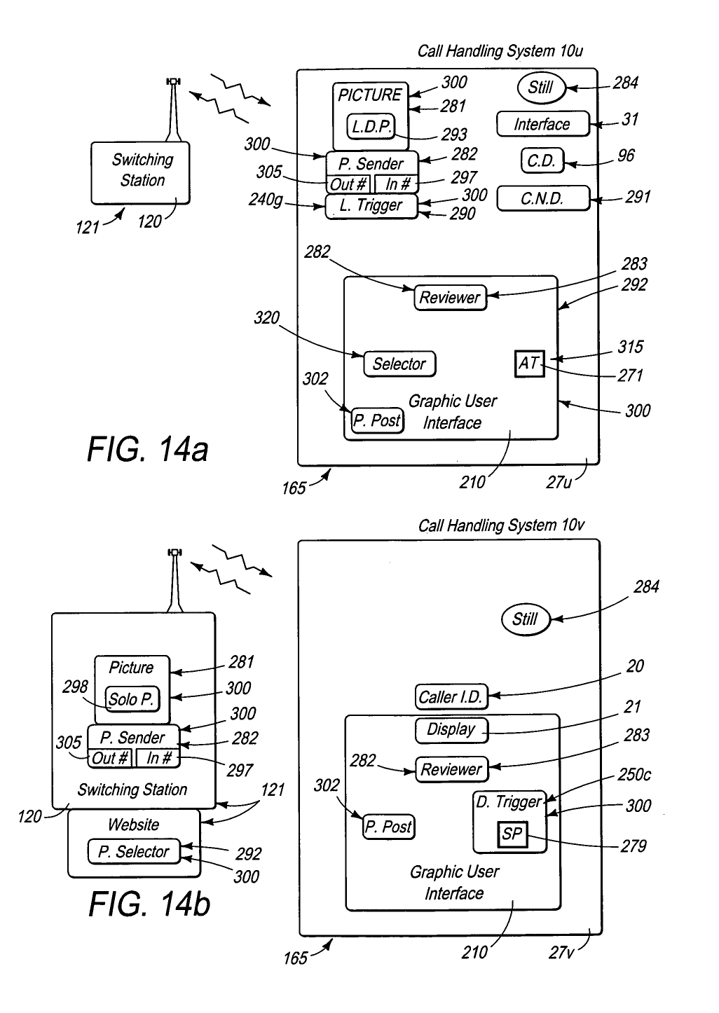

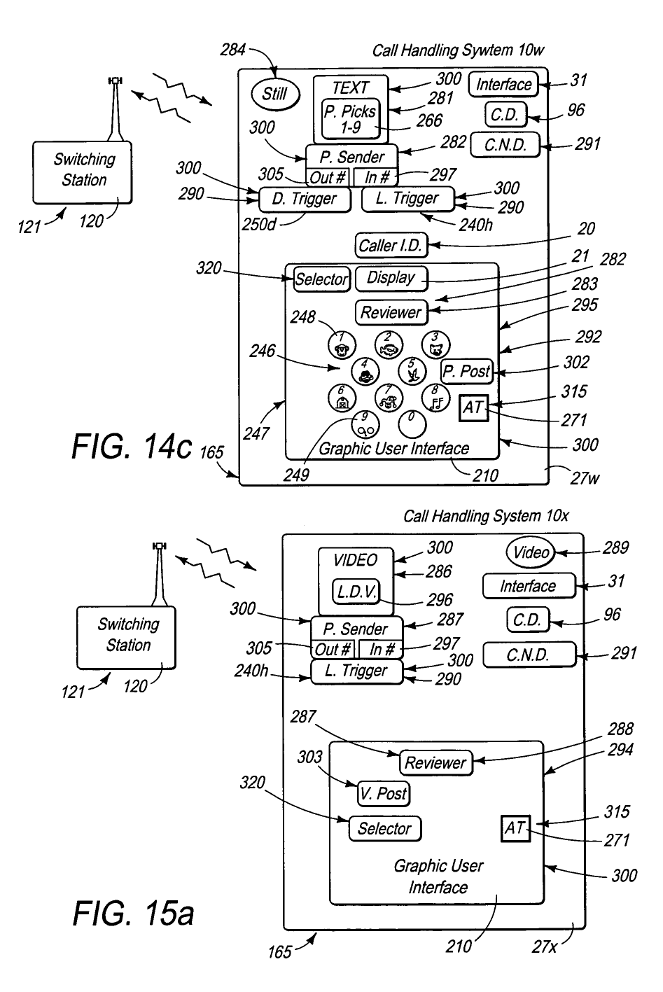

Picture sender 282 functions to send a picture to one of a calling telephone or to a called telephone. An exemplary picture sender 282 is depicted in FIG. 13d (shown as P. Sender 282 located at interface 31) and is depicted in FIGS. 14a through 14c (shown as P. Sender 282). Sender 282 can include circuitry and/or programming to send a stored picture to a calling telephone. Different ways can be envisioned to address a picture for delivery to the calling telephone. A serial number associated with the calling telephone can be included with the incoming ring signal. A picture can be sent to an address on file at provider 121 associated with that serial number. A picture sent by the user during an incoming call can be understood by provider 121 to be delivered to the calling telephone.

For this exemplary twelfth embodiment and for the exemplary thirteenth embodiment (FIGS. 14a through 14c), to send a picture to a calling telephone (i.e. incoming call to the user), as but one example, picture sender 282 can include circuitry and/or programming for obtaining the caller I.D. information included with the ring signal of an incoming call. Sender 282 can store the obtained caller I.D. information, for this example, at storage In Number 297, hereafter referred to and shown in FIGS. 14a through 13d as In # 297. Sender 282 can then employ the telephone number stored at IN # 297 to designate, to provider 121 for example, where the picture is to be delivered. Provider 121 can then deliver the picture to the designated telephone. (This arrangement differs from the current state of the art wherein a user must first open a menu, then enter the telephone number of the calling party and then instruct to send the picture.)

Picture sender 282 can include circuitry and/or programming to send a stored picture to a called telephone. Different ways can be envisioned to address a picture for delivery to a called telephone. As one example, a picture sent by the user during an outgoing call can be understood by provider 121 to be for delivery to the telephone number dialed by the user.

For this exemplary twelfth embodiment (and for the exemplary thirteenth embodiment), to send a picture to a called telephone (i.e. outgoing call from the user), as but one example, picture sender 282 can include circuitry and/or programming for obtaining the telephone number dialed by a user when placing a telephone call. Sender 282 can store the obtained called (dialed) telephone number, for this example, at storage Out Number 305, hereafter referred to and shown in FIG. 13d and FIGS. 14a through 14d as OUT # 305. Sender 282 can then employ the telephone number stored in OUT # 305 to designate, to provider 121 for example, where the picture is to be delivered. Provider 121 can then deliver the picture to said desired destination. (This arrangement differs from the current state of the art wherein a user must first open a menu, then enter the telephone number of the calling party and then instruct to send the picture.)

Herein has been stated “at the time of the telephone call”. (Once example of such statement, “Deployed trigger 250 functions to enable a user to initiate a sending at the time of the telephone call.”) The statement “at the time of the telephone call” designates the time period from receipt of an incoming ring signal (prior to the call being answered) until the time when the call ends (caller or user hang up). The statement “at the time of the telephone call” also designates the time period from when the user has finished dialing the number to place an outgoing call (prior to the call being answered) until the time when the call ends (caller or user hang up).

Sender 282 can continue to store the caller I.D. information stored at IN # 297 until the arrival of a next incoming call at which time sender 282 can then store at IN # 297 the caller I.D. information associated with said next incoming call and can delete the prior stored incoming call caller I.D. information. The statement “at the time of the telephone call” can also include the above suggested time period from when sender 282 stores the caller I.D. information until sender 282 deletes the information upon the arrival of a next incoming call.

For this exemplary picture sender 282, sender 282 is electrically connected to (or connectable to) picture storage 281 and to switching station 120 via a wireless connection. Also, sender 282 can include a picture reviewer 283 (shown as Reviewer 283 and shown located on GUI 210). Reviewer 283 functions to display to a user a picture that is to be sent and/or that has been sent to the caller. Displaying the picture can affirm the user's choice and/or can serve to share the experience of receiving the picture with the caller. (Picture sender 282 can be located at telephone 27, at service provider 121 or elsewhere.)

Still camera 284 functions to enable a user to take a still picture (image). An exemplary still camera 284 is depicted in FIG. 13d (shown as Still 284). Camera 284 can include circuitry and/or programming and/or hardware to enable a user to take a picture and to send the picture to be stored, for example, at picture storage 281. For this example, camera 284 is electrically connected to (or connectable to) picture storage 281. Camera 284 is preferably located at phone 165 (telephone 27). Locating camera 284 at phone 165 enables the user to take a picture via phone 165, the picture for delivery to a caller calling phone 165.

This twelfth embodiment can be enhanced through inclusion of a video delivery 285. Video delivery 285 functions to enable a user-selected video to be sent to one of a calling telephone or to a called telephone. An exemplary video delivery 285, which can be used to enhance this twelfth embodiment, is depicted in FIG. 13d. For this exemplary video delivery 285, delivery 285 includes a video selector 294, a video storage 286, delivery trigger 290 and a video sender 287.

Video selector 294 functions to enable a user to select a video (and/or to select a second video to replace a first video) said selecting prior the telephone call. An exemplary video selector 294 is depicted in FIG. 13d. The exemplary selector 294 includes GUI 210. For this example, GUI 210 includes programming to facilitate the selection and storage of a video (or of videos). A user can be provided with a plurality of choices for videos and the user's selection from those choices, via GUI 210, can be stored in video storage 286 (described below). The user can employ GUI 210, via mobile phone 165, to select videos from an internet site or from a file containing videos located on a computer or from a file containing videos located in phone 165 or from a video player or from a file containing videos in a video camera or from other. The user can employ selector 294 to load the selected video (or video clip) into video storage 286. Employing selector 294 to select a video can include taking a video and storing the video, for example, in video storage 286. For this example, GUI 210 is electrically connected to (or connectable to) storage 286. (GUI 210 has been described prior employed in the operation of ring-back selector 180, duration selector 185, terminator selector 190, profile selector 200 and text selector 215. GUI 210 can be programmed similarly to function as video selector 294. (Video selector 294 can be located at telephone 27, at service provider 121 or elsewhere, for example, selector 294 can be located at a computer, selected text stored, for example, at telephone 27 or at service provider 121, or at other.)

Video storage 286 functions to store one or more videos (including video clips). An exemplary video storage 286 is depicted in FIG. 13d, shown as Video Storage 286. Storage 286 can include circuitry and/or programming to facilitate the storing of the one or more videos. The one or more videos can comprise a video selected employing video selector 294. (Video storage 286 can be located at telephone 27, at service provider 121 or elsewhere.)

Delivery trigger 290 (described prior) functions to initiate a sending. An exemplary delivery trigger 290 is depicted in FIG. 13d. The exemplary trigger 290 can include one or more of a linked trigger 240 and a deployed trigger 250. When employed with video delivery 285 to enhance this twelfth embodiment, delivery trigger 290 is depicted comprising linked trigger 240f. The exemplary trigger 240f includes circuitry and/or programming to link the sending of a video to the sending of a text message. For this example, trigger 240f can be electrically connected to (or connectable to) video sender 287 and to text sender 220. When text sender 220 sends a text message, sender 220 can respond by sending a signal to trigger 240f. Trigger 240f can respond by sending a signal to video sender 287. Video sender 287 can respond by sending a video. (For this example, trigger 240f can be linked to (triggered by) any text delivery 300 related activity. Also, trigger 240f can be located at telephone 27, at service provider 121 or elsewhere.)

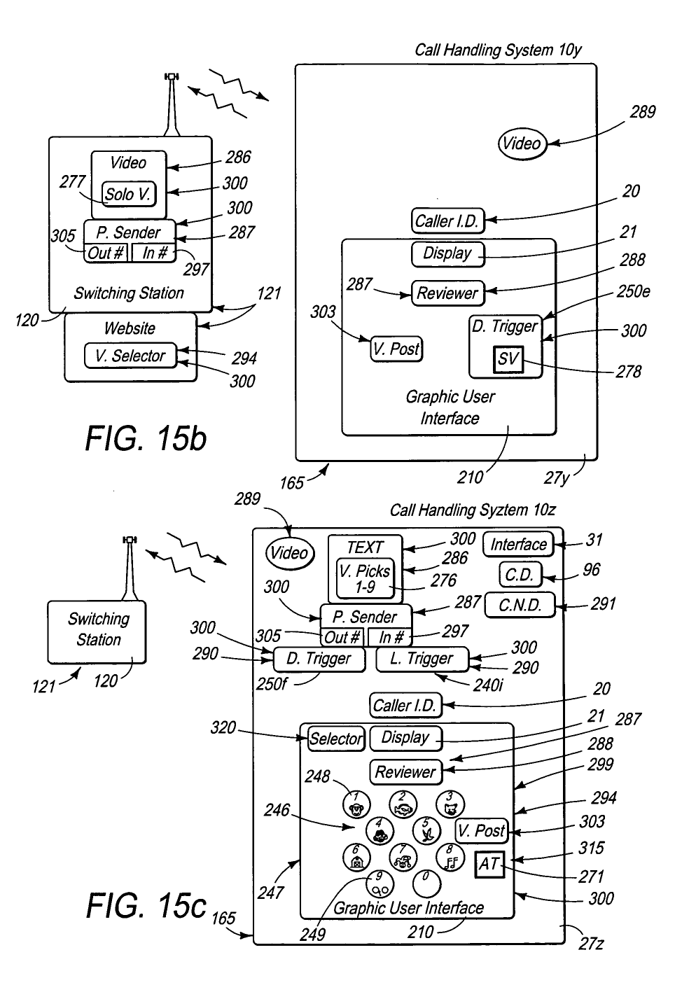

Video sender 287 functions to send a video (or video clip) to one of a calling telephone or to a called telephone. An exemplary video sender 287 is depicted in FIG. 13d and in FIGS. 15a through 15c (shown as V. Sender 287). Sender 287 can include circuitry and/or programming to send a stored video to a calling telephone. Different ways can be envisioned to address a video for delivery to the calling telephone. A serial number associated with the calling telephone can be included with the incoming ring signal. A video can be sent to an address on file at provider 121 associated with that serial number. A video sent by the user during an incoming call can be understood by provider 121 to be delivered to the calling telephone.

For this exemplary eleventh embodiment (and for the exemplary twelfth embodiment), to send a video to a calling telephone (i.e. incoming call to the user), as but one example, video sender 287 can include circuitry and/or programming for obtaining the caller I.D. information included with the ring signal of an incoming call. Sender 287 can store the obtained caller I.D. information, for this example, at storage In Number 297, hereafter referred to and shown in FIG. 12 and FIGS. 13a through 13d as In # 297. Sender 287 can then employ the telephone number stored at IN # 297 to designate, to provider 121 for example, where the video is to be delivered. Provider 121 can then deliver the video to the designated telephone.

Video sender 287 can include circuitry and/or programming to send a stored video to a called telephone. Different ways can be envisioned to address a video for delivery to a called telephone. As one example, a video sent by the user during an outgoing call can be understood by provider 121 to be for delivery to the telephone number dialed by the user.

For this exemplary twelfth embodiment (and for the exemplary fourteenth embodiment), to send a video to a called telephone (i.e. outgoing call from the user), as but one example, video sender 287 can include circuitry and/or programming for obtaining the telephone number dialed by a user when placing a telephone call. Sender 287 can store the obtained called (dialed) telephone number, for this example, at storage Out Number 305, hereafter referred to and shown in FIG. 13d and FIGS. 15a through 15c as OUT # 305. Sender 287 can then employ the telephone number stored in OUT # 305 to designate, to provider 121 for example, where the video is to be delivered. Provider 121 can then deliver the video to said desired destination.

Herein has been stated “at the time of the telephone call”. (Once example of such statement, “Deployed trigger 250 functions to enable a user to initiate a sending at the time of the telephone call.”) The statement “at the time of the telephone call” designates the time period from receipt of an incoming ring signal (prior to the call being answered) until the time when the call ends (caller or user hang up). The statement “at the time of the telephone call” also designates the time period from when the user has finished dialing the number to place an outgoing call (prior to the call being answered) until the time when the call ends (caller or user hang up).

Sender 287 can continue to store the caller I.D. information stored at IN # 297 until the arrival of a next incoming call at which time sender 287 can then store at IN # 297 the caller I.D. information associated with said next incoming call and can delete the prior stored incoming call caller I.D. information. The statement “at the time of the telephone call” can also include the above suggested time period from when sender 287 stores the caller I.D. information until sender 287 deletes the information upon the arrival of a next incoming call.

Video sender 287 can be electrically connected to (or connectable to) video storage 286 and to switching station 120 via a wireless connection. Also, sender 287 can include a video reviewer 288 (shown as Reviewer 288 and shown located on GUI 210). Reviewer 288 functions to display to a user a video that is to be sent and/or that has been sent to the caller. Displaying the video can affirm the user's choice and/or can serve to share the experience of receiving the video with the caller. Also, video sender 287 can be located at telephone 27, at service provider 121 or elsewhere.)

Delivery 285 can include a video camera 289. Video camera 289 functions to enable a user to take a video. An exemplary video camera 289 is depicted in FIG. 13d (shown as Video 289). Camera 289 can include circuitry and/or programming and/or hardware to enable a user to take a video and to send the video to be stored, for example, at video storage 286. For this example, camera 289 is electrically connected to (or connectable to) video storage 286. Video camera 289 is preferably located at phone 165 (telephone 27). Locating camera 289 at phone 165 enables the user to take a video via phone 165, the video for delivery to a caller calling phone 165.

A fourth example of this twelfth embodiment is illustrated as call handling system 10t in FIG. 13d. System 10t includes text selector 215. System 10t includes text delivery 300 and also includes picture delivery 280 and video delivery 285, all three deliveries shown located at telephone 27t. For this example, telephone 27t comprises mobile phone 165. For this example, picture delivery 280 comprises linked trigger 240e of delivery trigger 290. The exemplary trigger 240e can include circuitry and/or programming to link the sending of a picture to a sending of a text message. For this example, video delivery 285 comprises linked trigger 240f of delivery trigger 290. The exemplary trigger 240f can include circuitry and/or programming to link the sending of a video to a sending of a text message. System 10t can include telephone 27t and, thus, can include phone 165. System 10t can include caller I.D. circuitry 20, shown located at telephone 27t. (System 10t can also include one or more of: text reviewer 259, picture reviewer 283, video reviewer 288 linked trigger enabler 315 and link selector 320, all shown located at telephone 27t.)

For this example, text selector 215, picture selector 292 and video selector 294 can comprise any of the herein given examples of said selectors, or can comprise other examples. Caller I.D. circuitry 20 can enable the user to make a trigger decision based at least in part on caller I.D. information. Circuitry 20 can comprise any examples of circuitry 20 herein given or other. Text storage 169, picture storage 281, video storage 286, text sender 220, picture sender 282 and video sender 287, all shown located at telephone 27t, can comprise any of the herein given examples of said storage and senders or can comprise other examples.

As an example of operation, this example of this twelfth embodiment (system 10t) exemplifies the sending of a picture and/or a video linked to the sending of a text message. Accordingly, the sending of a picture and/or a video can be linked to any of the herein-described text sendings (or other text sendings). Said herein-described text sendings include sendings linked to (employing linked trigger 240) the sending of audio messages, the sending of audio content and to telephone operations. Said herein-described text sendings include user-deployed sendings (employing deployed trigger 250).

This twelfth embodiment can be enhanced through inclusion of icon selector 247. Icon selector 247 functions to enable a user to select an icon to represent something available for sending to the caller. An exemplary icon selector 247 is depicted in FIG. 13c. The exemplary selector 247 comprises GUI 210. GUI 210 includes programming to facilitate selection of icons for display. The user can employ GUI 210, via mobile phone 165 for example, to select an icon or icons from an internet site provided by service provider 121 or from an internet site of a telephone manufacturer or from other (or icons can be loaded into GUI 210 from a computer, or GUI 210 can be pre-loaded with icons by a telephone manufacturer for selection by the user, or other). Selector 247 can enable the selection of an icon or icons, an icon or icons nested with pre-scripted text, an icon or icons nested with prescribed text, an icon or icons nested with audio message and/or with audio content, an icon or icons nested with prescribed audio message and/or with prescribed audio content, or other. A selected icon can then be loaded into GUI 210 to then be presented, for example, on icon array 246, or to then be presented elsewhere.

ONE EXAMPLE of operation of icon selector 247 will now be given. For this example, icon selector 247 is employed with the third example of this twelfth embodiment (FIG. 13c). The user has selected a text message that reads “My monkey has a toothache” and has loaded the text message into text message “1” of storage 261 T. Picks: 1-9. The user then finds an icon of a monkey somewhere (or finds a monkey picture and generates an icon) and employs icon selector 247 to load the monkey icon into GUI 210 to comprise icon “1” of icon array 246. Some time later, the user can view icons “1” through “9”. Seeing that icon “1” is a monkey reminds the user that icon “1” represents the stored text “My monkey has a toothache”. Icon selector 247 can select subject icons 248 such as, for example, said monkey icon or can select action icons 249 such as, for example, the bell ringing shown in icon “9”, or other. Subject icons 248 can be the subjects of the associated text messages. Action icons 249 can represent the actions (verb) of the associated text messages. As an example of employing subject icons 248 (or action icons 249), all of the icons loaded into array 246 (employing selector 247) comprise the subject of the associated text messages stored in storage 169. Consequently, the user when viewing array 246, upon knowing that each icon comprises the subject in the associated text message, is assisted in remembering said associated text messages. (The icons can be numbered to assist the user in matching icon with text message number when selecting icons for array 246, or other.)

Icon selector 247 can likewise be employed to enhance the second and fourth examples of this twelfth embodiment. Selector 247 can also be employed to enhance any embodiments herein disclosed or other embodiments, for example, embodiments employing one or more of: call back message circuitry 30, message-then-hold circuitry 40, concert circuitry 50, call announce circuitry configured to attain who information 60, call announce circuitry configured to attain what/why information 70, call announce circuitry configured to attain who information and what/why information 80, camera delivery 280, video delivery 285 and message-then-record circuitry 310.

The twelfth embodiment can be enhanced, for example, by combining two or more of the given examples of the twelfth embodiment: system 10q, system 10r, system 10s and system 10t. As an example, system 10q can be combined with system 10r. As another example, systems 10q, 10s and 10t can be combined.

In summary, the examples of the twelfth embodiment (FIGS. 13a, 13c and 13d) preferably operate by enabling a user to select a text message prior to a telephone call, storing one or more text messages, initiating the sending of a stored text message at the time of the telephone call and sending the stored text message to one of a calling telephone or to a called telephone.

As can be seen from the foregoing, the present disclosure provides for a mobile phone for use with a text selector to enable a user to select a text message prior to a telephone call, for use with a text storage enabled to store a text message and for use with a text sender enabled to send a text message to one of a calling telephone or a called telephone. The mobile phone can include a trigger to initiate the text sender to send a text message stored in the text storage at the time of the telephone call. The mobile phone can further include a caller I.D. circuitry to provide caller I.D. information to the user such that the user can view the caller I.D. information and, in response to the information, the user can initiate the sending of a text message.

A thirteenth embodiment of telephone call handling system 10 is illustrated in FIGS. 14a, 14b and 14c. This embodiment includes still camera delivery 280 (described prior, which functions to enable a user-selected picture to be sent to one of a calling telephone or to a called telephone. An exemplary still camera delivery 280 is depicted in FIGS. 13a, 13b and 13c. The exemplary delivery 280 includes picture selector 292 (described prior, which functions to enable a user to select a picture), picture storage 281 (described prior, which functions to store one or more pictures), delivery trigger 290 (described prior, which functions to initiate a sending) and picture sender 282 (described prior, which functions to send a picture to one of a calling telephone or to a called telephone).

This thirteenth embodiment can further include caller I.D. circuitry 20 (described prior, which functions to provide caller I.D. information to a user) and still camera 284 (described prior, which functions to enable a user to take a still picture). This embodiment can be enhanced through inclusion of an instant picture post 302. This embodiment can be enhanced through inclusion of a picture picker 295. (This embodiment can further be enhanced through inclusion of one or more of the prior described icon selector 247, the prior described linked trigger enabler 315 and the prior described link selector 320. This thirteenth embodiment can be employed in combination with, or as an enhancement to, any of embodiments one through twelve, fourteen and fifteen herein described or other embodiments and examples.)

For this thirteenth embodiment, delivery trigger 290 is depicted comprising at least one of linked trigger 240 and deployed trigger 250. Linked trigger 240 (described prior) functions to link a sending to a caller to some other activity. The sending can comprise one or more of: an audio message, an entertainment/content, a text message, an image, a video or can comprise other. For this thirteenth embodiment, the sending can comprise an image.

Deployed trigger 250 (described prior) functions to enable a user to initiate a sending at the time of the telephone call. The sending can comprise one or more of: an audio message, an entertainment/content, a text message, an image, a video or the sending can comprise other. For this thirteenth embodiment, the sending can comprise an image. Trigger 250 can include circuitry and/or programming to respond to a user's instruction by dispatching a signal to initiate a sending of a picture.

A first example of this thirteenth embodiment is illustrated as call handling system 10u in FIG. 14a. System 10u includes: picture selector 292, picture storage 281, delivery trigger 290 and picture sender 282, all shown located at telephone 27u. This first example of this thirteenth embodiment can further include still camera 284, linked trigger enabler 315 and/or link selector 320. For this example, telephone 27u comprises mobile phone 165 (phone 165 described prior). System 10u can include telephone 27u and, thus, can include phone 165. (This first example also can include interface 31, call detector 96 and/or call number detector 291.)

For this example, picture selector 292 includes GUI 210. GUI 210 includes programming to facilitate the selection of a picture. Picture selection can comprise any of the examples herein given or other. (Also, picture selection can include selecting a previously selected picture stored, for example, in stand-alone picture 298 and/or in pick storage 266, both described later.) For this example, picture storage 281 comprises a linked-deliver picture storage 293 (shown as L.D.P. 293). Picture storage 281 provides for storing a picture in storage 293. The user can employ selector 292 to load a selected picture into linked-deliver picture storage 293. GUI 210 can be electrically connected to (or connectable to) storage 293. Picture sender 282 can include circuitry and/or programming to send a stored picture to a calling telephone. Sender 282 can be electrically connected to (or connectable to) storage 293 of picture storage 281 and to switching station 120 via a wireless connection. (System 10u can include the prior described picture reviewer 283.)

For this example, delivery trigger 290 comprises linked trigger 240 (trigger 240 described prior). An exemplary linked trigger 240 is shown as L. Trigger 240g in FIG. 14a. The exemplary trigger 240g includes circuitry and/or programming to receive signal input and to respond to said signal input by initiating the sending of a picture. Said signal input can be tied to some other activity (as described prior). Linked trigger 240g can function to link the sending of a picture to any/all herein-described activities. Said tied to some other activity can include tied to a telephone operation. Trigger 240g can be tied to one or more of interface 31, call detector 96 and calling number detector 291 (for example, tied as described in the first example of the twelfth embodiment.) A tied-to activity, for example, one or more of interface 31, detector 96 and detector 291 can be electrically connected to (or connectable to) trigger 240g. Trigger 240g is electrically connected to (or connectable to) picture sender 282. A tied-to activity can send a signal to trigger 240g. Trigger 240g can respond by instructing sender 282 to send a picture stored in linked-deliver picture storage 293 for receipt at the calling telephone.

A first example of operation of this first example of this thirteenth embodiment will now be given (FIG. 14a). For this example, linked trigger 240g has been preset by the telephone manufacturer electrically connected to interface 31 to receive signal input therefrom indicating a caller hang-up. The user employs picture selector 292 (in this case GUI 210) to select/load into linked-deliver picture storage 293 a picture stored on his personal computer (via a cable between phone 27u and the PC).

Some time later, the user's telephone (telephone 27u) rings from a ring signal sent by switching station 120 (provider 121). Picture sender 282 obtains and stores the caller I.D. information included with the ring signal of the incoming call at storage IN # 297 (supplanting prior caller I.D. information associated with the prior incoming call stored at IN # 297). The user answers the call. When the conversation has concluded, the caller hangs up. The hang up is detected by interface 31. Interface 31 responds by signaling trigger 240g. Trigger 240g responds by signaling picture sender 282. Sender 282 responds by sending the picture stored in linked-deliver picture storage 293 of storage 281. Sender 282 employs the caller I.D. information stored at IN # 297 to designate (for example, to service provider 121) that the picture be delivered to the telephone from where the incoming call originated.

A second example of operation will now be given (FIG. 14a). For this example, linked trigger 240g has been preset by the telephone manufacturer electrically connected to interface 31 to receive signal input therefrom indicating a caller hang-up. Also preset is a 20-second time delay. The time delay affects to delay the sending of a signal to trigger 240g until 20 seconds after the caller hang up has been detected. For this example, system 10u includes still camera 284. The user employs camera 284 to take a picture of a swan. System 10u is configured such that the picture upon being taken acts as selector 292 to loaded the picture into picture storage 293.

Some time later, the user's telephone (telephone 27u) rings from a ring signal sent by switching station 120. Picture sender 282 obtains and stores the caller I.D. information included with the ring signal of the incoming call at IN # 297 (supplanting the prior stored caller I.D. information at IN # 297). The user answers the call. When the conversation has concluded, the caller hangs up. The hang up is detected by interface 31. Interface 31 responds by implementing the 20-second delay and then by signaling trigger 240g. Trigger 240g responds by signaling picture sender 282. Sender 282 responds by sending the picture stored in picture storage 293 of storage 281. Sender 282 employs the caller I.D. information stored at IN # 297 to designate (for example, to service provider 120) that the picture be delivered to the telephone from where the incoming call originated. (Sender 282 includes programming to accommodate a next incoming call being received prior to completion of the 20-second delay. The programming provides for sender 282 sending the picture as scheduled after the delay has elapsed to the designated telephone while providing to supplant the prior stored caller I.D. information with the I.D. information of the next incoming call.)

A third example of operation will now be given (FIG. 14a). For this example, linked trigger 240g has been preset by the telephone manufacturer electrically connected to U.I. 99 of starter 92 (described prior) to receive signal input from U.I. 99 indicating that the user has pressed hold button 81 (FIG. 2a). For this example, system 10u includes link enabler 315, enabler 315 comprising auto-trigger icon 271. The user has just turned on his phone. Displayed on the screen of GUI 210 is auto-trigger icon 271. The user touches icon 271. GUI 210 responds by enabling trigger 240g. The user employs picture selector 292 (in this case GUI 210) to select and load a picture stored in picture picks storage 266 (FIG. 14c) into picture storage 293.

Some time later, telephone 27u rings from a ring signal sent by switching station 120. Picture sender 282 obtains and stores the caller I.D. information included with the ring signal of the incoming call at IN # 297 (supplanting the prior stored caller I.D. information at IN # 297). The user answers the call. Shortly thereafter, the user needs to attend to a situation and, so, presses hold button 81. Pressing button 81 instructs message-then-hold circuitry 40 to send a hold message to the caller and to place the caller on hold. Pressing button 81 also sends a signal to trigger 240g. Trigger 240g responds by signaling picture sender 282. Sender 282 responds by sending the picture stored in picture storage 293 of storage 281. Sender 282 employs the caller I.D. information stored at IN # 297 to designate that the picture be delivered to the telephone from where the incoming call originated.

A fourth example of operation will now be given (FIG. 14a). For this example, system 10u includes link selector 320. The user employs link selector 320 (via GUI 210) to select an activity to link the sending of a picture to. The user selects “detection of an incoming call” (from a plurality of activity choices). The user then employs picture selector 292 (in this case GUI 210) to select/load a picture stored on the memory card of his digital camera into linked-deliver picture storage 293.

Some time later, telephone 27u rings from a ring signal sent by switching station 120 (provider 121). Picture sender 282 obtains and stores the caller I.D. information included with the ring signal of the incoming call at In # 297 (supplanting prior stored caller I.D. information associated with the prior incoming call). Incoming call detector 96 detects the incoming call and responds by signaling linked trigger 240g. Trigger 240g responds by signaling picture sender 282. Sender 282 responds by sending the picture stored in picture storage 293 of storage 281. Sender 282 employs the caller I.D. information stored at IN # 297 to designate (for example, to service provider 120) that the picture be delivered to the telephone from where the incoming call originated.

A fifth example of operation will now be given (FIG. 14a). For this example, linked trigger 240g has been preset by the telephone manufacturer electrically connected to calling number detector 291. For this example, system 10u includes mobile phone 165 providing that detector 291 can be located phone 165 so the user does not require internet access hardware to input the calling phone number. (Including phone 165 also provides that enabler 315 and/or selector 320 can be located at phone 165, again, eliminating the need for hardware.) The user then employs GUI 210 (selector 292) to select and load a picture into storage 293.

Later, the user's telephone (telephone 27u) rings. Calling number detector 291 detects that the calling phone has been designated by the user. Detector 291 signals linked trigger 240c. Trigger 240c signals picture sender 282. Sender 282 responds by sending the picture stored in picture storage 293 of storage 281. Sender 282 employs the stored caller I.D. information to designate that the picture be delivered to the originating telephone number stored at IN # 297.

A sixth example of operation of this first example of this thirteenth embodiment will now be given (FIG. 14a). For this example, linked trigger 240g has been preset by the telephone manufacturer electrically connected to interface 31 to receive signal input therefrom indicating a called party hang-up. The user employs picture selector 292 (in this case GUI 210) to select/load into linked-deliver picture storage 293 a picture stored on his personal computer (via a cable between phone 27u and the PC).

Some time later, the user's places a call. Picture sender 282 obtains and stores the dialed telephone number at storage OUT # 305 (supplanting a prior stored number associated with the prior outgoing call stored at OUT # 305). The called party answers the call. When the conversation has concluded, the called party hangs up. The hang up is detected by interface 31. Interface 31 responds by signaling trigger 240g. Trigger 240g responds by signaling picture sender 282. Sender 282 responds by sending the picture stored in linked-deliver picture storage 293 of storage 281. Sender 282 employs the telephone number stored at OUT # 305 to designate (for example, to service provider 121) that the picture be delivered to the telephone from where the incoming call originated.

A second example of this thirteenth embodiment is illustrated as call handling system 10v in FIG. 14b. System 10v includes picture selector 292, picture storage 281, delivery trigger 290 and picture sender 282. For this example, telephone 27v comprises mobile phone 165 (phone 165 described prior). System 10v can include telephone 27v and, thus, can include phone 165. For this example, picture selector 292, picture storage 281, and picture sender 282 are shown located at service provider 21 (selector 292 shown as P. Selector 292). For this example, delivery trigger 290 comprises deployed trigger 250, trigger 250 shown located at telephone 27v.

For this second example, system 10v can also include caller I.D. circuitry 20 also shown located at telephone 27v. Circuitry 20 is shown employing GUI 210 to serve as display 21 to display caller I.D. information to the user (display 21, described prior, shown in FIG. 14b located on GUI 210). For this example, picture selector 292 can be located at a website of service provider 121, said website programmed to facilitate and/or enable the selection of a picture. (Picture selection can comprise any of the examples herein given of selector 292 or other. Also, the user can employ selector 292 to select a previously selected picture stored, for example, in the prior described linked-deliver picture storage 293 and/or in the to-be-described pick storage 266 described later.) For this example, picture storage 281 comprises a stand-alone picture storage 298 (shown as Solo P. 298). Picture storage 281 provides for storing a picture in storage 298. The user can employ selector 292 to load a selected picture into stand-alone picture storage 298. The website of service provider 121 can be electrically connected to (or connectable to) storage 281. Picture sender 282 can include circuitry and/or programming to send a stored picture to a calling telephone. Sender 282 can be electrically connected to (or connectable to) picture storage 281 and to switching station 120. (System 10v can include the prior described picture reviewer 283 and can include the prior described still camera 284.)

For this example, delivery trigger 290 comprises deployed trigger 250 (deployed trigger 250 described prior). An exemplary deployed trigger 250 is shown as D. Trigger 250c in FIG. 14b. The exemplary deployed trigger 250c is located at telephone 27v. The exemplary deployed trigger 250c can employ GUI 210 (described prior) to respond to the user's instruction by dispatching a signal to initiate a sending of a picture. Deployed trigger 250c can comprise a selected picture icon 279. GUI 210 can include programming to receive and respond to instruction from the user via the user touching selected picture icon 279 shown as SP 279 located on the touch-screen of GUI 210. GUI 210 can be electrically connected to (or connectable to) picture sender 282. GUI 210 can respond to the user touching icon 279 by sending a signal to sender 282. Sender 282 can respond to the signal by sending a picture stored in a stand-alone picture storage 298 to the calling phone.

Handling system 10v can comprise selector 292, storage 281 and sender 282 located at provider 121 with deployed trigger 250 located at telephone 27. Thus it can be appreciated that system 10v works in conjunction with a telephone 27v having deployed trigger 250 located thereon thus enabling the telephone user to employ trigger 250 to initiate the sending of a picture at the time of the telephone call.

A first example of operation of this second example of this thirteenth embodiment will now be given (FIG. 14b). A user has employed picture selector 292 (selector 292 located at a website operated by service provider 121, the user accessing the website via an on-line personal computer) to select a picture of a panda baby the user saw on the internet and to load the picture into stand-alone picture storage 298.

Some time later, the user's telephone (telephone 27v) rings from a ring signal sent by switching station 120. Picture sender 282 obtains and stores the caller I.D. information included with the ring signal of the incoming call at storage IN # 297 (supplanting prior stored caller I.D. information associated with the prior incoming call stored at IN # 297). Provided on the touch-screen of GUI 210 is selected picture icon 279 of deployed trigger 250c. The user is busy so he decides to touch icon 279 and leave the call unanswered. Touched icon 279 instructs GUI 210 to dispatch a signal to picture sender 282. Sender 282 responds by sending the picture stored in stand-alone picture storage 298. Sender 282 employs the caller I.D. information stored at IN # 297 to designate that the picture (panda baby) be delivered to the telephone from where the incoming call originated. (The picture can also be sent to and displayed on reviewer 283).

A second example of operation will now be given (FIG. 14b). A user has employed picture selector 292 (selector 292 located a website operated by service provider 121) to select a picture of a gorilla from a picture file located in a picture storage located in the user's personal computer being employed to access the internet and to load the picture into stand-alone picture storage 298.

Some time later, telephone 27v rings from a ring signal sent by switching station 120. Picture sender 282 obtains and stores the caller I.D. information included with the ring signal of the incoming call at IN # 297 (supplanting prior stored caller I.D. information at IN # 297 associated with the prior incoming call). Provided on the touch-screen of GUI 210 is selected picture icon 279 of deployed trigger 250c. The user is feeling friendly so he decides to touch icon 279 and then to answer the call. Touched icon 279 instructs GUI 210 to dispatch a signal to picture sender 282. Sender 282 responds by sending the picture stored in stand-alone picture storage 298. Sender 282 employs the stored caller I.D. information to designate that the picture (gorilla) be delivered to the telephone from where the incoming call originated. The user begins a conversation with the caller and the gorilla picture arrives at the calling phone. They can then talk about the gorilla.

A third example of operation will now be given (FIG. 14b). Phone 27v is internet enabled. A user has employed picture selector 292 (selector 292 located at a website operated by service provider 121 and accessed by the user via phone 27v) to select/load a picture of a wedding from a picture storage in phone 27v into stand-alone picture storage 298.

Some time later, telephone 27v rings from a ring signal sent by switching station 120. Picture sender 282 obtains and stores the caller I.D. information included with the ring signal of the incoming call at IN # 297 (supplanting prior stored caller I.D. information associated with the prior incoming call at IN # 297). Provided on the touch-screen of GUI 210 is selected picture icon 279 of deployed trigger 250c. The user answers the call, and while chatting with the caller decides he'd like to send the wedding picture. The user touches icon 279. Touched icon 279 instructs GUI 210 to dispatch a signal to picture sender 282. Sender 282 responds by sending the picture stored in stand-alone picture storage 298. Sender 282 employs the caller I.D. information stored at IN # 297 to designate that the picture be delivered to the telephone from where the incoming call originated. Consequently the wedding picture has been sent to and received at the calling telephone while they chat. Then they can chat about the picture.

A fourth example of operation will now be given (FIG. 14b). A user has employed picture selector 292 (selector 292 located at a website operated by service provider 121) to select a picture of a boat crash from a boat racing website and to load the picture into stand-alone picture storage 298.

Some time later, telephone 27v rings from a ring signal sent by switching station 120. Picture sender 282 obtains and stores the caller I.D. information included with the ring signal of the incoming call at IN # 297 (supplanting prior stored caller I.D. information associated with the prior incoming call). Provided on the touch-screen of GUI 210 is selected picture icon 279 of deployed trigger 250c. The user answers the call, chats with the caller and then hangs up. A few minutes later (prior to receiving a next incoming call), the user decides he'd like to send the just chatted with caller the boat crash picture. The user finds the phone and touches icon 279. Touched icon 279 instructs GUI 210 to dispatch a signal to picture sender 282. Sender 282 responds by sending the picture stored in stand-alone picture storage 298 to the telephone number stored at IN # 297. Consequently the boat crash picture has been sent to the calling telephone (and can be sent to display on reviewer 283). The user begins a conversation with the caller and the boat crash picture arrives at the calling phone.

A fifth example of operation will now be given (FIG. 14b). For this example, system 10v includes caller I.D. circuitry 20. A user has employed picture selector 292 (selector 292 located at a website operated by service provider 121) to select/load a beach baby picture from a picture file on the hard drive of the PC they are employing into stand-alone picture storage 298.

Some time later, the user's telephone (telephone 27v) rings from a ring signal sent by switching station 120 indicating an incoming call. Picture sender 282 obtains and stores the caller I.D. information included with the ring signal of the incoming call at IN # 297 (supplanting prior stored caller I.D. information associated with the prior incoming call at IN # 297). Circuitry 20 provides the caller I.D. information on the touch-screen of GUI 210 (GUI 210 serving as display 21). Also provided on the touch-screen of GUI 210 is selected picture icon 279 of deployed trigger 250c. The user recognizes the caller I.D. information and, thus, is certain his girlfriend is calling. The user wants to share the beach picture he has loaded and, so, the user touches selected picture icon 279. Touched icon 279 instructs GUI 210 to dispatch a signal to picture sender 282. Sender 282 responds by sending the picture stored in stand-alone picture storage 298. Sender 282 employs the stored caller I.D. information to designate that the picture (beach baby) be delivered to the telephone from where the incoming call originated (IN # 297). Consequently the beach picture has been sent to his girlfriend's telephone. Subsequently, the user answers the call or the user declines to answer (or the girlfriend hangs up).

A sixth example of operation will now be given (FIG. 14b). For this example, system 10v includes caller I.D. circuitry 20. A user has employed picture selector 292 (selector 292 located at a website operated by service provider 121) to select/load a baby picture from a picture file on the hard drive of the PC they are employing into stand-alone picture storage 298.

Some time later, the user places a telephone call. Picture sender 282 obtains the dialed number and stores the number in storage OUT # 305 (supplanting prior stored dialed number from the prior outgoing call). Circuitry 20 provides the caller I.D. information on the touch-screen of GUI 210 (GUI 210 serving as display 21). Also provided on the touch-screen of GUI 210 is selected picture icon 279 of deployed trigger 250c. The user recognizes the caller I.D. information and, thus, is certain his girlfriend is calling. The user wants to share the baby picture he has loaded and, so, the user touches selected picture icon 279. Touched icon 279 instructs GUI 210 to dispatch a signal to picture sender 282. Sender 282 responds by sending the picture stored in stand-alone picture storage 298. Sender 282 employs the stored dialed telephone number from OUT # 305 to designate that the picture (baby) be delivered to the dialed telephone. Consequently the baby picture has been sent to his girlfriend's telephone. Subsequently, the user answers the call or the user declines to answer (or the girlfriend hangs up).

This thirteenth embodiment can include a picture picker 295. Picker 295 functions to enable a user to pick a picture from a plurality of picture choices to pick from. An exemplary picture picker 295 is depicted in FIG. 14c. The exemplary picker 295 includes GUI 210 (described prior). GUI 210 is electrically connected to (or connectable to) deployed trigger 250d (trigger 250 described prior) and is electrically connected to (or connectable to) linked trigger 240h shown as L. Trigger 240h (trigger 240 described prior). GUI 210 includes programming to receive and to respond to instruction from the user via the user touching an icon. Said icon can be located in an icon array 246 shown located on the touch-screen of GUI 210. Icon array 246 can include icons, “1” through “0” as shown. GUI 210 can respond to the user touching an icon by signaling deployed trigger 250d and/or by signaling linked trigger 240h. Trigger 250d can include circuitry and/or programming to receive signal input and to respond to said signal input by initiating the sending of a picture. Trigger 250d can respond to a signal from GUI 210 by instructing picture sender 282 to send a picture (or pictures) stored in a pick storage 266 (storage 266 described later) shown located in picture storage 281. Linked trigger 240h includes circuitry and/or programming to receive signal input and to respond to said signal input by initiating the sending of a picture (or pictures). Linked trigger 240h can respond to a signal from GUI 210 by waiting for a signal indicating an activity. As an example, trigger 240h can be awaiting a signal indicating a detected hang-up by a user (detected by, for example, the prior described interface 31, interface 31 being electrically connected to, or connectable to, trigger 240h). Upon receiving the signal indicating the hang-up, trigger 240h can respond by instructing picture sender 282 to send a picture stored in pick storage 266 (described later). (Picker 295 can be employ in conjunction with linked trigger 240h only, can be employed in conjunction with deployed trigger 250d only or can be employed in conjunction with both trigger 240h and trigger 250d. When employed in conjunction with both, picker 260 can be employed in conjunction with both during the same telephone call or with one or the other during telephone call depending, for example, on a user's instruction. GUI 210 can be programmed to enable a user to implement said instruction. Also, any icon herein suggested for user-initiating the sending of a picture can be configured to display the picture as the icon. Also, exemplary picker 295 can be employed by a user at any time during “at the time of the telephone call”.)

A third example of this thirteenth embodiment is illustrated as call handling system 10w in FIG. 14c. System 10w includes picture selector 292, picture storage 281, picture picker 295, delivery trigger 290 and picture sender 282, all shown located at a telephone 27w. For this example, telephone 27w comprises mobile phone 165 (phone 165 described prior). System 10w can include telephone 27w and, thus, can include phone 165.

For this example, system 10w can include caller I.D. circuitry 20. For this example, circuitry 20 includes GUI 210. Circuitry 20 is shown employing GUI 210 to serve as display 21 to display caller I.D. information to the user (display 21, described prior, shown in FIG. 14c located on GUI 210). For this example, picture selector 292 includes GUI 210. GUI 210 includes programming to facilitate the selection and storage of a picture.

For this example, picture storage 281 comprises pick storage 266, shown as P. Picks 1-9. Storage 281 provides for storing a plurality of pictures in storage 266 P. Picks: 1-9. The user can employ selector 292 to load said plurality of pictures into pick storage 266. (Alternately, a plurality of pictures can be pre-loaded into, for example, phone 165 by, for example, a telephone manufacturer, or other. Picture selector 292 can then operate by enabling the user to select pictures from the pre-loaded plurality to be stored, for example, in storage 266. Alternately, storage 266 P. Picks: 1-9, or some other storage, can be pre-loaded with pictures and those pictures can be represented by pre-set icons displayed on GUI 210. Also, picture selection can comprise any of the examples herein given of selector 292 or other.) GUI 210 can be electrically connected to (or connectable to) storage 266. Picture sender 282 can include circuitry and/or programming to send a stored picture to a calling telephone. Sender 282 can be electrically connected to (or connectable to) storage 281 and to switching station 120 (provider 121) via a wireless connection.

For this example, system 10w comprises picture picker 295 (described prior). For this example, picture picker 295 can be employed in conjunction with deployed trigger 250d. Thus, deployed trigger 250d is electrically connected to (or connectable to) picker 295 and to picture sender 282. For this example, picker 295 can be employed in conjunction with linked trigger 240h. Thus, linked trigger 240h is electrically connected to (or connectable to) picker 295 and to picture sender 282. Picture picker 295, via GUI 210, can enable the user to pick one of the pictures stored in storage 266 P. Picks: 1-9. As an example, the user touches one of the icons “1” through “0” located on icon array 246. Each icon is associated with a picture stored in storage 266. In other words, touching the icon picks a picture from storage 266 P. Picks 1-9. For example, touching icon “1” picks picture “1” stored in storage 266 P. Picks 1-9, touching icon “2” picks picture “2” stored in storage 266 P. Picks 1-9, etc. through picture “9”.

For this example, picker 295 can be configured such that touching an icon on GUI 210 sends a signal from GUI 210 to deployed trigger 250d. Trigger 250d signals sender 282. Sender 282 responds by sending a picture associated with the icon pressed to the caller. For this example, picker 295 can be configured such that touching an icon on GUI 210 for a duration (for example two seconds) sends a signal from GUI 210 to linked trigger 240h. Trigger 240h waits for receipt of a signal from a linked-to activity and upon receiving that signal signals sender 282. Sender 282 responds to the signal by sending a picture associated with the icon pressed to the caller. (For this example, system 10w can comprise linked trigger enabler 315 providing that a user can enable and disable linked trigger 240h. For this example, system 10w can comprise the prior described link selector 320 and, for this example, selector 320 can include circuitry and/or programming to time events. System 10w can include the prior described picture reviewer 283 and can include the prior described still camera 284.)

(For this example, deployed trigger 250d is depicted comprising a diagrammatic block for illustrative convenience. In actuality, GUI 210 including icons “1” through “9” of icon array 246 (also of icons “01” through “09” etc.) comprise trigger 250d. The example above has a touched icon “1” through “9” affecting GUI 210 to signal trigger 250d. Trigger 250d in turn signals sender 282. Absent the illustrative convenience, GUI 210 can be directly connected to (or connectable to) sender 282. In that case, a touched icon “1” through “9” affects GUI 210 to directly signal sender 282. To be clear, for system 10w, a touched for duration icon “1” through “9” affects GUI 210 to signal linked trigger 240h.)

(Also, from the picture picks stored in storage 266, or from pictures stored elsewhere, a picture can be chosen randomly, or other, in a manner similar to that described prior for shuffler 117. Further, picture selector 292 can enable the user to select groups of picture, for example groups having a common subject or action or other. A group can include icons therein nested that, for example, automatically post on GUI 210 when the group is loaded into, for example, storage 266. In one variation, a group can be selected by subject, or other, wherein the user knows the subject but not the individual picture. Upon touching an icon, the associated picture can be sent to the caller and to reviewer 283.)

A first example of operation of this third example of this thirteenth embodiment will now be given (FIG. 14c). The user employs picture selector 292 to select interesting pictures from a library of picture stored by the manufacturer of telephone 27w in telephone 27w. The user employs picture selector 292 to load a selected pictures into each of picture “1” through picture “9” of storage 266 P. Picks 1-9.

Some time later, telephone 27w rings from a ring signal sent by switching station 120. Picture sender 282 obtains and stores the caller I.D. information included with the ring signal of the incoming call stored at IN # 297 (supplanting prior stored caller I.D. information associated with the prior incoming call stored at IN # 297). The user answers the call. Provided on the touch-screen of GUI 210 is icon array 246 of picture picker 295. The user thinks this caller would enjoy the picture he has loaded into picture “6” of pick storage 266. The user touches icon “6”. Touched icon “6” instructs GUI 210 to dispatch a signal to picture sender 282. Sender 282 responds by sending the picture associated with icon “6” stored as picture “6” in storage 266 P. Picks 1-9. Sender 282 employs the caller I.D. information stored at IN # 297 to designate that the picture be delivered to the telephone from where the incoming call originated. Consequently the picture is sent to the caller.

A second example of operation of this third example of this thirteenth embodiment will now be given (FIG. 14c). For this example, system 10w includes caller I.D. circuitry 20. The user's telephone (telephone 27w) is internet enabled. The user employs telephone 27w (via service provider 121) to visit a picture gallery located on the internet. From the gallery, the user employs picture selector 292 to select/load interesting pictures into each of picture “1” through picture “9” of storage 266 P. Picks 1-9.

Some time later, the user's telephone (telephone 27w) rings from a ring signal sent by switching station 120. Included with the ring signal is caller I.D. information. Circuitry 20 obtains and provides the information on the touch-screen of GUI 210 (GUI 210 serving as display 21). Picture sender 282 also obtains the caller I.D. information and stores the information at IN # 297 (supplanting prior stored caller I.D. information associated with the prior incoming call at IN # 297). Also provided on the touch-screen of GUI 210 is icon array 246 of picture picker 295. The user is mostly certain from the information that it's Uncle Barney calling and knows that Barney loves rainbows. The user remembers he has loaded into picture “2” of pick storage 266 a rainbow picture. The user decides to touch icon “2”. Touched icon “2” instructs GUI 210 to dispatch a signal to picture sender 282. Sender 282 responds by sending the picture associated with icon “2” stored as picture “2” in storage 266 P. Picks 1-9. Sender 282 employs the caller I.D. information stored at IN # 297 to designate that the picture be delivered to the telephone from where the incoming call originated. Consequently the rainbow picture is sent to Uncle Barney's telephone (can also be displayed on GUI 210 by reviewer 283). Subsequently, the user answers the call or not or Barney hangs up.)

The user decides to answer the call. While chatting with Barney, the user decides to send him another picture. The user touches icon “4”. (The user has prior loaded into picture “4” of pick storage 266 a picture of a bulldog.) Touched icon “4” instructs GUI 210 to dispatch a signal to picture sender 282. Sender 282 responds by sending the picture associated with icon “4” stored as picture “4” in storage 266 P. Picks 1-9 to the number stored at IN # 297. Consequently the bulldog picture is sent to Barney's telephone. Now, the user hangs up.

A third example of operation of this third example of this thirteenth embodiment will now be given (FIG. 14c). For this example, linked trigger 240h has been preset by the telephone manufacturer electrically connected to interface 31 to receive signal input therefrom indicating a user hangup. For this example, system 10w includes caller I.D. circuitry 20. The user employs picture selector 292 to select/load interesting pictures stored in a storage located on a PC into each of picture “1” through picture “9” of storage 266 P. Picks 1-9 (via a cable between phone 27w and the PC).

Some time later, the user's telephone (telephone 27w) rings from a ring signal sent by switching station 120. Included with the ring signal is caller I.D. information. Circuitry 20 obtains and provides the information on the touch-screen of GUI 210 (GUI 210 serving as display 21). picture sender 282 also obtains the caller I.D. information and stores the information at IN # 297 (supplanting prior stored caller I.D. information associated with the prior incoming call at IN # 297). Also provided on the touch-screen of GUI 210 is icon array 246 of picture picker 295. The user is certain from the information that his doctor is calling. The icons on icon array 246 comprise miniatures of the associated pictures stored. The user sees on icon “1” the picture of a medicine bottle, the bottle picture the user had prior loaded into storage 266 as picture “1”. The user decides to touch icon “1”. Touched icon “1” instructs GUI 210 to dispatch a signal to picture sender 282. Sender 282 responds by sending the picture associated with (and shown on) icon “1” stored as picture “1” in storage 266 P. Picks 1-9. Sender 282 employs the stored caller I.D. information to designate that the picture be delivered to the telephone from where the incoming call originated. Consequently the medicine bottle picture is sent to his doctor's telephone.

The user then answers the call. While chatting with the doctor, the user decides to send him a linked picture. Icon “7” shows the picture of a waterfall. The user touches icon “7” for a duration. Touched icon “7” for a duration instructs GUI 210 to dispatch a signal to linked trigger 240d. Trigger 240d waits for a signal from interface 31. When the conversation has concluded, the user hangs up. The hang up is detected by interface 31. Interface 31 responds by signaling trigger 240d. Trigger 240d responds by signaling picture sender 282. Sender 282 responds by sending the picture associated with icon “7” stored as picture “7” in storage 266 P. Picks 1-9 to the number stored at IN # 297. Consequently the waterfall picture is sent to the doctor's telephone.

This thirteenth embodiment can be enhanced through inclusion of an instant picture post 302. Instant picture post 302 functions to post a picture sent from the other party of a telephone call in progress for viewing by a user. An exemplary instant picture post 302, which can be used to enhance this thirteenth embodiment is depicted in FIGS. 14a, 14b, 14c and 14d (shown as P. Post 302 located at GUI 210). For this exemplary instant picture post 302, post 302 can firstly include circuitry and/or programming to recognize that a telephone call is in progress. A telephone call in progress can include a call being sent or received but not yet answered. A telephone call in progress can include an answered telephone call and not yet hung up by either of the user or the other party. As one example, post 302 can employ interface 31 to detect said call in progress.

Secondly, for this exemplary instant picture post 302, post 302 can include circuitry and/or programming to obtaining the location/address of the other party's telephone. As one example, if the call originated as incoming, post 302 can attain caller I.D. information included with the ring signal of an incoming call to then store the caller's telephone number, and if the call originated as outgoing, post 302 can store the telephone number dialed by the user (at telephone 27).

Thirdly, for this exemplary instant picture post 302, post 302 can include circuitry and/or programming to detect that a picture has been received, circuitry and/or programming to obtain the origination location/address of an incoming picture and circuitry and/or programming to post a picture to a display. As one example, telephone picture sending can include the telephone number of the sending telephone of a picture. Post 302 can store the telephone number included with an incoming picture.

Finally, for this example, when post 302 detects that a picture has been received, post 302 checks for signal information from interface 31 indicating a call in progress. If a call is in progress, post 302 then compares the location/address of the other party's telephone with the location/address of the incoming picture. If the telephone address and the picture address match, post 302 can then immediately post the incoming picture to the user's display (for this embodiment GUI 210). The user is enabled to view the picture while conversing with the other party. They can discuss the picture. While instant picture post 302 is here disclosed as an enhancement to this thirteenth embodiment, post 302 can be employed on any telephone or cell phone adapted to receive and display a picture. (Instant picture post 302 can be enhanced with a picture post enabler, said enabler can operate to enable and/or disable post 302. Said enabler can operate similarly to the prior described link enabler 315.)

The thirteenth embodiment can be enhanced, for example, by combining two or more of the given examples of the thirteenth embodiment: system 10u, system 10v and system 10w. As an example, system 10u can be combined with system 10v. As another example, systems 10u, 10v and 10w can be combined.

In summary, the examples of the thirteenth embodiment (FIGS. 14a, 14b and 14c) preferably operate by enabling a user to select a picture prior to a telephone call, storing one or more pictures, initiating the sending of a stored picture and sending the stored picture to one of a calling telephone or to a called telephone.

As can be seen from the foregoing, the present disclosure provides for a mobile phone for use with a picture selector to enable a user to select a picture prior to a telephone call, for use with a picture storage enabled to store a picture and for use with a picture sender enabled to send a picture to one of a calling telephone or a called telephone. The mobile phone can include a trigger to initiate the picture sender to send a picture stored in the picture storage at the time of the telephone call. The mobile phone can further include a caller I.D. circuitry to provide caller I.D. information to the user such that the user can view the caller I.D. information and, in response to the information, the user can initiate the sending of a picture.

A fourteenth embodiment of telephone call handling system 10 is illustrated in FIGS. 15a, 15b and 15c. This embodiment includes video delivery 285 (described prior, which functions to enable a user-selected picture to be sent to one of a calling telephone or to a called telephone. An exemplary video delivery 285 is depicted in FIGS. 14a, 14b and 14c. The exemplary delivery 285 includes video selector 294 (described prior, which functions to enable a user to select a video, video storage 286 (described prior, which functions to store one or more videos), delivery trigger 290 (described prior, which functions to initiate a sending and video sender 220 (described prior, which functions to send a video to one of a calling telephone or to a called telephone).

This fourteenth embodiment can further include caller I.D. circuitry 20 (described prior, which functions to provide caller I.D. information to a user) and video camera 289 (described prior, which functions to enable a user to take a video). This embodiment can be enhanced through inclusion of an instant video post 303. This embodiment can be enhanced through inclusion of a video picker 299. (This embodiment can further be enhanced through inclusion of one or more of the prior described icon selector 247, the prior described linked trigger enabler 315 and the prior described link selector 320. This fourteenth embodiment can be employed in combination with, or as an enhancement to, any of embodiments one through twelve, thirteen and fifteen herein described or other embodiments and examples.)

For this fourteenth embodiment, delivery trigger 290 is depicted comprising at least one of linked trigger 240 and deployed trigger 250. Linked trigger 240 described prior, functions to link a sending to some other activity. The sending can comprise one or more of: an audio message, an entertainment/content, a text message, an image, a video or can comprise other. For this fourteenth embodiment, the sending can comprise a video.

Deployed trigger 250 (described prior) functions to enable a user to initiate a sending at the time of the telephone call. The sending can comprise one or more of: an audio message, an entertainment/content, a text message, an image, a video or the sending can comprise other. For this fourteenth embodiment, the sending can comprise a video. Trigger 250 can include circuitry and/or programming to respond to a user's instruction by dispatching a signal to initiate a sending of a video.

A first example of this fourteenth embodiment is illustrated as call handling system 10x in FIG. 15a. System 10x includes: video selector 294, video storage 286, delivery trigger 290 and video sender 287, all shown located at telephone 27x. This first example of this fourteenth embodiment can further include video camera 289, linked trigger enabler 315 and/or link selector 320. For this example, telephone 27x comprises mobile phone 165 (phone 165 described prior). System 10x can include telephone 27x and, thus, can include phone 165. (This first example also can include interface 31, call detector 96 and/or call number detector 291.)

For this example, video selector 294 includes GUI 210. GUI 210 includes programming to facilitate the selection of a video. Video selection can comprise any of the video selection examples herein given or other. (Also, video selection can include selecting a previously selected video stored, for example, in stand-alone video 277 and/or in pick storage 276, both described later.) For this example, video storage 286 comprises a linked-deliver video storage 296 (shown as L.D.V. 296). Video storage 286 provides for storing a video in storage 296. The user can employ selector 294 to load a selected video into linked-deliver video storage 296. GUI 210 can be electrically connected to (or connectable to) storage 286. Video sender 287 can include circuitry and/or programming to send a stored video to a calling telephone. Sender 287 can be electrically connected to (or connectable to) video storage 286 and to switching station 120 via a wireless connection. (System 10x can include the prior described video reviewer 288 and can include the prior described video camera 289.)

For this example, delivery trigger 290 comprises linked trigger 240h. For this example, trigger 240h includes circuitry and/or programming to receive signal input and to respond to said signal input by initiating the sending of a video. Said signal input can be tied to some other activity as described prior. Said tied to some other activity can include tied to a telephone operation. Trigger 240h can be tied to one or more of interface 31, call detector 96 and calling number detector 291 (for example, tied as described in the first example of the twelfth embodiment.) A tied-to activity, for example, one or more of interface 31, detector 96 and detector 291 can be electrically connected to (or connectable to) trigger 240g. Trigger 240h electrically is connected to (or connectable to) video sender 287. A tied-to activity can send a signal to trigger 240h. Trigger 240h can respond by instructing video sender 287 to send a video stored in linked-deliver video storage 296 to the calling telephone.

A first example of operation of this first example of this fourteenth embodiment will now be given (FIG. 15a). For this example, linked trigger 240g has been preset by the telephone manufacturer electrically connected to interface 31 to receive signal input therefrom indicating a user hang-up. The user employs video selector 294 (in this case GUI 210) to select/load a video stored on the hard drive of his personal computer into linked-deliver video storage 296 (a cable connects phone 27x to the PC).

Some time later, the user's telephone (telephone 27x) rings from a ring signal sent by switching station 120 (provider 121). Video sender 287 obtains and stores the caller I.D. information included with the ring signal of the incoming call at IN # 297 (supplanting prior stored caller I.D. information associated with the prior incoming call at IN # 297). The user answers the call. When the conversation has concluded, the user hangs up. The hang up is detected by interface 31. Interface 31 responds by signaling trigger 240h. Trigger 240h responds by signaling video sender 287. Sender 287 responds by sending the video stored in linked-deliver video storage 296 of storage 286. Sender 287 employs the caller I.D. information to designate (for example, to service provider 121) that the video be delivered to the telephone from where the incoming call originated.

A second example of operation will now be given (FIG. 15a). For this example, linked trigger 240g has been preset by the telephone manufacturer electrically connected to interface 31 to receive signal input therefrom indicating a user's answering. Also preset is a one-hour time delay. The time delay affects to delay the sending of a signal to trigger 240g until one hour after the user answering has been detected. For this example, system 10x includes video camera 289. The user employs camera 289 to take a video of a plane crash. System 10x is configured such that the video upon being taken acts as selector 294 to loaded the video into video storage 296.

Some time later, telephone 27x rings from a ring signal sent by switching station 120. Video sender 287 obtains and stores the caller I.D. information included with the ring signal of the incoming call stored at IN # 297 (supplanting the prior stored caller I.D. information stored at IN # 297). The user answers the call. The user's answering is detected by interface 31. Interface 31 responds by implementing the one-hour delay and then by signaling trigger 240h. Trigger 240h responds by signaling video sender 287. Sender 287 responds by sending the video stored in video storage 296 of storage 286. Sender 287 employs the caller I.D. information stored at IN # 297 to designate (for example, to service provider 120) that the video be delivered to the telephone from where the incoming call originated. (Sender 287 includes programming to accommodate a next incoming call being received prior to completion of the one-hour delay. The programming provides for sender 287 sending the video as scheduled after the delay has elapsed to the designated telephone while providing to supplant the prior stored caller I.D. information with the I.D. information of the next incoming call.)

A third example of operation will now be given (FIG. 15a). For this example, linked trigger 240h has been preset by the telephone manufacturer electrically connected to U.I. 99 of starter 92 (described prior) to receive signal input from U.I. 99 indicating that the user has pressed select entertainment button SE 48 (FIG. 2b). For this example, system 10x includes link enabler 315, enabler 315 comprising auto-trigger icon 271. The user has just turned on his phone. Displayed on the screen of GUI 210 is auto-trigger icon 271. The user touches icon 271. GUI 210 responds by enabling trigger 240h.

Some time later, the telephone 27x rings from a ring signal sent by switching station 120. Video sender 287 obtains and stores the caller I.D. information included with the ring signal of the incoming call at IN # 297 (supplanting the prior stored caller I.D. information). The user answers the call. Shortly thereafter, the user needs wants the caller to hear his new music and, so, presses hold button 81 followed buy button SE 48. Pressing button 81 instructs message-then-hold circuitry 40 to send a hold message to the caller and to place the caller on hold. Pressing button SE 48 sends stored hold music to the caller. Pressing button SE 48 also sends a signal to trigger 240h. Trigger 240h responds by signaling video sender 287. Sender 287 responds by sending the video stored in video storage 296 of storage 286. Sender 287 employs the caller I.D. information stored at IN # 297 to designate that the video be delivered to the telephone from where the incoming call originated.

A fourth example of operation will now be given (FIG. 15a). For this example, system 10x includes link selector 320. The user employs link selector 320 (via GUI 210) to select an activity to link the sending of a video to. The user selects “auto-call back” (from a plurality of activity choices). The user then employs video selector 294 (in this case GUI 210) to select a video stored on the website U-Tube (phone 27x is cable-connected to a PC, the PC internet enabled). The user then further employs GUI 210 (selector 294) to download the selected video into linked-deliver video storage 296.

Some time later, the user's telephone (telephone 27x) rings from a ring signal sent by switching station 120 (provider 121). Video sender 287 obtains and stores the caller I.D. information included with the ring signal of the incoming call at In # 297 (supplanting prior stored caller I.D. information associated with the prior incoming call). Incoming call detector 96 detects the incoming call and responds by sending a signal to U.I. 99 of activator 91. U.I. 99 responds by sending a signal to linked trigger 240h and a signal to call back message circuitry 30. Circuitry 30 sends a callback message to the caller. Trigger 240h responds by signaling video sender 287. Sender 287 responds by sending the video stored in video storage 296 of storage 286. Sender 287 employs the caller I.D. information stored at IN # 297 to designate that the video be delivered to the telephone from where the incoming call originated.

A fifth example of operation will now be given (FIG. 15a). For this example, linked trigger 240h has been preset by the telephone manufacturer electrically connected to calling number detector 291. For this example, system 10x includes mobile phone 165 providing that detector 291 can be located phone 165 so the user does not require internet access hardware to input the calling phone number. (Including phone 165 also provides that enabler 315 and/or selector 320 can be located at phone 165, again, eliminating the need for hardware.) The user then employs GUI 210 (selector 294) to select and load a video into storage 296.

Later, the user's telephone (telephone 27x) rings. Calling number detector 291 detects that the calling phone has been designated by the user. Detector 291 signals linked trigger 240h. Trigger 240h signals video sender 287. Sender 287 sends the video stored in linked-deliver storage 296 to the calling phone.

A sixth example of operation of this first example of this fourteenth embodiment will now be given (FIG. 15a). For this example, linked trigger 240g has been preset by the telephone manufacturer electrically connected to interface 31 to receive signal input therefrom indicating a called party hang-up. The user employs video selector 294 (in this case GUI 210) to select/load a video stored on the hard drive of his personal computer into linked-deliver video storage 296 (a cable connects phone 27x to the PC).

Some time later, the user's places a telephone call. Video sender 287 obtains and stores the dialed telephone number in storage OUT # 305. (supplanting a prior stored number associated with the prior incoming call). The called party answers the call. When the conversation has concluded, the called party hangs up. The hang up is detected by interface 31. Interface 31 responds by signaling trigger 240h. Trigger 240h responds by signaling video sender 287. Sender 287 responds by sending the video stored in linked-deliver video storage 296 of storage 286. Sender 287 employs the dialed telephone number stored at OUT # 305 to designate (for example, to service provider 121) that the video be delivered to the telephone of the called party.

A second example of this fourteenth embodiment is illustrated as call handling system 10y in FIG. 15b. System 10y includes video selector 294, video storage 286, delivery trigger 290 and video sender 287. For this example, telephone 27y comprises mobile phone 165 (phone 165 described prior). System 10y can include telephone 27y and, thus, can include phone 165. For this example, video selector 294, video storage 286, and video sender 287 are shown located at service provider 21 (selector 294 shown as V. Selector 294). For this example, delivery trigger 290 comprises deployed trigger 250, trigger 250 shown located at telephone 27y.

For this second example, system 10y can also include caller I.D. circuitry 20 also shown located at telephone 27y. Circuitry 20 is shown employing GUI 210 to serve as display 21 to display caller I.D. information to the user (display 21, described prior, shown in FIG. 14b located on GUI 210). For this example, video selector 294 can be located at a website of service provider 121, said website programmed to facilitate and/or enable the selection of a video. (Video selection can comprise any of the examples herein given of selector 294 or other. Also, the user can employ selector 294 to select a previously selected video stored, for example, in the prior described linked-deliver video storage 296 and/or in the to-be-described video pick storage 276 described later.) For this example, video storage 286 comprises a stand-alone video storage 277 (shown as Solo V. 277). Video storage 286 provides for storing a video in storage 277. The user can employ selector 294 to load a selected video into stand-alone video storage 277. The website of service provider 121 can be electrically connected to (or connectable to) storage 286. Video sender 287 can include circuitry and/or programming to send a stored video to a calling telephone. Sender 287 can be electrically connected to (or connectable to) video storage 286 and to switching station 120. (System 10y can include the prior described video reviewer 288 and can include the prior described video camera 289.)

For this example, delivery trigger 290 comprises deployed trigger 250 (deployed trigger 250 described prior). An exemplary deployed trigger 250 is shown as D. Trigger 250e in FIG. 15b. The exemplary deployed trigger 250e is located at telephone 27y. The exemplary deployed trigger 250e can employ GUI 210 (described prior) to respond to the user's instruction by dispatching a signal to initiate a sending of a video. Deployed trigger 250e can comprise a selected video icon 278. GUI 210 can include programming to receive and respond to instruction from the user via the user touching selected video icon 278 shown as SV 278 located on the touch-screen of GUI 210. GUI 210 can be electrically connected to (or connectable to) video sender 287. GUI 210 can respond to the user touching icon 278 by sending a signal to sender 287. Sender 287 can respond to the signal by sending a video stored in a stand-alone video storage 277 to the calling phone.

Handling system 10y can comprise selector 294, storage 286 and sender 287 located at provider 121 with deployed trigger 250 located at telephone 27. Thus it can be appreciated that system 10y works in conjunction with a telephone 27y having deployed trigger 250 located thereon thus enabling the telephone user to employ trigger 250 to initiate the sending of a video at the time of the telephone call.

A first example of operation of this second example of this fourteenth embodiment will now be given (FIG. 15b). A user has employed video selector 294 (selector 294 located at a website operated by service provider 121, the user accessing the website via an on-line personal computer) to select/load a video of a birth the user saw on the internet into stand-alone video storage 277.

Some time later, the user's telephone (telephone 27y) rings from a ring signal sent by switching station 120. Video sender 287 obtains and stores the caller I.D. information included with the ring signal of the incoming call stored at IN # 297 (supplanting prior stored caller I.D. information associated with the prior incoming call at IN # 297). Provided on the touch-screen of GUI 210 is selected video icon 278 of deployed trigger 250e. The user decides to touch icon 278. Touched icon 278 instructs GUI 210 to dispatch a signal to video sender 287. Sender 287 responds by sending the video stored in stand-alone video storage 277. Sender 287 employs the stored caller I.D. information to designate that the video (or a link to where the video is stored) be delivered to the telephone from where the incoming call originated stored at IN # 297. The user can then answer the call or not. (The video can also be sent to and displayed on reviewer 283).

A second example of operation will now be given (FIG. 15b). Phone 27y is Internet enabled. A user has employed video selector 294 (selector 294 located at a website operated by service provider 121 and accessed by the user via phone 27y) to select/load a video of a wedding from a video storage in phone 27y into stand-alone video storage 277.

Some time later, telephone 27y rings from a ring signal sent by switching station 120. Video sender 287 obtains and stores the caller I.D. information included with the ring signal of the incoming call at IN # 297 (supplanting prior stored caller I.D. information associated with the prior incoming call at IN # 297). Provided on the touch-screen of GUI 210 is selected video icon 278 of deployed trigger 250e. The user answers the call, and while chatting with the caller decides he'd like to send the wedding video. The user touches icon 278. Touched icon 278 instructs GUI 210 to dispatch a signal to video sender 287. Sender 287 responds by sending the video stored in stand-alone video storage 277. Sender 287 employs the stored caller I.D. information to designate that the video be delivered to the telephone from where the incoming call originated stored at IN # 297. Consequently the wedding video (or a link to the stored video) has been sent to the calling telephone while they chat. The caller can indicate that the video has arrived. (Both caller and user can be enabled to watch the video simultaneously.)

A third example of operation will now be given (FIG. 15b). A user has employed video selector 294 (selector 294 located at a website operated by service provider 121) to select a video of a boat crash from a boat racing website and to load the video into stand-alone video storage 277.

Some time later, telephone 27y rings from a ring signal sent by switching station 120. Video sender 287 obtains and stores the caller I.D. information included with the ring signal of the incoming call at IN # 297 (supplanting prior stored caller I.D. information associated with the prior incoming call at IN # 297). Provided on the touch-screen of GUI 210 is selected video icon 278 of deployed trigger 250e. The user answers the call, chats with the caller and then hangs up. A few minutes later (prior to receiving a next incoming call), the user decides he'd like to send the just chatted with caller the boat crash video. The user finds the phone and touches icon 278. Touched icon 278 instructs GUI 210 to dispatch a signal to video sender 287. Sender 287 responds by sending the video stored in stand-alone video storage 277. Sender 287 employs the stored caller I.D. information to designate that the video be delivered to the telephone from where the incoming call originated stored at IN # 297. Consequently the boat crash video has been sent to the calling telephone.

A fourth example of operation will now be given (FIG. 15b). For this example, system 10y includes caller I.D. circuitry 20. A user has employed video selector 294 (selector 294 located at a website operated by service provider 121) to select a beach baby video from a video file on the interne website U-Tube and to load the video into stand-alone video storage 277.

Some time later, the user's telephone (telephone 27y) rings from a ring signal sent by switching station 120 indicating an incoming call. Video sender 287 obtains and stores the caller I.D. information included with the ring signal of the incoming call at IN # 297 (supplanting prior stored caller I.D. information associated with the prior incoming call). Circuitry 20 provides the caller I.D. information on the touch-screen of GUI 210 (GUI 210 serving as display 21). Also provided on the touch-screen of GUI 210 is selected video icon 278 of deployed trigger 250e. The user recognizes the caller I.D. information and, thus, is certain his girlfriend is calling. The user wants to share the video he has loaded and, so, the user touches selected video icon 278. Touched icon 278 instructs GUI 210 to dispatch a signal to video sender 287. Sender 287 responds by sending the video stored in stand-alone video storage 277. Sender 287 employs the caller I.D. information stored at IN # 297 to designate that the video (beach baby) be delivered to the telephone from where the incoming call originated. Consequently the beach baby video has been sent to his girlfriend's telephone. Subsequently, the user answers the call or the user declines to answer (or the girlfriend hangs up).

This fourteenth embodiment can include a video picker 299. Picker 299 functions to enable a user to pick a video from a plurality of video choices to pick from. An exemplary video picker 299 is depicted in FIG. 15c. The exemplary picker 299 includes GUI 210 (described prior). GUI 210 is electrically connected to (or connectable to) deployed trigger 250f (trigger 250 described prior) and is electrically connected to (or connectable to) linked trigger 240i shown as L. Trigger 240i (trigger 240 described prior). GUI 210 includes programming to receive and to respond to instruction from the user via the user touching an icon. Said icon can be located in an icon array 246 shown located on the touch-screen of GUI 210. Icon array 246 can include icons, “1” through “0” as shown. GUI 210 can respond to the user touching an icon by signaling deployed trigger 250f and/or by signaling linked trigger 240i. Deployed trigger 250f can include circuitry and/or programming to receive signal input and to respond to said signal input by initiating the sending of a video. Trigger 250f can respond to a signal from GUI 210 by instructing video sender 287 to send a video (or videos) stored in a video pick storage 276 (storage 276 described later) shown located in video storage 286. Linked trigger 240i includes circuitry and/or programming to receive signal input and to respond to said signal input by initiating the sending of a video (or videos). Linked trigger 240i can respond to a signal from GUI 210 by waiting a signal indicating an activity. As an example, trigger 240i can be awaiting a signal indicating a detected hang-up by a user (detected by, for example, the prior described interface 31, interface 31 being electrically connected to, or connectable to, trigger 240i). Upon receiving the signal indicating the hang-up, trigger 240i can respond by instructing video sender 287 to send a video stored in pick storage 276 (described later). (Picker 299 can be employ in conjunction with linked trigger 240i only, can be employed in conjunction with deployed trigger 250f only or can be employed in conjunction with both trigger 240i and trigger 250f. When employed in conjunction with both, picker 299 can be employed in conjunction with both during the same telephone call or in conjunction with one or the other during telephone call depending, for example, on a user's instruction. GUI 210 can be programmed to enable a user to implement said instruction. Also, any icon herein suggested for user-initiating the sending of a video can be configured to display a picture representative of the video as the icon. Also, exemplary picker 299 can be employed by a user at any time during “at the time of the telephone call”.)

A third example of this fourteenth embodiment is illustrated as call handling system 10z in FIG. 15c. System 10z includes video selector 294, video storage 286, video picker 299, delivery trigger 290 and video sender 287, all shown located at a telephone 27z. For this example, telephone 27z comprises mobile phone 165 (phone 165 described prior). System 10z can include telephone 27z and, thus, can include phone 165.

For this example, system 10z can include caller I.D. circuitry 20. For this example, circuitry 20 includes GUI 210. Circuitry 20 is shown employing GUI 210 to serve as display 21 to display caller I.D. information to the user (display 21, described prior, shown in FIG. 15c located on GUI 210). For this example, video selector 294 includes GUI 210. GUI 210 includes programming to facilitate the selection and storage of a video.

For this example, video storage 286 comprises video pick storage 276, shown as V. Picks 1-9. Storage 286 provides for storing a plurality of videos in storage 276 V. Picks: 1-9. The user can employ selector 294 to load said plurality of videos into pick storage 276. (Alternately, a plurality of videos can be pre-loaded into, for example, phone 165 by, for example, a telephone manufacturer, or other. Video selector 294 can then operate by enabling the user to select videos from the pre-loaded plurality to be stored, for example, in storage 276. Alternately, storage 276 V. Picks 1-9, or some other storage, can be pre-loaded with videos and those videos can be represented by pre-set icons displayed on GUI 210. Video selection can comprise any of the video selection examples herein given or other.) GUI 210 can be electrically connected to (or connectable to) storage 276. Video sender 287 can include circuitry and/or programming to send a stored video to a calling telephone. Sender 287 can be electrically connected to (or connectable to) storage 286 and to switching station 120 (provider 121) via a wireless connection.

For this example, system 10z comprises video picker 299 (described prior). For this example, video picker 299 can be employed in conjunction with deployed trigger 250f. Thus, trigger 250f can be electrically connected to (or connectable to) picker 299 and to video sender 287. For this example, picker 299 can be employed in conjunction with linked trigger 240i. Thus, linked trigger 240h can be electrically connected to (or connectable to) picker 299 and to video sender 287. Video picker 299, via GUI 210, can enable the user to pick one of the videos stored in storage 276 V. Picks 1-9. As an example, the user touches one of the icons “1” through “0” located on icon array 246. Each icon is associated with a video stored in storage 276. In other words, touching the icon picks a video from storage 276 V. Picks 1-9. For example, touching icon “1” picks video “1” stored in storage 276 V. Picks 1-9, touching icon “2” picks video “2” stored in storage 276 V. Picks 1-9, etc. through video “9”.

For this example, picker 299 can be configured such that touching an icon on GUI 210 can send a signal from GUI 210 to deployed trigger 250f. Trigger 250f signals sender 287. Sender 287 responds by sending a video associated with the icon pressed to the caller. For this example, picker 299 can be configured such that touching an icon on GUI 210 for a duration (for example three seconds) can send a signal from GUI 210 to linked trigger 240i. Trigger 240i waits for receipt of a signal from a linked-to activity and upon receiving dispatches a signal to sender 287. Sender 287 responds to the signal by sending a video associated with the icon pressed to the caller. (For this example, system 10z can comprise linked trigger enabler 315 providing that a user can enable and disable linked trigger 240i. For this example, when linked trigger 240i is enabled, For this example, system 10z can comprise the prior described link selector 320 and, for this example, selector 320 can include circuitry and/or programming to time events. System 10z can include the prior described video reviewer 288 and can include the prior described video camera 289.)

(For this example, deployed trigger 250f is depicted comprising a diagrammatic block for illustrative convenience. In actuality, GUI 210 including icons “1” through “9” of icon array 246 (also of icons “01” through “09” etc.) comprise trigger 250f. The example above has a touched icon “1” through “9” affecting GUI 210 to signal trigger 250f. Trigger 250f in turn signals sender 287. Absent the illustrative convenience, GUI 210 can be directly connected to (or connectable to) sender 287. In that case, a touched icon “1” through “9” affects GUI 210 to directly signal sender 287. To be clear, for system 10z, a touched for duration icon “1” through “9” affects GUI 210 to signal linked trigger 240i.)

(Also, from the video picks stored in storage 276, or from videos stored elsewhere, a videos can be chosen randomly, or other, in a manner similar to that described prior for shuffler 117. Also, video selector 294 can enable the user to select groups of videos, for example groups having a common subject or action or other. A group can include icons therein nested that, for example, automatically post on GUI 210 when the group is loaded into, for example, storage 276. In one variation, a group can be selected by action, or other, wherein the user knows the action but not the individual video. Upon touching an icon, the associated video is sent to the caller and to reviewer 288.)

A first example of operation of this third example of this fourteenth embodiment will now be given (FIG. 15c). The user employs video selector 294 to select interesting video clips from a video library stored by the manufacturer of telephone 27z in telephone 27z. The user employs video selector 294 to load a selected video into each of video “1” through video “9” of storage 276 V. Picks 1-9.

Some time later, telephone 27z rings from a ring signal sent by switching station 120. Video sender 287 obtains and stores the caller I.D. information included with the ring signal of the incoming call at IN # 297 (supplanting prior stored caller I.D. information associated with the prior incoming call at IN # 297). The user answers the call. Provided on the touch-screen of GUI 210 is icon array 246 of video picker 299. The user thinks this caller would enjoy the video clip he has loaded into video “6” of pick storage 276. The user touches icon “6”. Touched icon “6” instructs GUI 210 to dispatch a signal to video sender 287. Sender 287 responds by sending the video associated with icon “6” stored as video “6” in storage 276 V. Picks 1-9. Sender 287 employs the stored caller I.D. information to designate that the video be delivered to the telephone from where the incoming call originated (IN # 297). Consequently the video clip is sent to the caller.

A second example of operation of this third example of this fourteenth embodiment will now be given (FIG. 15c). For this example, system 10z includes caller I.D. circuitry 20. The user's telephone (telephone 27z) is internet enabled. The user employs telephone 27z (via service provider 121) to visit a video clip store located on the internet. The user purchases video clips from the store. The user employs video selector 294 to select/load the purchased video clips into each of video “1” through video “9” of storage 276 V. Picks 1-9.

Some time later, the user's telephone (telephone 27z) rings from a ring signal sent by switching station 120. Included with the ring signal is caller I.D. information. Circuitry 20 obtains and provides the information on the touch-screen of GUI 210 (GUI 210 serving as display 21). Video sender 287 also obtains the caller I.D. information and stores the information at IN # 297 (supplanting prior stored caller I.D. information associated with the prior incoming call). Also provided on the touch-screen of GUI 210 is icon array 246 of video picker 299. The user is mostly certain from the information that it's Dingeldorf calling and knows that Dingeldorf loves car racing. The user remembers he has loaded into video “2” of pick storage 276 a video clip of last year's Indy 500 finish. The user decides to touch icon “2”. Touched icon “2” instructs GUI 210 to dispatch a signal to video sender 287. Sender 287 responds by sending the video associated with icon “2” stored as video “2” in storage 276 V. Picks 1-9. Sender 287 employs the stored caller I.D. information to designate that the video be delivered to the telephone from where the incoming call originated stored at IN # 297. Consequently the video clip of the Indy 500 finish is sent to Dingeldorf's telephone (can also be displayed on GUI 210 by reviewer 288). Subsequently, the user answers the call or not or Barney hangs up.)

The user decides to answer the call. While chatting with Dingeldorf, the user decides to send him another video clip. The user touches icon “4”. (The user has prior loaded into video “4” of pick storage 276 a video clip of a bullfrog leaping.) Touched icon “4” instructs GUI 210 to dispatch a signal to video sender 287. Sender 287 responds by sending the video associated with icon “4” stored as video “4” in storage 276 V. Picks 1-9. Consequently the leaping bullfrog video clip is sent to Dingeldorf's telephone. Now, the user hangs up.

A third example of operation of this third example of this fourteenth embodiment will now be given (FIG. 15c). For this example, linked trigger 240i has been preset by the telephone manufacturer electrically connected to interface 31 to receive signal input therefrom indicating a user hang-up. Also preset is a 60-second time delay. The time delay affects to delay the sending of a signal to trigger 240g until 60 seconds after the caller hang up has been detected. For this example, system 10z includes caller I.D. circuitry 20. The user employs video selector 294 to select/load interesting video clips stored in a storage located on a PC into each of video “1” through video “9” of storage 276 V. Picks 1-9 (via a cable between phone 27z and the PC).

Some time later, the user's telephone (telephone 27z) rings from a ring signal sent by switching station 120. Included with the ring signal is caller I.D. information. Circuitry 20 obtains and provides the information on the touch-screen of GUI 210 (GUI 210 serving as display 21). video sender 287 also obtains the caller I.D. information and stores the information at IN # 297 (supplanting prior stored caller I.D. information associated with the prior incoming call). Also provided on the touch-screen of GUI 210 is icon array 246 of video picker 299. The user is

certain from the information that his psychiatrist is calling. Each icon on icon array 246 comprises a representative picture of the associated video stored. The user sees on icon “1” the picture of a loose screw, the loose screw picture representative of a video clip of the movie “One Flew Over the CooCoo's Nest” the user had prior loaded into video 276 as video “1”. The user decides to touch icon “1”. Touched icon “1” instructs GUI 210 to dispatch a signal to video sender 287. Sender 287 responds by sending the video associated with (and shown on) icon “1” stored as video “1” in storage 276 V. Picks 1-9. Sender 287 employs the caller I.D. information stored at IN # 297 to designate that the video be delivered to the telephone from where the incoming call originated. Consequently the “One Flew Over the CooCoo's Nest” video clip is sent to his psychiatrist's telephone.

The user then answers the call. While chatting with the psychiatrist, the user decides to send him a linked picture. The user switches phone 27z to operate picture sender 282. Icon “7” shows the picture of a waterfall. The user touches icon “7” for a duration. Touched icon “7” for a duration instructs GUI 210 to dispatch a signal to linked trigger 2401. Trigger 2401 waits for a signal from interface 31. When the conversation has concluded, the user hangs up. The hang up is detected by interface 31. Interface 31 waits 60 seconds and then responds by signaling trigger 240i. Trigger 240i responds by signaling picture sender 282. Sender 282 responds by sending the picture associated with icon “7” stored as picture “7” in storage 266P. Picks 1-9. Consequently the waterfall picture is sent to the psychiatrist's telephone.

This fourteenth embodiment can be enhanced through inclusion of an instant video post 303. Instant video post 303 functions to post a video sent from the other party of a telephone call in progress for viewing by a user. An exemplary instant video post 303, which can be used to enhance this fourteenth embodiment is depicted in FIGS. 15a, 15b, 15c and 15d (shown as V. Post 303 on GUI 210). For this exemplary instant video post 303, post 303 can firstly include circuitry and/or programming to recognize that a telephone call is in progress. A telephone call in progress can include a call being sent or received but not yet answered. A telephone call in progress can include an answered telephone call and not yet hung up by either of the user or the other party. As one example, post 303 can employ interface 31 to detect said call in progress.

Secondly, for this exemplary instant video post 303, post 303 can include circuitry and/or programming to obtaining the location/address of the other party's telephone. As one example, if the call originated as incoming, post 303 can attain caller I.D. information included with the ring signal of an incoming call to then store the caller's telephone number, and if the call originated as outgoing, post 303 can store the telephone number dialed by the user (at telephone 27).

Thirdly, for this exemplary instant video post 303, post 303 can include circuitry and/or programming to detect that a video has been received, circuitry and/or programming to obtain the origination location/address of an incoming video and circuitry and/or programming to post a video to a display. As one example, telephone video sending can include the telephone number of the sending telephone of a video. Post 303 can store the telephone number included with an incoming video.

Finally, for this example, when post 303 detects that a video has been received, post 303 checks for signal information from interface 31 indicating a call in progress. If a call is in progress, post 303 then compares the location/address of the other party's telephone with the location/address of the incoming video. If the telephone address and the video address match, post 303 can then immediately post the incoming video to the user's display (for this embodiment GUI 210). The user is enabled to view the video while conversing with the other party. They can discuss the video. While instant video post 303 is here disclosed as an enhancement to this fourteenth embodiment, post 303 can be employed on any telephone or cell phone adapted to receive and display a video. (Instant video post 303 can be enhanced with a video post enabler, said enabler can operate to enable and/or disable post 303. Said enabler can operate similarly to the prior described link enabler 315.)

The fourteenth embodiment can be enhanced, for example, by combining two or more of the given examples of the twelfth embodiment: system 10x, system 10y and system 10z. As an example, system 10y can be combined with system 10z. As another example, systems 10x, 10y and 10z can be combined.

In summary, the examples of the fourteenth embodiment (FIGS. 15a, 15b and 15c) preferably operate by enabling a user to select a video prior to a telephone call, storing one or more videos, initiating the sending of a stored video and sending the stored video to one of a calling telephone or to a called telephone.

As can be seen from the foregoing, the present disclosure provides for a mobile phone for use with a video selector to enable a user to select a video prior to a telephone call, for use with a video storage enabled to store a video and for use with a video sender enabled to send a video to one of a calling telephone or a called telephone. The mobile phone can include a trigger to initiate the video sender to send a video stored in the video storage at the time of the telephone call. The mobile phone can further include a caller I.D. circuitry to provide caller I.D. information to the user such that the user can view the caller I.D. information and, in response to the information, the user can initiate the sending of a video.

For the embodiments depicted in FIGS. 13a, 14a and 15a, the selectors, storage and senders employed by text delivery 300, picture delivery 280 and video delivery 285 (respectively) have been shown all located at service provider 121. Said selectors, storage and senders can be located otherwise. For example, all can be located at the respective telephones 27. Other location arrangements include: selector at provider 121 with storage and sender located at telephone 27; storage at provider 121 with selector and sender located at telephone 27; sender located at provider 121 with selector and storage located at telephone 27; selector at provider telephone 27 with storage and sender located at provider 121; storage at telephone 27 with selector and sender located at provider 121; and sender located at telephone 27 with selector and storage located at provider 121. (Any/all other various combinations of component locations can alternately be implemented.)

For the embodiments depicted in FIGS. 13b, 13c, 14b, 14c, 15b and 15c, the selectors, storage and senders employed by text delivery 300, picture delivery 280 and video delivery 285 have been shown all located at telephone 27. Said selectors, storage and senders can be located otherwise. For example, for each embodiment selector, storage and sender can all be located at service provider 121. Other location arrangements can include said other location arrangements suggested above.

Selectors herein disclosed include: message selector 68, entertainment selector 69, text selector 215, picture selector 292, video selector 294 and link selector 320. Selections are preferably made via telephone 27 with the selector either located at telephone 27 or with telephone 27 enabled to access the selector elsewhere via telephone 27 (for example, at the service provider or at the internet). Making a selection via telephone 27 is convenient because the selection pertains to telephone calls as does telephone 27. Otherwise, the user is required to access secondary hardware to make a selection. Enablements herein described, including enabler 315, are also preferably made via telephone 27 for the above said convenience.

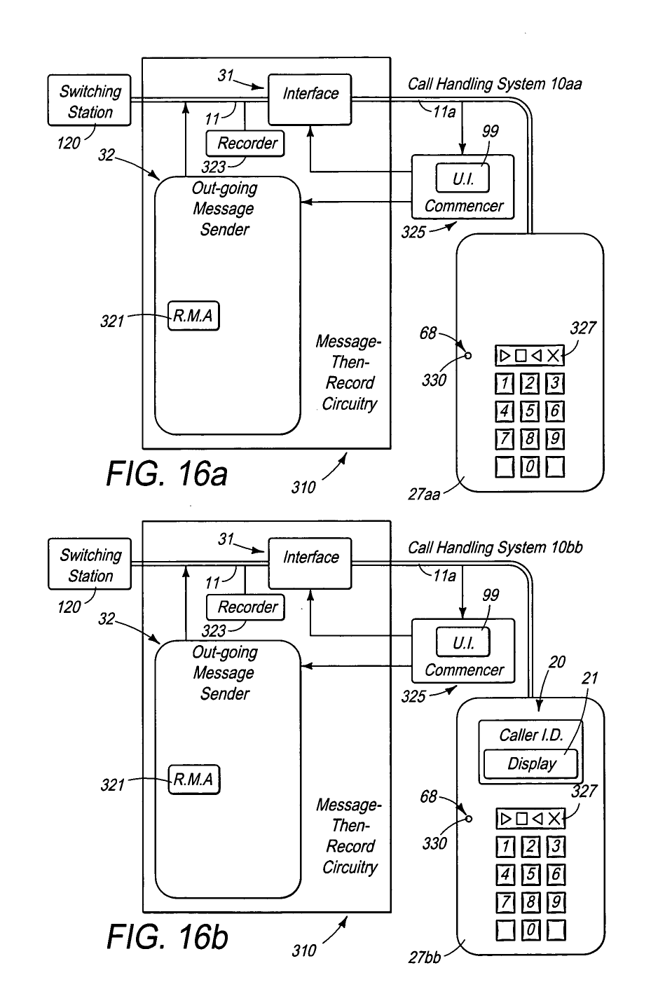

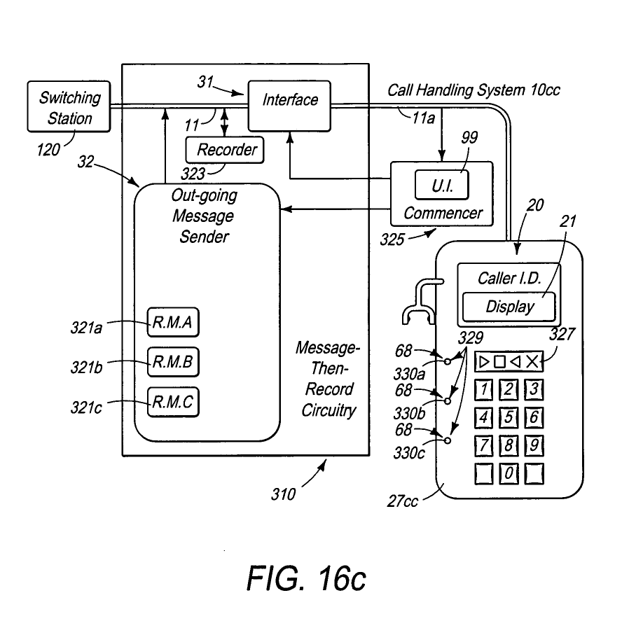

A fifteenth embodiment of telephone call handling system 10 is illustrated in FIGS. 16a, 16b and 16c. This fifteenth embodiment comprises message-then-record circuitry 310 and a commencer 325. This embodiment can include the previously described caller I.D. circuitry 20. This embodiment can be further enhanced with a record message picker 329. (In one variation, this fifteenth embodiment comprises circuitry 20 and commencer 325, both located at a phone (27aa, 27bb, 27cc) and interacts with, and can include, message-then-record circuitry 310 located, for example, at service provider 121. Also, this fifteenth embodiment can employ the prior described message selector 68. Also, the prior described plurality of complementary circuitry 130 can comprise message-then-record circuitry 310.)

Message-then-record circuitry 310 functions to deliver a message to a caller and then record a conversation. An exemplary message-then-record circuitry 310 is depicted in FIGS. 16a, 16b and 16c. The exemplary circuitry 310 comprises interface 31 (described prior) and out-going message sender 32 (described prior).

Commencer 325 functions to receive instruction from a user to commence message-then-record circuitry 310. An exemplary commencer 325 is depicted in FIGS. 16a, 16b and 16c. The exemplary commencer 325 comprises user interface (shown as U.I.) 99 (described prior). UI 99 functions to receive instruction from a user.

A first example of this fifteenth embodiment is illustrated as system 10aa in FIG. 16a. For this example, out-going message sender 32 of message-then-record circuitry 310 is configured to store and to deliver to a caller a record message A 321 shown as R.M. A 321. Record message A 321 states, for example, “This conversation may be recorded.” Interface 31 is configured to maintain the off-hook condition until detecting the call being answered by the user.

Further for this example, UI 99 of commencer 325 is configured to receive instruction from a user via a control button 330, button 330 electrically connected to (or connectable to) line 11a and located at telephone 27aa. When pressed, button 330 sends a control signal to UI 99. UI 99 responds by sending a signal to interface 31 and, after a two-second delay, sending a signal to sender 32. Interface 31 responds by going off-hook. Sender 32 responds by sending record message A 321 to the caller. (Button 330 can be part of commencer 325.)

An first example of operation of this first example of this fifteenth embodiment will now be given (FIG. 16a). A user's telephone is rung by an incoming ring signal provided by station 120 via line 11 and line 11a. The user may desire to record the conversation for any of a number of different reasons. Accordingly, the user presses control button 330. Pressed button 330 sends a signal to UI 99 via line 11a and commencer 325. UI 99 responds by sending a signal to interface 31 and, after a two-second delay, by sending a signal to out-going message sender 32. Interface 31 responds by going off-hook. Sender 32 responds by playing and sending record message A 321, “This conversation may be recorded” to the caller (via line 11 and switching station 120). The caller hears the message and understands that any subsequent telephonic conversation with the user may be recorded. At the conclusion to the sending of the message, handling system 10aa remains idle (on hold) by interface 31 maintaining the off-hook condition until the user answers the call. When the user answers, the off-hook condition of telephone 27aa is detected by interface 31. Interface 31 responds by discontinuing the off-hook condition. (If the caller hangs up prior to the user answering, interface 31 can respond by discontinuing the off-hook condition.) Circuitry 310 responds to discontinuance of the off-hook condition (and provided the caller has not terminated the call) by engaging recorder 323. (Circuitry 310 is configured to determine the following conditions in order to engage recorder 323: (i) that button 330 has been presses to send the “record” message; (ii) that the off-hook condition has been terminated; (iii) that the call has not been terminated; and (iv) that the user has not subsequently signaled the circuitry to terminate the recording. Circuitry 310 can alternately be configured to maintain the recorder 323 in the engaged condition following termination of the call by the caller so that the user can record verbal information relating to the call, such as the date, time and identity of the caller, and any other notes the user wishes to record. The recorder can then be disengaged by the user by signaling circuitry 310 (e.g., via button 330) to disengage the recorder.) Recorder 323 remains engaged until circuitry 310 determines that (i) the incoming call has been terminated (i.e., no incoming call signal detected), (ii) the user disengages the recorder 323 during the conversation (e.g., by pressing button 330 again), or the user disengages the recorder after the caller has terminated the call. Thus, button 330 can act as a multi-function button, serving to: (i) send the “record” message R.M. A 321 (if circuitry 310 determines that there is an unanswered incoming call); (ii) act as an “on-off” toggle for the recorder 323 during a conversation (if circuitry 310 determines that there is an ongoing connected call); and (iii) to enable playback of the last-recorded conversation (if circuitry 310 determines that there is currently no incoming or ongoing call). Phone 27aa can also use common message playback features (e.g., “play”, “repeat”, “delete”) 327 to manage conversations recorded by the recorder 323.

“Record” message R.M. A (321) can either be provided as a standard default message supplied by a service provider or a telephone manufacturer, or as a user customized message. In the latter instance the user can customize the “record” message R.M. A (321) by pressing button 330 (when no call is incoming or in progress), and then speaking the desired customized “record” message into the microphone (a standard feature for any telephone, and thus not depicted in FIG. 16a). One the desired “record” message has been recorded, the user can again press button 330 to terminate recording of the message.

A second example of operation of this first example of this fifteenth embodiment will now be given (FIG. 16a). A user's telephone is rung by an incoming ring signal provided by station 120 via line 11 and line 11a. The user decides to answer the call. While conversing with the caller, the user decides that he would benefit by recording information that he expects will be shared. Accordingly, the user presses control button 330. Pressed button 330 sends a signal to UI 99 via line 11a and commencer 325. UI 99 responds by sending a signal to out-going message sender 32. Sender 32 responds playing and sending record message A 321, “This conversation may be recorded” to the caller (via line 11 and switching station 120). The caller hears the message (as does the caller) and understands that any subsequent telephonic conversation with the user may be recorded. Sender 32 then discontinues the playing and sending of the message and signals recorder 323. Recorder 323 commences to record the conversation. Recorder 323 remains engaged until circuitry 310 determines that (i) the incoming call has been terminated (i.e., no incoming call signal detected), (ii) the user disengages the recorder 323 during the conversation (e.g., by pressing button 330 again), or the user disengages the recorder after the caller has terminated the call. (Alternately, UI 99 can respond to the user pressing button 330 by employing interface 31 to communicably disconnect caller and user while message A 321 is played to the caller. Sender 32 can then indicate a conclusion to the message sending by sending a signal to interface 31 and a signal to recorder 323. Interface 31 can respond by communicably re-connecting caller and user. Recorder 323 respond to the signal by recording the conversation. Also, as can be seen from this second example of operation, this fifteenth embodiment can function to record conversations regardless of whether the call originated as an incoming call or was placed by the user.)

A second example of the fifteenth embodiment is illustrated as telephone call handling system 10bb in FIG. 16b. This second example comprises the first example and further configured with caller I.D. circuitry 20 and display 21 (depicted as being located on phone 27bb). This feature allows the user to determine whether or not to send the “record” message R.M. A (321) to the caller.

An example of operation of this second example of this fifteenth embodiment will now be given (FIG. 16b). A user's telephone is rung by an incoming ring signal provided by station 120 via line 11 and line 11a. Delivered with the ring signal is caller I.D. information. The information appears on display 21 (located at telephone 27bb). The user recognizes the phone number (or caller identification) on the display; i.e. the user essentially knows who's calling. The user may determine that this person is someone whose conversations should be recorded (perhaps a client calling to give instructions to a professional). Accordingly, the user presses control button 330. Pressed button 330 sends a signal to UI 99 via line 11a. UI 99 responds by sending a signal to interface 31 and, after a two-second delay, by sending a signal to out-going message sender 32. Interface 31 responds by going off-hook. Sender 32 responds by playing and sending record message A 321, “This conversation may be recorded” to the caller (via line 11 and switching station 120). The caller hears the message and understands that any subsequent telephonic conversation with the user may be recorded. At the conclusion to the sending of the message, handling system 10bb remains idle (on hold) by interface 31 maintaining the off-hook condition until the user answers the call. When the user answers, the off-hook condition of telephone 27bb is detected by interface 31. Interface 31 responds by discontinuing the off-hook condition. (If the caller hangs up prior to the user answering, interface 31 can respond by discontinuing the off-hook condition.) Circuitry 310 responds to discontinuance of the off-hook condition (and provided the caller has not terminated the call) by engaging recorder 323. Recorder 323 remains engaged until circuitry 310 determines that either (i) the incoming call has been terminated (i.e., no incoming call signal detected) or (ii) the user disengages the recorder 323 (e.g., by pressing button 330 again).

As with phone 27aa of FIG. 16a, phone 27bb of FIG. 16b can be provided with message management features 327 in order to manage conversations recorded by the recorder 323. Also, for this second example of this fifteenth embodiment, the user can employ system 10bb to initiate the recording of a conversation subsequent to answering the call (start the recording during the conversation).

A third example of the fifteenth embodiment is illustrated as telephone call handling system 10 cc in FIG. 16c. This third example comprises the first or second example, and further configured with a record message picker 329 (depicted as being located on phone 27cc). This feature allows the user to determine a specific “record” message to be sent to the caller. (While the record message picker 329 can be used without caller I.D. 20, the caller I.D. enhances the user's ability to select an appropriate “record” message based on the user's identification of the caller.) The record message picker 329 can be implemented as a plurality of buttons (here, depicted as buttons 330a, 330b and 330c) on phone 27cc. Alternately, the record message picker 329 can be implemented on a touch-screen (e.g., display 21) with a scrolling feature to enable the user to select one of a plurality of “record” messages displayed on the screen.

Further in this third example, message-then-record circuitry 310b can be provided with a plurality of “record” messages 321. (With the exception of the plurality of “record” messages, circuitry 310b can be configured essentially identical to the message-then-record circuitry 310 described above with respect to the first two examples of this embodiment.) As exemplarily depicted in FIG. 16c, the plurality of “record” messages 321 can include “record” message “A” (R.M. A, 321a), “record” message “B” (R.M. B, 321b), and “record” message “C” (R.M. C, 321c). By way of example only, record message R.M. A (321a) can state “This call may be recorded”, record message R.M. B (321b) can state “This call may be recorded in order to protect our legal rights”, and record message R.M. C (321c) can state “This call may be recorded to ensure the quality of your order”. Thus, when coupled with the caller I.D. 20, the record message picker 329 can allow a user to select an appropriate record message (321a, 321b, etc.) to be sent to the caller.

An example of operation of this third example of this fifteenth embodiment will now be given (FIG. 16c). A user's telephone is rung by an incoming ring signal provided by station 120 via line 11 and line 11a. Optionally, but preferably, delivered with the ring signal is caller I.D. information. The information appears on display 21 (located at telephone 27bb). The user recognizes the phone number (or caller identification) on the display; i.e. the user essentially knows who's calling. The user may determine that this person is a customer who might be placing a telephone order for a product or service offered for sale by the user. Accordingly, the user presses button 330c on record message picker 329. Pressed button 330 sends a signal to UI 99 via line 11a. UI 99 responds by sending a signal to interface 31 and, after a two-second delay, by sending a signal to out-going message sender 32. Interface 31 responds by going off-hook. Sender 32 responds by playing and sending record message C 321c, “This call may be recorded to ensure the quality of your order” to the caller (via line 11 and switching station 120). The caller hears the message and understands that any subsequent telephonic conversation with the user may be recorded. At the conclusion to the sending of the message, handling system 10 cc remains idle (on hold) by interface 31 maintaining the off-hook condition until the user answers the call. When the user answers, the off-hook condition of telephone 27cc is detected by interface 31. Interface 31 responds by discontinuing the off-hook condition. (If the caller hangs up prior to the user answering, interface 31 can respond by discontinuing the off-hook condition.) Circuitry 310b responds to discontinuance of the off-hook condition (and provided the caller has not terminated the call) by engaging recorder 323. Recorder 323 remains engaged until circuitry 310b determines that either (i) the incoming call has been terminated (i.e., no incoming call signal detected) or (ii) the user disengages the recorder 323 (e.g., by pressing button 330 again).

As with phone 27aa of FIG. 16a, phone 27cc of FIG. 16c can be provided with message management features 327 in order to manage conversations recorded by the recorder 323. Also, for this third example of this fifteenth embodiment, the user can employ system 10 cc to initiate the recording of a conversation subsequent to answering the call (start the recording during the conversation).

“Record” messages (321) can either be provided as standard default messages supplied by a service provider or a telephone manufacturer, or as a user customized messages. In the latter instance the user can customize the “record” messages (321) by pressing one of buttons 330a, 330b or 330c (when no call is incoming or in progress), and then speaking the desired customized “record” message into the microphone (a standard feature for any telephone, and thus not depicted in FIG. 16c). Once the desired “record” message has been recorded, the user can again press the button to terminate recording of the message. This can be performed for any or all of “record” messages R.M. A (321a), R.M. B (321b), and R.M. C (321c).

In one variation, in order to assist the user in selecting the appropriate “record” message to be sent to a caller, once the user presses any one of buttons 330a, 330b or 330c during an incoming call, the corresponding “record” message can be announced to the user via the telephone speaker (a feature common to all telephones). If the message is the one desired, the user can then press the button a second time in order to cause the selected “record” message to be sent to the caller. However, if the initially selected “record” message is not the message the user desires to send to the caller, then the user can press a different button (330a, 330b or 330c) and repeat the process. As an alternative, rather than announcing the entire “record” message to the user, the user can store “shorthand” descriptions for each “record” message. (These “shorthand” descriptions can be stored in a memory device located in circuitry 310b, in phone 27cc, or at a service provider.) For example: for a generic “record message R.M. A (321a) of “This message may be recorded”, the shorthand verbal clue can be “generic”; for a customized “record message R.M. B (321b) of “This message may be recorded to protect our legal rights”, the shorthand verbal clue can be “legal”; and for a customized “record message R.M. C (321c) of “This message may be recorded in order to ensure the quality of your order”, the shorthand verbal clue can be “customer”.

In yet another variation, the user can store text equivalents (or shorthand text notes) for each “record” message in a memory device located in circuitry 310b, in phone 27cc, or at a service provider. Then, once any one of buttons 330a, 330b or 330c is pressed during an incoming call, the corresponding text description for the associated “record” message can be displayed on display 21. If the displayed text indicates that the desired message has been selected, the user can press the button again (or, if display 21 is a touch screen, by merely tapping the screen).

Entities herein disclosed, including activator 91, starter 92, orchestrator 93, initiator 94, engager 125 and commencer 325, have been depicted in FIGURES herein each comprising a diagrammatic block. Each of said entities have herein been described comprising user interface 99. Interface 99 as disclosed can comprise circuitry and/or programming. However, said entities as disclosed merely house user interface 99 and, thus said entities have been included not as operational components but, instead, to describe the operations of user interface 99 relative to the associated embodiment.

Described prior information shown stored at jingler 205, include: ring 153, ring-back 154, ring modifier 155 ring-back modifier 233, pre-concert 244, ring-back terminator 170, ring-back profile 200, re-direct profile 195, phone off profile 225. Described prior information shown stored in text storage 169 include: ring-back text 178, terminator text 179, ring-back profile text 181, re-direct text 182, phone-off profile text 183, linked-deliver storage 272, stand-alone text 251, pick storage 261 T. Picks 1-9. Described prior information shown stored in picture storage 281 include linked-deliver picture 293, stand alone picture 298 and picture pick storage 266 P. Picks 1-9. Described prior information stored in video storage 286 include: linked-deliver video 296, stand alone video 277 and video pick storage 276 V. Picks 1-9.

Said described prior information (or other) can be initially, and/or subsequently, loaded into, for example, jingler 205, text storage 169, picture storage 281 or video storage 286, respectively (or other), by a user. Said information can be re-selected and again loaded into, for example, jingler 205, text storage 169, picture storage 281 or video storage 286 respectively (or other), re-selecting to include selecting a new/next/subsequent choice of information to load. A user can load information from any number of sources such as: libraries on the internet via a computer or a WiFi connection (if system 10 is WiFi enabled) or provider 121, a music player, a recording device, libraries stored in handling system 10 itself, libraries stored in mobile phone 165, libraries stored at service provider 121. (Said libraries on the internet may be found on a service provider web site, a telephone manufacturer web site, a music web site or other. The stored information can also be stored on one or more memory devices which can be made accessible to the user via a service provider. The stored information can be stored elsewhere, for example, elsewhere at system 10 or elsewhere at telephone 27, or other.)

It is understood that the above examples of the various embodiments provided for herein can be implemented using alternative means and structures to provided essentially equivalent functionality, and that the scope of the present invention is not to be limited by these examples. As an example, the specific content of messages which can be provided to a caller by the systems described herein can vary from the given examples, without varying from the general scope of a respective embodiment. Further, the functionality provided by the interface 31 (i.e., of generating an off-hook signal in order to enable outgoing transmissions of information to the caller) can be accomplished using other known circuitry and/or software implementations. In general, the systems described herein include circuitry and/or software implementations to enable information to be sent to a caller telephone without necessarily placing the called phone in a call-answered condition. In one variation, and in response to a command from a user to send information to a caller based on the user's review of the caller-ID (or lack thereof), the systems described herein use existing voice message circuitry to enable the user-selected information to be sent to the calling telephone. That is, the incoming call is answered, but communication is enabled only from the messaging sending circuitry to the caller (and potentially from the caller to the user, in the case of “who” and “what/why” requested information), and only bilaterally between the caller and the user once the user answers the call. In another variation, information described herein that is to be sent to a caller in the form of a verbal message (e.g., “I'll be with you in one minute”, or “Please call back in 30 minutes”) can be sent to the caller, for example, by the message sender 32 in the form of a text message, provided the calling telephone has text-message capability.

Handling systems 10a through 10j, systems 10L through 10q, system 10s, system 10t, system 10u, system 10w, system 10x, system 10z and system 10aa through 10cc can reside with and as the property of the telephone user as illustrated in FIGS. 1a through 6, FIGS. 8 through 13a, 13c, 13d, 14c, 15a and 15c through 16c. Alternately, handling system 10k lends benefit to the user but is provided by telephone service provider 121 as illustrated in FIG. 7, FIG. 13b, FIG. 14b and FIG. 15b. As an example, handling system 10k comprises handling system 10j of FIG. 8 oriented such that plurality of complementary circuitry 130 and engager 125 are located at switching station 120 while the various control buttons and caller I.D. display 21 remain located at telephone 27k. (Handling system 10k as well as handling systems 10r, 10v and 10y can comprise substantially different circuitry than the examples of system 10a through 10j, systems 10L through 10q, system 10s, system 10t, system 10u, system 10w, system 10x, system 10z and system 10aa through 10cc.)

The embodiments of telephone call handling system 10 herein disclosed in FIGS. 1a through 6, FIGS. 8 through 10 and FIGS. 16a through 16c are shown as functional when located between service provider 121 and telephone 27 with control buttons and display 21 located at telephone 27. The embodiment of system 10 disclosed in FIG. 7, FIG. 13b, FIG. 14b and FIG. 15b is shown functional when located at service provider 121, with control buttons or GUI 210 and display 21 located at telephone 27. The embodiments of system 10 disclosed in FIGS. 11 through 13a, 13c, 14a, 14c, 15a and 15c are shown functional when located at telephone 27 (phone 165) with the functionality of control buttons and display provided by a graphic user interface also located at telephone 27.

Additionally, system 10 can be located otherwise. For example, system 10 can be located in-part at the base of a cordless telephone and in-part at the cordless telephone itself. For example, system 10 can be located in-part at a service provider 121, in-part located between service provider 121 and telephone 27 and with control buttons and display 21 (and/or GUI 210) located at telephone 27. For example, system 10 can be located in-part at a service provider 121 and in-part located between service provider 121 and telephone 27, with control buttons and display 21 (and/or GUI 210) located between service provider 121 and telephone 27 and with control buttons and display (and/or GUI 210) located at telephone 27. For example, system 10 can be located in-part at a service provider 121, in-part located between service provider 121 and telephone 27, in-part at telephone 27 and with control buttons and display 21 (and/or GUI 210) located at telephone 27. For example, service provider 121 can provide phone service along with cable television service. A television screen can then comprise display 21 and system 10 can be located, for example, at telephone 27 (or at a cable control box or at other). Telephone 27 can be electrically connected to (or connectable to) a cable control box (user's home) and control buttons can be located at telephone 27 and/or can be located on a remote control associated with the cable box and/or can be located at the cable box (or other cable/phone configurations).

Telephone 27 can comprise a corded landline telephone, a cellular telephone, a cordless landline phone, or other. Any embodiment herein disclosed employing (or operating in conjunction with) a landline telephone can be configured to employ (or to operate in conjunction) with a cellular telephone. Any embodiment herein disclosed employing (or operating in conjunction) with a cellular telephone can be configured to employ (or operate in conjunction) with a landline telephone.

I claim:

1. A mobile phone for use with a text selector to enable a user to select a text message prior to an incoming call from a caller, a text storage enabled to store the text message and a text sender enabled to send the stored text message to another telephone; the mobile phone comprising:
a trigger configured to respond to a user's instruction by signaling the text sender to send the stored text message to the caller's telephone at the time of the telephone call.

2. The mobile phone of claim 1 and wherein text selection is located at or facilitated by the mobile phone.

3. The mobile phone of claim 2 and wherein the user-selected text message consists of at least one of: a pre-scripted text message, a personalized text message or a prescribed text message.

4. The mobile phone of claim 2 and wherein the text selector enables the user to select a second text message prior to the incoming call to replace a first text message.

5. The mobile phone of claim 1 and wherein the mobile phone further comprises the text storage.

6. The mobile phone of claim 1 and wherein the mobile phone further comprises the text sender.

7. The mobile phone of claim 1 and wherein the mobile phone further comprises a text picker to enable the user to pick a text message from a plurality of text messages.

8. The mobile phone of claim 7 and further comprising an icon selector to enable a user to select an icon to represent the text message.

9. The mobile phone of claim 1 and further comprising a caller I.D. circuitry to provide caller I.D. information to the user enabling the user to consider the information prior to instructing the trigger.

10. The mobile phone of claim 9 and wherein the mobile phone further comprises a text picker to enable the user to pick a text message from a plurality of text messages.

11. A telephone system comprising:
a text selector to enable a user to select a text message prior to an incoming call,
a text storage to store the text message,
a text sender to send the text message to a calling telephone, and
a delivery trigger to initiate the sending of the text message.

12. The system of claim 11 and wherein the delivery trigger initiates the sending of the text message at the time of the telephone call.

13. The system of claim 11 and wherein the initiating of the text sender is linked to the sending of at least one of: an audio message, an audio content, an image, or a video.

14. The system of claim 11 and wherein the user initiates the sending of the text message.

15. The system of claim 11 and wherein the user-selected text message consists of at least one of: a pre-scripted text message, a personalized text message or a prescribed text message.

16. The system of claim 11 and wherein the text selector enables the user to select a second text message to replace a first text message.

17. The system of claim 11 and wherein the system further comprises caller I.D. circuitry to provide caller I.D. information to the user enabling the user to consider the information prior to instructing the trigger.

18. The system of claim 17 and wherein the text storage comprises a plurality of text messages and wherein the user is enabled to pick one of the text messages stored in the text storage, said picking based on the user's consideration of the caller I.D. information.

19. The system of claim 11 and wherein the text storage comprises a plurality of text messages and the user is enabled to pick one of the text messages.

20. The system of claim 11 and wherein the system further comprises further comprises an icon selector to enable the user to select an icon to represent the text message stored in the text storage.
